(19) United States
(12) Patent Application Publication
(10) Pub. No.: US 2026/0268757 A1
(43) Pub. Date: Sep. 10, 2026

(54) USER INTERFACES AND TECHNIQUES FOR REVIEWING GUESTS

(71) Applicant: Apple Inc., Cupertino, CA (US)

(72) Inventors: Vincenzo O. GIULIANI, Thousand Oaks, CA (US); Joshua D. DEITEL, San Francisco, CA (US); Mischa K. MCLACHLAN, San Francisco, CA (US); Sung Min K. ARENA, Mill Valley, CA (US); William N. DANNER, Santa Cruz, CA (US)

(21) Appl. No.: 19/462,821

(22) Filed: Jan. 28, 2026

Related U.S. Application Data
(60) Provisional application No. 63/751,236, filed on Jan. 29, 2025.
(60) Provisional application No. 63/880,282, filed on Sep. 11, 2025.
(60) Provisional application No. 63/970,144, filed on Jan. 28, 2026.

(51) Int. Cl. G08B 25/00; G08B 3/10; G08B 25/10

(52) U.S. Cl. CPC G08B 25/001; G08B 3/10; G08B 25/10

(57) ABSTRACT

The present disclosure generally relates to displaying indications of subjects. Some techniques are for displaying representations of guests based on authentication in accordance with some embodiments. Other techniques are for displaying access permissions in accordance with some embodiments. Other techniques are for alerting devices of detected subjects in accordance with some embodiments.

### CROSS-REFERENCE TO RELATED APPLICATIONS

This application claims priority to U.S. Provisional Patent Application No. 63/970,144, entitled “User Interfaces and Techniques for Reviewing Guests,” filed Jan. 28, 2026, U.S. Provisional Patent Application No. 63/880,282, entitled “User Interfaces and Techniques for Reviewing Guests,” filed Sep. 11, 2025, and to U.S. Provisional Patent Application No. 63/751,236, entitled “User Interfaces and Techniques for Reviewing Guests,” filed Jan. 29, 2025. The content of these applications are hereby incorporated by reference in their entirety.

### BACKGROUND

Homes are becoming increasingly populated with devices. For example, devices are often utilized to increase security and/or provide monitoring of a home. Handling alerts and/or configuring security permissions is difficult as devices often require separate applications that can be cumbersome. Thus, there is a need to improve techniques for reviewing guests.

### SUMMARY

Some techniques described herein enable electronic devices to be faster, more efficient, and/or more effective for displaying indications of subjects. Such techniques can replace and/or work in conjunction with existing techniques for displaying indications of subjects.

In some embodiments, a method that is performed at a computer system that is in communication with one or more display components is described. In some embodiments, the method comprises: receiving an indication of an activity of a subject in an environment; after receiving the indication of the activity of the subject in the environment, displaying, via the one or more display components, a first representation of the subject in a first user interface; while displaying the first user interface: in accordance with a determination that the subject is authenticated: ceasing display of, via the one or more display components, the first representation of the subject; and displaying, via the one or more display components, a second representation of the subject different from the first representation of the subject; and in accordance with a determination that the subject is not authenticated, maintaining display of, via the one or more display components, the first representation of the subject.

In some embodiments, a non-transitory computer-readable storage medium storing one or more programs configured to be executed by one or more processors of a computer system that is in communication with one or more display components is described. In some embodiments, the one or more programs includes instructions for: receiving an indication of an activity of a subject in an environment; after receiving the indication of the activity of the subject in the environment, displaying, via the one or more display components, a first representation of the subject in a first user interface; while displaying the first user interface: in accordance with a determination that the subject is authenticated: ceasing display of, via the one or more display components, the first representation of the subject; and displaying, via the one or more display components, a second representation of the subject different from the first representation of the subject; and in accordance with a determination that the subject is not authenticated, maintaining display of, via the one or more display components, the first representation of the subject.

In some embodiments, a transitory computer-readable storage medium storing one or more programs configured to be executed by one or more processors of a computer system that is in communication with one or more display components is described. In some embodiments, the one or more programs includes instructions for: receiving an indication of an activity of a subject in an environment; after receiving the indication of the activity of the subject in the environment, displaying, via the one or more display components, a first representation of the subject in a first user interface; while displaying the first user interface: in accordance with a determination that the subject is authenticated: ceasing display of, via the one or more display components, the first representation of the subject; and displaying, via the one or more display components, a second representation of the subject different from the first representation of the subject; and in accordance with a determination that the subject is not authenticated, maintaining display of, via the one or more display components, the first representation of the subject.

In some embodiments, a computer system configured to communicate with one or more display components is described. In some embodiments, the computer system comprises one or more processors and memory storing one or more programs configured to be executed by the one or more processors. In some embodiments, the one or more programs includes instructions for: receiving an indication of an activity of a subject in an environment; after receiving the indication of the activity of the subject in the environment, displaying, via the one or more display components, a first representation of the subject in a first user interface; while displaying the first user interface: in accordance with a determination that the subject is authenticated: ceasing display of, via the one or more display components, the first representation of the subject; and displaying, via the one or more display components, a second representation of the subject different from the first representation of the subject; and in accordance with a determination that the subject is not authenticated, maintaining display of, via the one or more display components, the first representation of the subject.

In some embodiments, a computer system configured to communicate with one or more display components is described. In some embodiments, the computer system comprises means for performing each of the following steps: receiving an indication of an activity of a subject in an environment; after receiving the indication of the activity of the subject in the environment, displaying, via the one or more display components, a first representation of the subject in a first user interface; while displaying the first user interface: in accordance with a determination that the subject is authenticated: ceasing display of, via the one or more display components, the first representation of the subject; and displaying, via the one or more display components, a second representation of the subject different from the first representation of the subject; and in accordance with a determination that the subject is not authenticated, maintaining display of, via the one or more display components, the first representation of the subject.

In some embodiments, a computer program product is described. In some embodiments, the computer program product comprises one or more programs configured to be executed by one or more processors of a computer system that is in communication with one or more display components. In some embodiments, the one or more programs include instructions for: receiving an indication of an activity of a subject in an environment; after receiving the indication of the activity of the subject in the environment, displaying, via the one or more display components, a first representation of the subject in a first user interface; while displaying the first user interface: in accordance with a determination that the subject is authenticated: ceasing display of, via the one or more display components, the first representation of the subject; and displaying, via the one or more display components, a second representation of the subject different from the first representation of the subject; and in accordance with a determination that the subject is not authenticated, maintaining display of, via the one or more display components, the first representation of the subject.

In some embodiments, a method that is performed at a computer system that is in communication with one or more input devices and one or more display components is described. In some embodiments, the method comprises: receiving a notification that a subject is present at a location; after receiving the notification that the subject is present at the location, displaying, via the one or more display components, a representation of the notification with a user interface element to review access to the location; while displaying the representation of the notification with the user interface element to review access to the location, detecting, via one or more input devices, an input corresponding to the user interface element to review access to the location; and in response to detecting the input corresponding to the user interface element to review access to the location, displaying, via the one or more display components, a user interface including access permission assigned to the subject for the location.

In some embodiments, a non-transitory computer-readable storage medium storing one or more programs configured to be executed by one or more processors of a computer system that is in communication with one or more input devices and one or more display components is described. In some embodiments, the one or more programs includes instructions for: receiving a notification that a subject is present at a location; after receiving the notification that the subject is present at the location, displaying, via the one or more display components, a representation of the notification with a user interface element to review access to the location; while displaying the representation of the notification with the user interface element to review access to the location, detecting, via one or more input devices, an input corresponding to the user interface element to review access to the location; and in response to detecting the input corresponding to the user interface element to review access to the location, displaying, via the one or more display components, a user interface including access permission assigned to the subject for the location.

In some embodiments, a transitory computer-readable storage medium storing one or more programs configured to be executed by one or more processors of a computer system that is in communication with one or more input devices and one or more display components is described. In some embodiments, the one or more programs includes instructions for: receiving a notification that a subject is present at a location; after receiving the notification that the subject is present at the location, displaying, via the one or more display components, a representation of the notification with a user interface element to review access to the location; while displaying the representation of the notification with the user interface element to review access to the location, detecting, via one or more input devices, an input corresponding to the user interface element to review access to the location; and in response to detecting the input corresponding to the user interface element to review access to the location, displaying, via the one or more display components, a user interface including access permission assigned to the subject for the location.

In some embodiments, a computer system configured to communicate with one or more input devices and one or more display components is described. In some embodiments, the computer system comprises one or more processors and memory storing one or more programs configured to be executed by the one or more processors. In some embodiments, the one or more programs includes instructions for: receiving a notification that a subject is present at a location; after receiving the notification that the subject is present at the location, displaying, via the one or more display components, a representation of the notification with a user interface element to review access to the location; while displaying the representation of the notification with the user interface element to review access to the location, detecting, via one or more input devices, an input corresponding to the user interface element to review access to the location; and in response to detecting the input corresponding to the user interface element to review access to the location, displaying, via the one or more display components, a user interface including access permission assigned to the subject for the location.

In some embodiments, a computer system configured to communicate with one or more input devices and one or more display components is described. In some embodiments, the computer system comprises means for performing each of the following steps: receiving a notification that a subject is present at a location; after receiving the notification that the subject is present at the location, displaying, via the one or more display components, a representation of the notification with a user interface element to review access to the location; while displaying the representation of the notification with the user interface element to review access to the location, detecting, via one or more input devices, an input corresponding to the user interface element to review access to the location; and in response to detecting the input corresponding to the user interface element to review access to the location, displaying, via the one or more display components, a user interface including access permission assigned to the subject for the location.

In some embodiments, a computer program product is described. In some embodiments, the computer program product comprises one or more programs configured to be executed by one or more processors of a computer system that is in communication with one or more input devices and one or more display components. In some embodiments, the one or more programs include instructions for: receiving a notification that a subject is present at a location; after receiving the notification that the subject is present at the location, displaying, via the one or more display components, a representation of the notification with a user interface element to review access to the location; while displaying the representation of the notification with the user interface element to review access to the location, detecting, via one or more input devices, an input corresponding to the user interface element to review access to the location; and in response to detecting the input corresponding to the user interface element to review access to the location, displaying, via the one or more display components, a user interface including access permission assigned to the subject for the location.

In some embodiments, a method that is performed at a computer system is described. In some embodiments, the method comprises: detecting an unidentified subject; in response to detecting the unidentified subject, outputting, via a device corresponding to a first type of resident, a first alarm; and after causing output of the first alarm: in accordance with a determination that a set of one or more criteria is satisfied, outputting, via a device corresponding to a second type of resident, a second alarm, wherein the device corresponding to the second type of resident is separate from the device corresponding to the first type of resident, and wherein the second type of resident is different from the first type of resident; and in accordance with a determination that the set of one or more criteria is not satisfied, forgoing output of, via the device corresponding to the second type of resident, the second alarm.

In some embodiments, a non-transitory computer-readable storage medium storing one or more programs configured to be executed by one or more processors of a computer system is described. In some embodiments, the one or more programs includes instructions for: detecting an unidentified subject; in response to detecting the unidentified subject, outputting, via a device corresponding to a first type of resident, a first alarm; and after causing output of the first alarm: in accordance with a determination that a set of one or more criteria is satisfied, outputting, via a device corresponding to a second type of resident, a second alarm, wherein the device corresponding to the second type of resident is separate from the device corresponding to the first type of resident, and wherein the second type of resident is different from the first type of resident; and in accordance with a determination that the set of one or more criteria is not satisfied, forgoing output of, via the device corresponding to the second type of resident, the second alarm.

In some embodiments, a transitory computer-readable storage medium storing one or more programs configured to be executed by one or more processors of a computer system is described. In some embodiments, the one or more programs includes instructions for: detecting an unidentified subject; in response to detecting the unidentified subject, outputting, via a device corresponding to a first type of resident, a first alarm; and after causing output of the first alarm: in accordance with a determination that a set of one or more criteria is satisfied, outputting, via a device corresponding to a second type of resident, a second alarm, wherein the device corresponding to the second type of resident is separate from the device corresponding to the first type of resident, and wherein the second type of resident is different from the first type of resident; and in accordance with a determination that the set of one or more criteria is not satisfied, forgoing output of, via the device corresponding to the second type of resident, the second alarm.

In some embodiments, a computer system is described. In some embodiments, the computer system comprises one or more processors and memory storing one or more programs configured to be executed by the one or more processors. In some embodiments, the one or more programs includes instructions for: detecting an unidentified subject; in response to detecting the unidentified subject, outputting, via a device corresponding to a first type of resident, a first alarm; and after causing output of the first alarm: in accordance with a determination that a set of one or more criteria is satisfied, outputting, via a device corresponding to a second type of resident, a second alarm, wherein the device corresponding to the second type of resident is separate from the device corresponding to the first type of resident, and wherein the second type of resident is different from the first type of resident; and in accordance with a determination that the set of one or more criteria is not satisfied, forgoing output of, via the device corresponding to the second type of resident, the second alarm.

In some embodiments, a computer system is described. In some embodiments, the computer system comprises means for performing each of the following steps: detecting an unidentified subject; in response to detecting the unidentified subject, outputting, via a device corresponding to a first type of resident, a first alarm; and after causing output of the first alarm: in accordance with a determination that a set of one or more criteria is satisfied, outputting, via a device corresponding to a second type of resident, a second alarm, wherein the device corresponding to the second type of resident is separate from the device corresponding to the first type of resident, and wherein the second type of resident is different from the first type of resident; and in accordance with a determination that the set of one or more criteria is not satisfied, forgoing output of, via the device corresponding to the second type of resident, the second alarm.

In some embodiments, a computer program product is described. In some embodiments, the computer program product comprises one or more programs configured to be executed by one or more processors of a computer system. In some embodiments, the one or more programs include instructions for: detecting an unidentified subject; in response to detecting the unidentified subject, outputting, via a device corresponding to a first type of resident, a first alarm; and after causing output of the first alarm: in accordance with a determination that a set of one or more criteria is satisfied, outputting, via a device corresponding to a second type of resident, a second alarm, wherein the device corresponding to the second type of resident is separate from the device corresponding to the first type of resident, and wherein the second type of resident is different from the first type of resident; and in accordance with a determination that the set of one or more criteria is not satisfied, forgoing output of, via the device corresponding to the second type of resident, the second alarm.

A computer-readable storage medium or other computer program product that is set up to run on one or more processors can optionally include executable instructions for carrying out steps described above.

### DESCRIPTION OF THE DRAWINGS

To gain a clearer understanding of techniques described herein, references to various embodiments are described below in the Detailed Description. In conjunction with the Detailed Description, drawings are provided in which reference numerals refer to related parts across the drawings.

FIG. 1 is a block diagram illustrating a computer system in accordance with some embodiments.

FIG. 2A is a block diagram illustrating a device and a system in accordance with some embodiments.

FIG. 2B illustrates a computer system with a touch screen in accordance with some embodiments.

FIG. 3 is a block diagram illustrating an ecosystem including a computer system with other accessory devices in accordance with some embodiments.

FIGS. 4A-4J illustrate exemplary user interfaces for reviewing guests in accordance with some embodiments.

FIG. 5 is a flow diagram illustrating a process for displaying representations of guests based on authentication in accordance with some embodiments.

FIG. 6 is a flow diagram illustrating a process for displaying access permissions in accordance with some embodiments.

FIGS. 7A-7G illustrate exemplary user interfaces for alerting devices of detected subjects in accordance with some embodiments.

FIG. 8 is a flow diagram illustrating a process for alerting devices of detected subjects in accordance with some embodiments.

### DETAILED DESCRIPTION

The description that follows covers exemplary embodiments and examples. However, it should be acknowledged that this description is given as an explanation and is not meant to restrict the scope of the current disclosure. For example, terms used to describe different embodiments and different examples are not meant to be restrictive unless explicitly stated.

In some embodiments, one or more steps of a process can be contingent upon fulfillment of one or more conditions. To fulfill the one or more conditions, a process can be repeated multiple times. In such embodiments, different conditions can be satisfied in different repetitions. For example, steps can be repeated until all conditions have been satisfied. In some embodiments, electronic devices, computer systems, and/or computer readable mediums include instructions for performing one or more steps that are contingent upon one or more conditions being satisfied. Such instructions can include logic that determines whether the one or more conditions have been fulfilled without repetition of a step.

Although terms such as “first”, “second”, and so forth are used with different elements in the following description, these elements should not be constrained by the terms unless explicitly stated otherwise. In some embodiments, the terms are used to differentiate one element from another. For example, a “first” input can be different from a “second” input, though the terms “first” and “second” can be switched without changing the meaning of either input. In some embodiments, the “first” input and the “second” input are two different references to the same input unless explicitly stated otherwise.

Unless context makes it apparent otherwise, singular forms of “a”, “an”, and “the” are meant to cover plural forms. Additionally, the term “and/or” is meant to be interpreted to apply to and include any and all potential combinations of one or more of the related mentioned things. The terms “has”, “having”, “includes”, “including”, “comprises”, and/or “comprising” are meant to cover the presence of different elements; however, they do not preclude the presence or addition of one or more additional elements. The term “if” is meant to be interpreted to indicate “when”, “upon”, “in response to determining”, or “in response to detecting”. Accordingly, depending on the context, the expressions “if it is determined” or “if [a stated condition] is detected” can be interpreted as meaning “upon determining”, “in response to determining”, “upon detecting [the stated condition]”, or “in response to detecting [the stated condition]”.

Some processes described below enhance the operability of devices and make interfaces better, such as by helping a user provide proper inputs and/or reduce mistakes when using devices, through various techniques. For example, some processes perform an operation when a set of conditions has been met without requiring further input, such as input by a user. For another example, some processes provide additional control options without cluttering user interfaces with additional displayed controls. For another example, some processes reduce the number of inputs needed to perform an operation. For another example, some processes provide improved feedback (e.g., visual, haptic, acoustic, and/or tactile feedback) to a user. Additional techniques include increasing the security and/or privacy of the device and/or reducing burn-in. These techniques also reduce power usage and/or improve battery life of devices, such as by enabling a user to use devices better, more quickly, and/or efficiently.

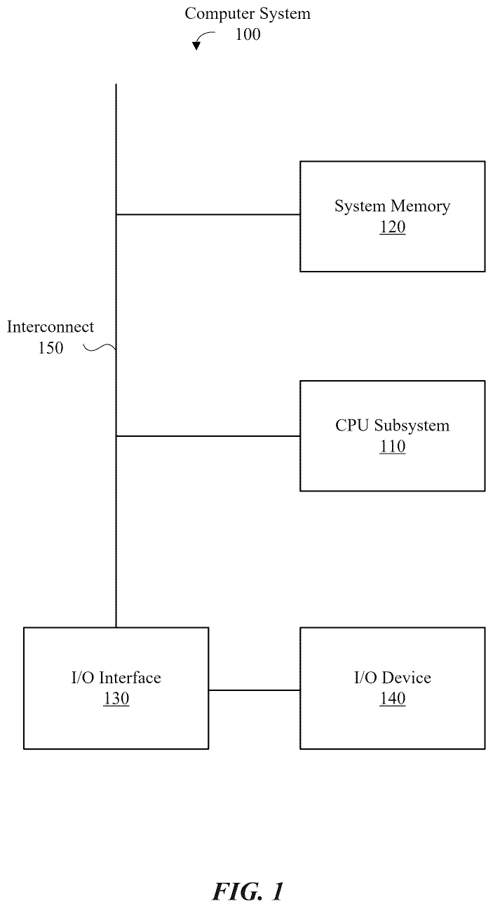

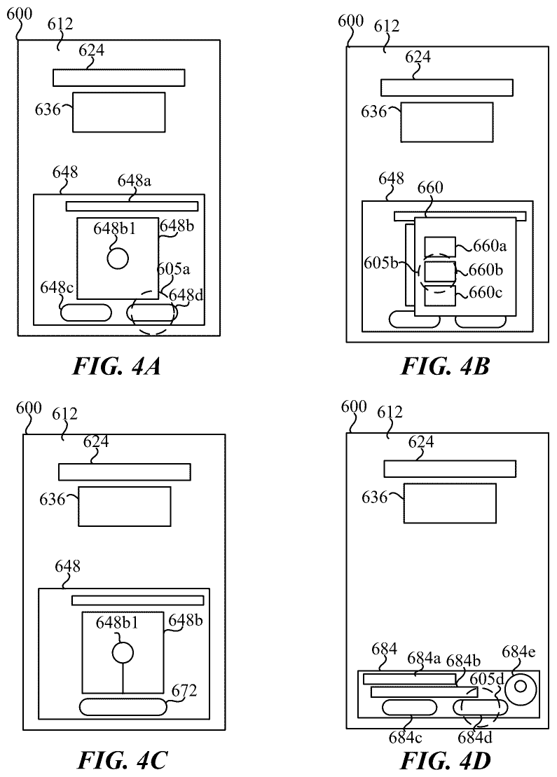

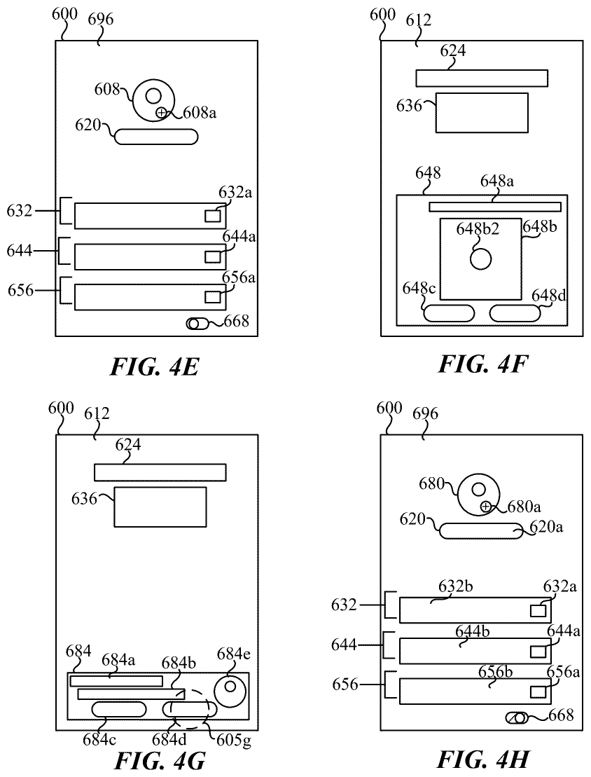

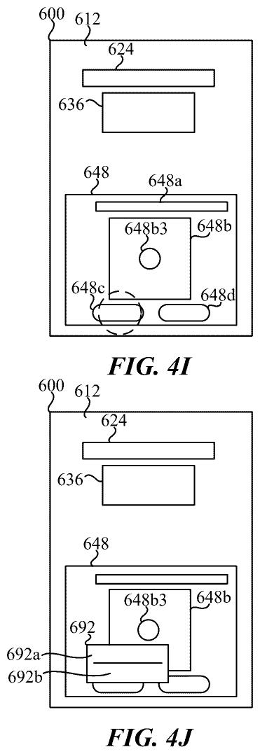

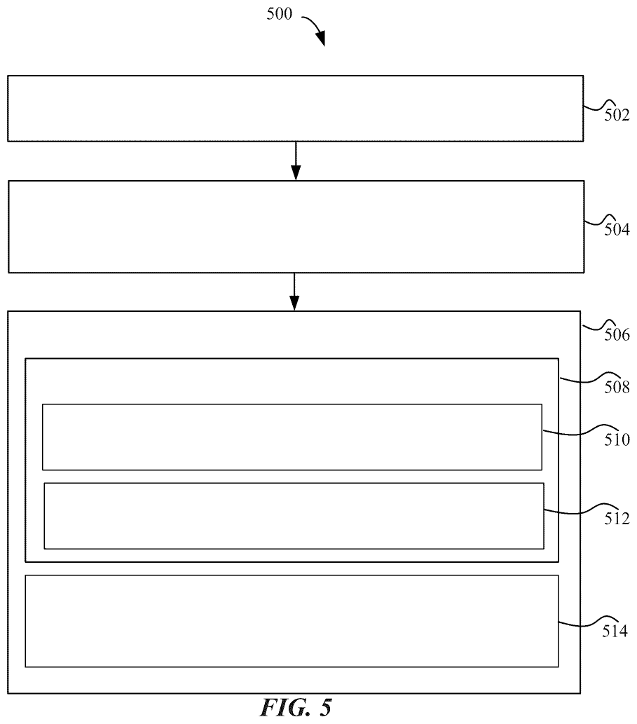

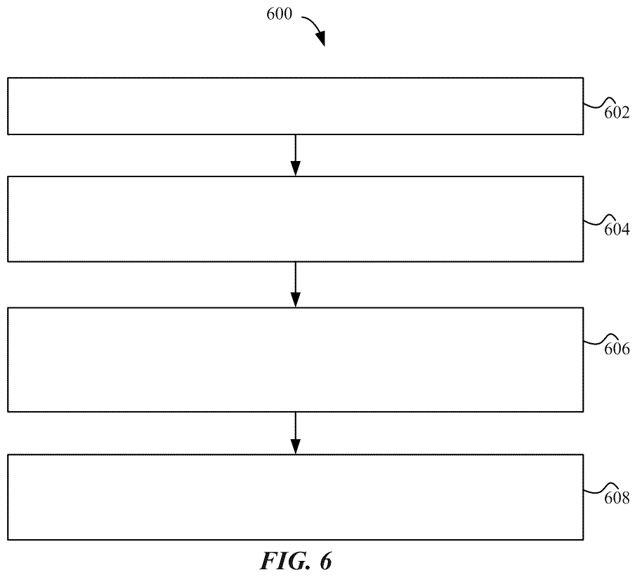

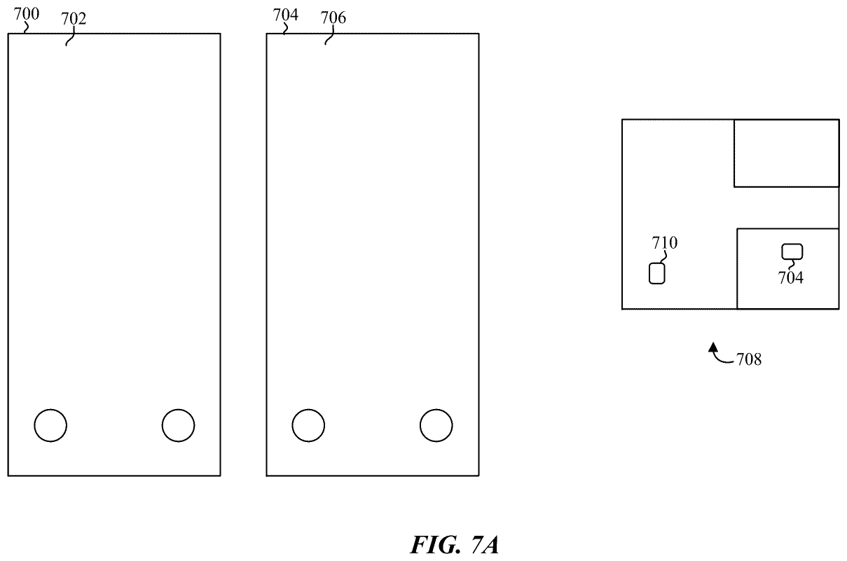

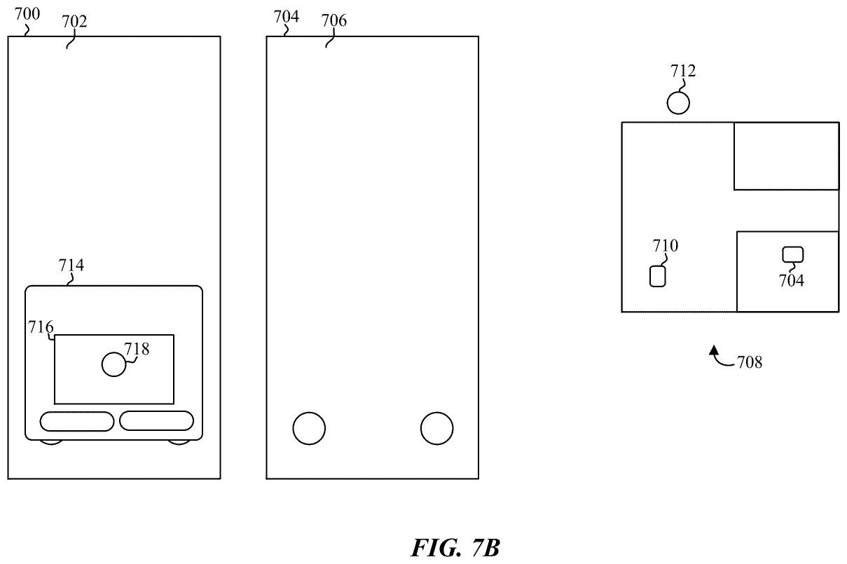

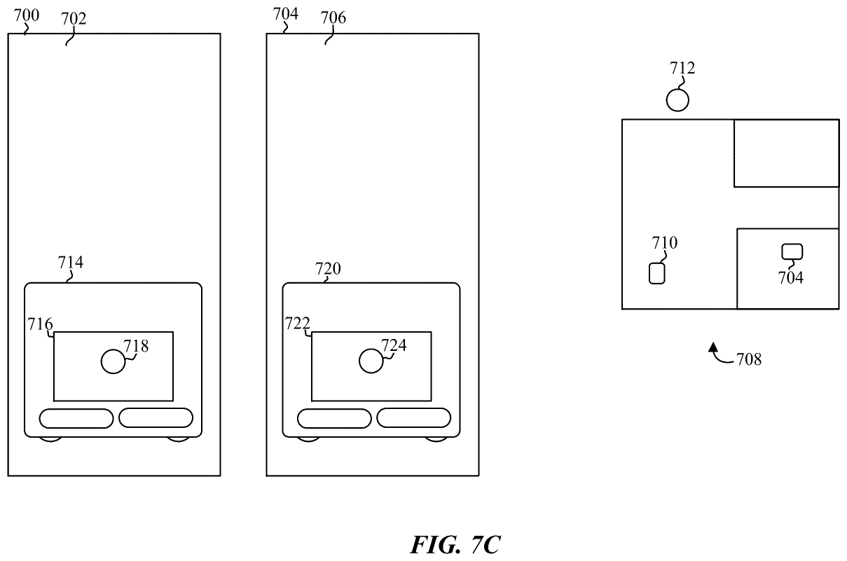

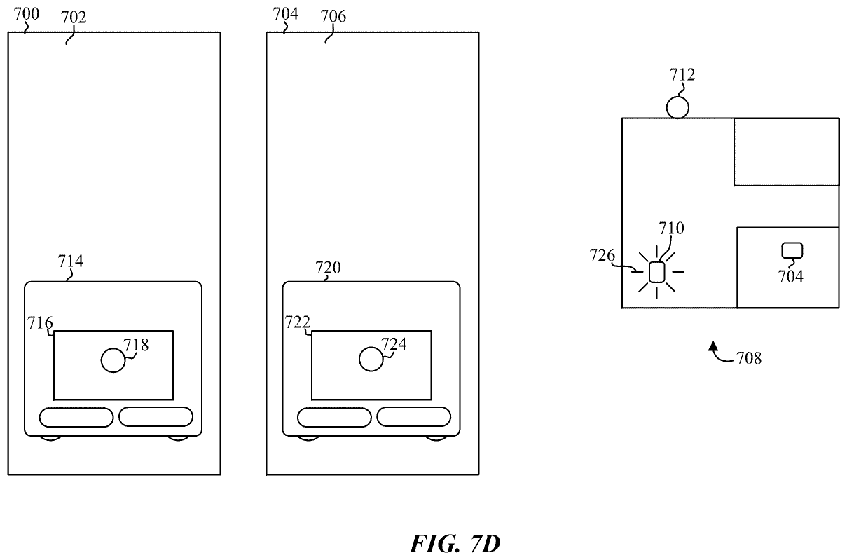

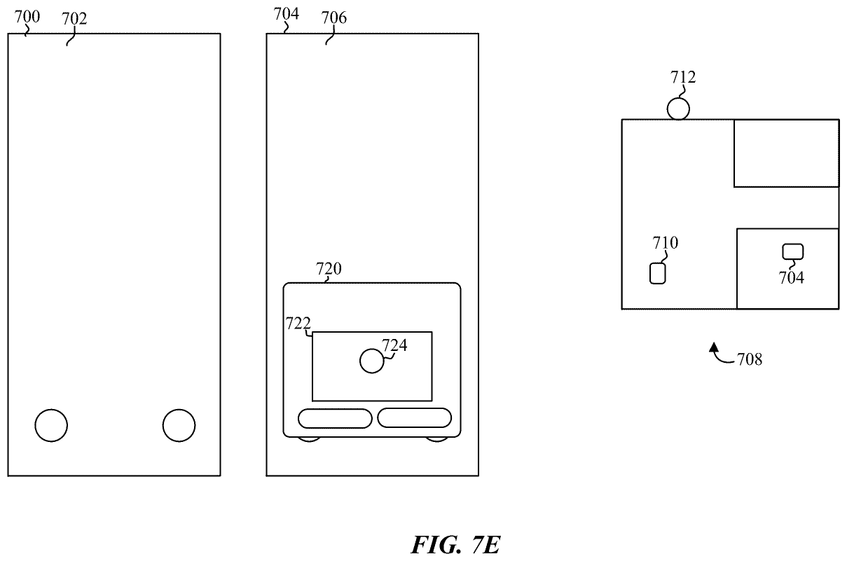

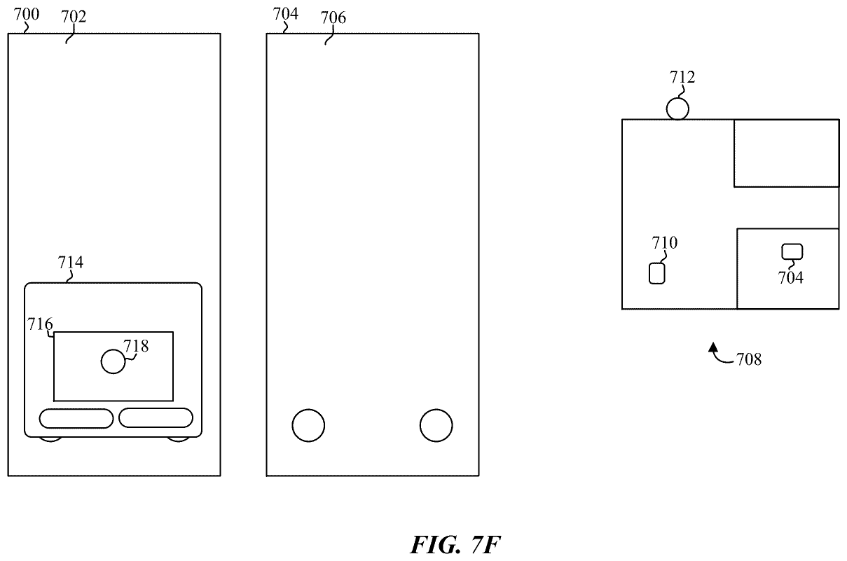

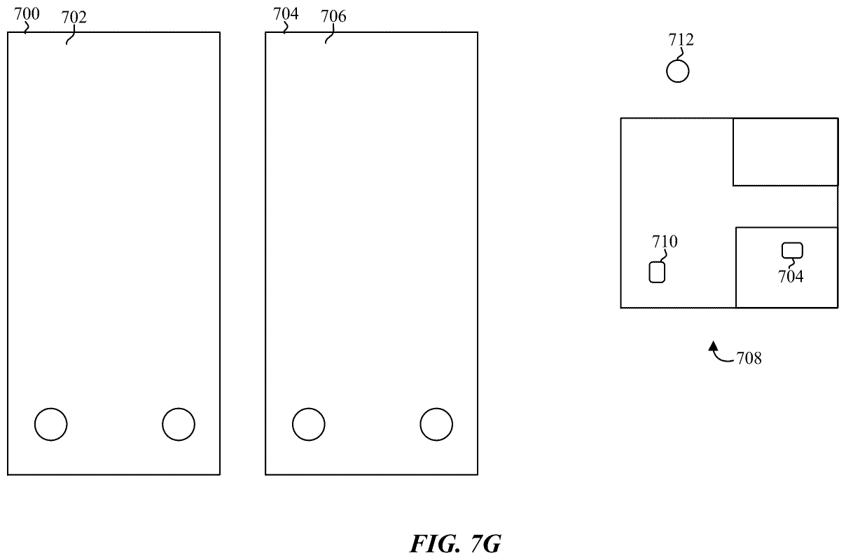

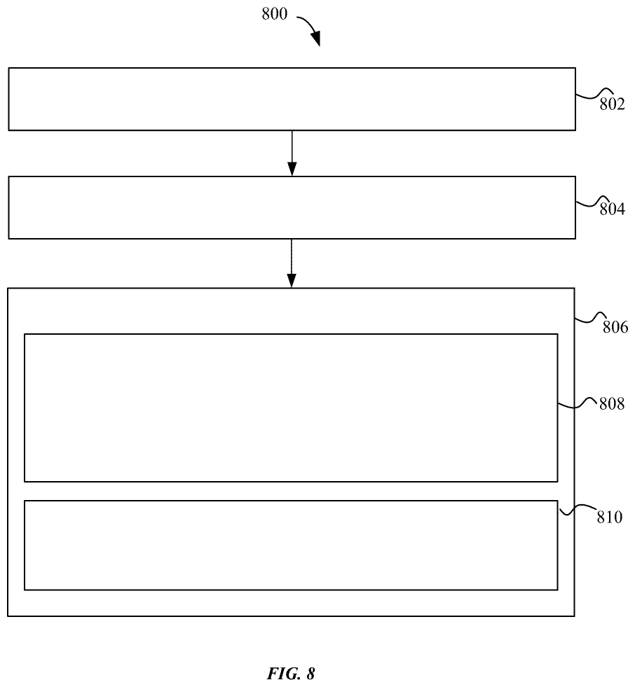

Below, FIGS. 1, 2A-2B, and 3 provide description of exemplary devices for implementing techniques described below. FIGS. 4A-4J illustrate exemplary user interfaces for reviewing guests in accordance with some embodiments. FIG. 5 is a flow diagram illustrating a process for displaying representations of guests based on authentication in accordance with some embodiments. The user interfaces in FIGS. 4A-4J are used to illustrate the processes described below, including the processes in FIG. 5. FIG. 6 is a flow diagram illustrating a process for displaying access permissions in accordance with some embodiments. The user interfaces in FIGS. 4A-4J are used to illustrate the processes described below, including the processes in FIG. 6. FIGS. 7A-7G illustrate exemplary user interfaces for alerting devices of detected subjects in accordance with some embodiments. FIG. 8 is a flow diagram illustrating a process for alerting devices of detected subjects in accordance with some embodiments. The user interfaces in FIGS. 7A-7G are used to illustrate the processes described below, including the processes in FIG. 8.

FIG. 1 is a block diagram illustrating a computer system in accordance with some embodiments. While FIG. 1 illustrates one computer system, two or more computer systems working together can implement techniques described herein. It should be acknowledged that the computer system (e.g., computer system 100) is sometimes referred to as a device, an electronic device, an electronic system, a compute system, and/or a system. In some embodiments, computer system 100 is a personal computer system, a server system, a smart phone, a system on a chip, a smart watch, a wearable device, a tablet, a laptop computer, a fitness tracking device, a head-mounted display (HMD) device, a desktop computer, a communal device (e.g., a smart speaker, connected thermostat, and/or other home-based computer systems), an accessory (e.g., a switch, light, speaker, air conditioner, heater, window cover, fan, lock, media playback device, and/or television), a controller, a hub device, or a sensor.

As illustrated in FIG. 1, computer system 100 includes CPU subsystem 110, system memory 120, and I/O interface 130. Such components are able to communicate with one another through interconnect 150. In some embodiments, interconnect 150 is an electrical means of communication such as a system bus, one or more memory locations, and/or additional electrical channels for connecting multiple components of computer system 100.

It should be acknowledged that computer system 100 is only one example of a computer system to carry out techniques described below and that one or more other computer systems can carry out such techniques. Furthermore, while FIG. 1 illustrates a particular computer architecture of computer system 100, techniques described herein can be carried out by other computer architectures, such as by incorporating more, less, similar, and/or different components than the components illustrated.

In some embodiments, CPU subsystem 110 includes one or more processing units that can carry out techniques described herein. For example, CPU subsystem 110 can execute system-level and/or application-level instructions to perform an operation. In some embodiments, computer system 100 has several processing subsystems (e.g., multiple instances of CPU subsystem 110).

In some embodiments, CPU subsystem 110 is capable of carrying out instructions stored on a storage medium, such as a non-transitory or transitory computer-readable medium. A computer-readable storage medium (or many physical computer-readable storage media of one or more types) including one or more computer-readable instructions can be used to realize implementations falling partially or fully under the purview of the current disclosure. It should be acknowledged that computer-readable instructions can be arranged in any way, such as components, software, processes, widgets, and/or applications.

It should be acknowledged that the storage medium can be any medium that can physically include or store computer-executable instructions. For example, the storage medium can be temporary or non-temporary. Examples of storage medium include magnetic (e.g., hard drives and/or magnetic disks), optical (e.g., optical drives and/or optical discs based on CD, DVD, and Blu-ray technologies), solid state (e.g., solid state drives and/or flash drives), and/or semiconductor (e.g., random access memory) storages. In some embodiments, the storage medium is system memory 120. In such embodiments, each instruction stored by system memory 120 and executed by CPU subsystem 110 corresponds to an operation for completing functionality described herein. For example, instructions for processes 500, 600, and 800 (FIGS. 5, 6, and 8) can be stored in system memory 120.

In some embodiments, system memory 120 implements a range of distinct physical, non-transitory memory media. Examples of system memory 120 include a storage array, a storage area network (SAN), a removable flash drive, flash memory, hard disk storage, optical drive storage, floppy disk storage, removable disk storage, random access memory (such as SDRAM, DDR SDRAM, RAM-SRAM, EDO RAM, and/or RAMBUS RAM), and/or read-only memory (such as PROM and/or EEPROM). In some embodiments, computer system 100 has several memory components coupled, either directly or via interconnect 150, to CPU subsystem 110.

In some embodiments, computer system 100 communicates with external devices through I/O interface 130, which can be one or more types of interfaces. For example, I/O interface 130 can include a bridge chip that connects a front-side bus to one or more back-side buses. In some embodiments, I/O interface 130 allows communication through one or more appropriate buses or other interfaces with one or more I/O devices, such as I/O device 140. For example, I/O device 140 can include one or more: physical user-interface devices (e.g., a physical keyboard, a mouse, a button, a touch-sensitive surface, a rotatable component, and/or a joystick), storage devices (e.g., as described above with respect to system memory 120), network interface devices (e.g., to a local and/or wide-area network), sensor devices (e.g., a camera, a microphone, a motion detector, and/or a temperature sensor), audio output devices (e.g., speaker, audio jacks, and/or hearing loops), and/or visual output devices (e.g., screen, light, and/or projector). In some embodiments, I/O device 140 includes a network interface device that enables computer system 100 to establish a wired or wireless connection to a network or other computer systems. Examples of network interface devices include Ethernet, USB, Bluetooth, NFC, Wi-Fi, and/or Thunderbolt communication devices. In some embodiments, I/O device 140 is wired or wirelessly connected to I/O interface 130.

In some embodiments, a component of computer system 100 incorporates I/O device 140 with other components. For example, a single component can include I/O interface 130 and I/O device 140. In some embodiments, I/O device 140 is a discrete component, meaning it is not incorporated into another part of computer system 100. In some embodiments, functionality of different components is integrated into a component of computer system 100 that is composed of I/O interface 130 and I/O device 140. Additionally, it should be acknowledged that computer system 100 can include one or more I/O interfaces that connect to one or more I/O devices.

In some embodiments, I/O device 140 can be used to detect a subject (e.g., a user, a person, an animal, another computer system different from computer system 100, and/or an object) and/or an input (e.g., a verbal input, a tap input, a swipe input, a hold-and-drag input, a gaze input, an air-gesture input, a physical input and/or a passive input) from a detected subject. In some embodiments, a user has an account enabled by and/or linked to computer system 100, and computer system 100 can determine if a detected subject is a user with an account (e.g., a known user). Determining if a detected subject has an account includes identifying and/or authenticating the detected subject. In some embodiments, identifying and/or authenticating the detected subject includes comparing detected information to stored information about known users. For example, comparing detected information can include comparing biometric data (e.g., facial scans, iris scans, fingerprint scans, and/or voice recognition data) of detected subjects to stored biometric data of known users. For another example, comparing detected information can include comparing detected identification (e.g., MAC address and/or IP address) of a computer system of a detected subject to known identifications of computer systems of known users. For yet another example, comparing detected information can include comparing detected passcodes (e.g., usernames, passwords, passphrases, and/or PINs). In another example, computer system 100 can detect a known user (e.g., a user that corresponds to an account) and allow access to an environment when the user is identified. In some embodiments, computer system 100 detects unknown subjects and enables guest accounts for the unknown subjects to utilize computer system 100.

In some embodiments, computer system 100 collects information without the need for physical inputs via a sensor of I/O device 140. For example, computer system 100 can recognize subject inputs, including air-gesture inputs and/or passive inputs via a camera. In some embodiments, an air-gesture input is that is a detected intentional motion of a portion of the subject's body without the subject touching an input element in communication with or of the device. In some embodiments, a passive input is a detected input that is not purposefully directed at computer system 100 and/or a component in communication with computer system 100. Examples of passive inputs that can be detected by a camera include, but are not limited to, the subject entering an environment, the motion of the subject through an environment, the location of the subject in the environment, the direction the subject is looking and/or facing, and/or light levels of the environment. In some embodiments, computer system 100 can send visual and/or video data to an application from one or more cameras. For example, computer system 100 can send video data to an application for the purpose of making a video phone call. For another example, computer system 100 can detect the sound of a subject talking, glass breakings, and/or music playing via a microphone of I/O device 140. In some embodiments, computer system 100 recognizes speech as verbal a input from a subject that are detected via a microphone.

In some embodiments, computer system 100 detects information about the environment via other types of sensors of I/O device 140. Examples of such sensors include a flow sensor, a gas sensor, a humidity sensor, a chemical sensor, a contact sensor, a precipitation sensor, a pressure sensor, a proximity sensor, a motion sensor, an occupancy sensor, an electricity sensor, and/or a flood sensor.

In some embodiments, computer system 100 detects a physical input via a physical user-interface device of I/O device 140 that allow a subject to communicate with computer system 100 directly. In some embodiments, computer system 100 includes one or more input devices as described above, and data from one input device is combined with data from one or more other input devices (e.g., that are a part of computer system 100 and/or other computer systems) to gather information about the physical environment.

In some embodiments, computer system 100 outputs visual information via a component of I/O device 140, such as a display screen, a projector, a touch-sensitive display, and/or a light. For example, I/O device 140 can include a light to indicate a status of computer system 100, such as an on/off status. For another example, I/O device 140 can include a display screen for displaying user interface elements. In some embodiments, “outputting” visual information includes sending data (e.g., image and/or video data) to an external display component via a wired or wireless connection, causing the external display component can display the visual information.

In some embodiments, computer system 100 emits sound via an audio output device of I/O device 140, such as a speaker, a headphone, an earbud, an audio jack, an optical audio output, a Bluetooth audio output, an HDMI audio output, and/or a hearing loop. For example, computer system 100 can provide a subject with information and/or audio-based content via speakers of I/O device 140.

In some embodiments, I/O device 140 includes a tactile output device. For example, I/O device 140 can include a haptic element that allows computer system 100 to communicate with a subject who is in close proximity to or in physical contact with computer system 100.

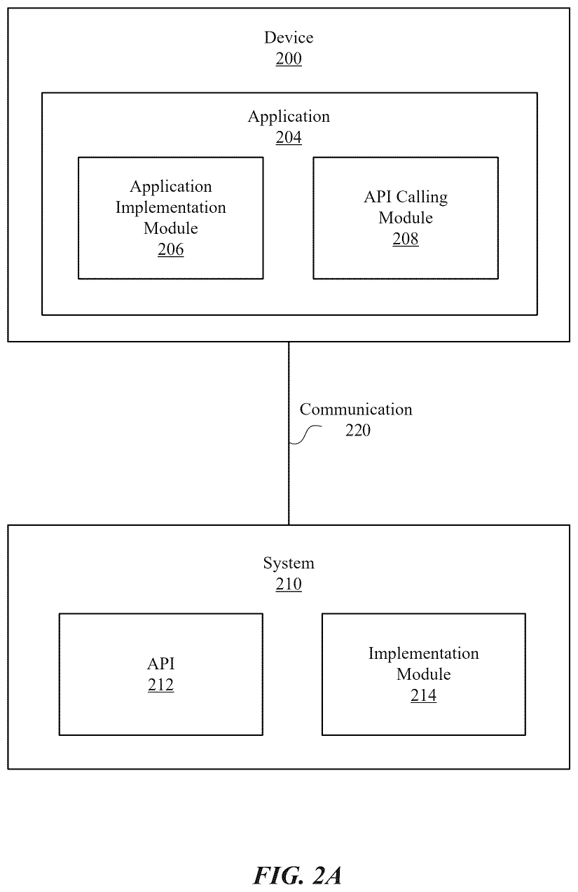

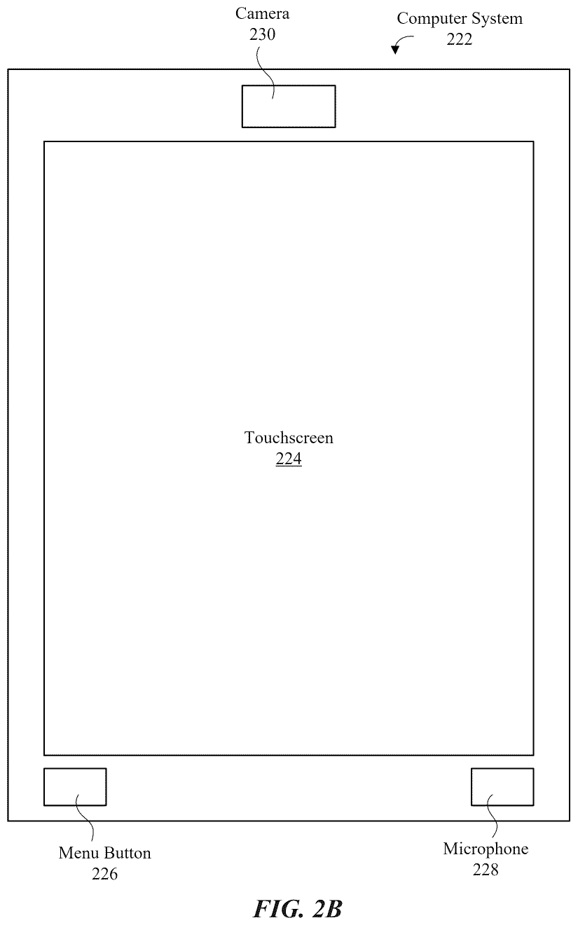

FIG. 2A is a block diagram illustrating a device and a system in accordance with some embodiments. In some embodiments, device 200 is a personal computing device, a server system, a smart phone, a smart watch, a tablet, a laptop computer, a fitness tracking device, a head-mounted display (HMD) device, a desktop computer, a communal device (e.g., a smart speaker, connected thermostat, and/or other home-based computer systems), an accessory (e.g., a switch, light, speaker, air conditioner, heater, window cover, fan, lock, media playback device, and/or television), a controller, a hub device, or a sensor. In some embodiments, system 210 is an operating system hosted on device 200. In some embodiments, system 210 is an operating system hosted on an external device (e.g., a server, a peripheral device, an accessory, and/or a personal computing device). It should be acknowledged that device 200 and/or system 210 can include more, fewer, and/or different components than illustrated in FIG. 2A.

As illustrated in FIG. 2A, device 200 includes an application (e.g., application 204) that, when executed by one or more processing units, causes device 200 to perform one or more processes and/or methods described herein. In some embodiments, application 204 is an application that is pre-installed on device 200 by a manufacture of device 200 (e.g., a first-party application). In some embodiments, application 204 is an application that is provided to device 200 via an operating system update file (e.g., a first-party application or a second-party application). In some embodiments, application 204 is an application that is installed by a user of device 200, such as through an application store installed on device 200. It should be acknowledged that application 204 can be any suitable type of application such a browser application, a fitness application, a health application, a digital payments application, a media application, a social network application, a messaging application, a maps application, and/or an application that functions as an execution environment for plug-ins, widgets and/or other applications. In some embodiments, application 204 causes device 200 to perform processes 500, 600, and 800 (FIGS. 5, 6, and 8).

In some embodiments, a software platform has a set of frameworks that provide objects and/or behaviors that a software developer uses to build applications on the software platform. Software developers use the set of frameworks to display and/or interact with content, and/or manage interactions with the software platform. In some embodiments, an application relies on the set of frameworks for their behavior. In such embodiments, the set frameworks can provide different ways for the software developer to customize behavior of the application to match specific needs of the application.

In some embodiments, interaction with a device includes transfer and/or receipt of one or more API calls between multiple different software processes (e.g., different portions of an operating system, an application and an operating system, or different applications) via one or more APIs. For example, when an input is detected, raw sensor data can be processed into one or more input events that are provided (e.g., via an API) to a receiving software process that makes some determination based on the one or more input events, and then sends (e.g., via an API) information to a software process to perform an operation (e.g., change a device state and/or user interface).

In some embodiments, an object and/or a behavior is accessed via an API, specifying a format for communication between processes, including specifying and grouping available protocols, variables, and/or functions. For example, an API call, sometimes referred to as an API request, can be sent from a first software process to a second software process as a way to accomplish different things. The first software process can request information from the second software process. The first software process can provide information to the second software process. The first software process can request action by the second software process. The first software process can provide information to the second software process about action taken by the first software process.

In some embodiments, while a determination and an operation performed in response can be made by the same software process, alternatively, a determination can be made in a first software process and relayed (e.g., via an API) to a second software process different from the first software process. Relaying the determination can cause an operation to be performed by the second software process. Alternatively, the second software process can relay one or more instructions (e.g., via an API) to a third software process different from the first software process and/or the second software process. The one nor more instructions can be to perform an operation.

It should be acknowledged that some or all subject interactions with a computer system can involve one or more API calls within a step of interacting with the computer system, such as between different software components of the computer system or between a software component of the computer system and a software component of one or more remote computer systems.

As illustrated in FIG. 2A, application 204 includes application implementation module 206 and API calling module 208. In some embodiments, application implementation module 206 includes a set of one or more instructions corresponding to one or more operations performed by application 204. For example, when application 204 is a messaging application, application implementation module 206 can include operations to receive and send messages.

In some embodiments, API calling module 208 is a module that can receive application programming interface (API) calls, respond to API calls, and/or send API calls. In some embodiments, application implementation module 206 communicates with API calling module 208 to communicate with a system, such as system 210. In some embodiments, communication 220 represents one or more API calls and/or one or more other forms of communication between device 200 (e.g., one or more components of device 200) and system 210 (e.g., one or more components of system 210).

As illustrated in FIG. 2A, system 210 includes API 212 and implementation module 214. In some embodiments, API 212 is a software and/or hardware module that can receive API calls, respond to API calls, and/or send API calls. In some embodiments, API 212 is a software module (e.g., a collection of computer-readable instructions) that provides an interface that allows a different module (e.g., API calling module 208) to access and/or use one or more functions, methods, procedures, data structures, classes, and/or other services provided by implementation module 214. For example, API calling module 208 can make an API call to API 212 to access and use a feature of implementation module 214 that is specified by API 212. In some embodiments, API 212 is implemented in part by firmware, microcode, or other low-level logic that executes in part on the hardware component.

In some embodiments, API calling module 208 passes data and/or controls information within implementation module 214 through the one or more API calls via API 212. In some embodiments, API 212 includes one or more features for translating API calls and returns between implementation module 214 and API calling module 208, which allows multiple API-calling modules written in different programming languages to communicate with implementation module 214. For example, API calling module 208 can call using APIs from different providers such as a set of APIs from an OS provider, another set of APIs from a plug-in provider, and/or another set of APIs from another provider (e.g., the provider of a software library) or creator of the other set of APIs.

In some embodiments, implementation module 214 is a system (e.g., operating system, and/or server system) software module that is constructed to perform an operation in response to receiving an API call via API 212. In some embodiments, implementation module 214 is constructed to provide an API response (via API 212) as a result of processing an API call. In some embodiments, implementation module 214 is embodied at least in part in firmware, microcode, or hardware logic. In some embodiments, implementation module 214 calls one or more other components via an underlying API and thus is both an implementation module and an API calling module similar to API calling module 208. For example, implementation module 214 and API calling module 208 can each be any one of an operating system, a library, a device driver, an API, an application program, or other module. It should be acknowledged that implementation module 214 and API calling module 208 can be the same or different type of module from each other.

In some embodiments, various API calls are transferred between API calling module 208 and implementation module 214. It should be acknowledged that transferring API calls can include issuing, initiating, invoking, calling, receiving, returning, and/or responding to a function of calls or messages. In other words, transferring API calls can describe actions by either API calling module 208 or implementation module 214. In some embodiments, in response to an API call from API calling module 208, implementation module 214 returns (via API 212) a value to report to application 204 the capabilities or state of a hardware component of device 200, such as input capabilities and state, output capabilities and state, processing capability, power state, storage capacity and state, and/or communications capability.

In some embodiments, implementation module 214 provides more than one API, with different APIs supplying different aspects of functionality performed by implementation module 214 while protecting some aspects of functionality from view. For example, one API of implementation module 214 can provide a first set of functions and can be exposed to third-party developers while another API of implementation module 214 can be hidden (e.g., not exposed) and provide a subset of the first set of functions and/or provide a different set of functions, such as testing or debugging functions which are not in the first set of functions. It should be acknowledged that implementation module 214 can include additional functions, methods, classes, data structures, and/or other features that are not specified through API 212 and are not available to API calling module 208. In some embodiments, implementation module 214, API 212, and/or API calling module 208 are stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, in response to and/or after receiving information from one or more hardware components of device 200, one or more software modules of device 200, and/or one or more hardware components external to device 200 (e.g., a peripheral device, an accessory device, and/or a server), application 204 executes a task with the information. In some embodiments, the tasks executed include: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling API 212 of system 210 based on the information. In some embodiments, after receiving the information, application 204 executes the task in response to a trigger, such as a detection of an event, a notification received from system 210, an input, and/or a response to a call to an API provided by system 210.

In some embodiments, application 204 calling API 212 (e.g., as part of a task executed by application 204 in response to and/or after receiving information) includes using one or more parameters defined by API 212. In some embodiments, the one or more parameters include a constant, a key, a data structure, an object, an object class, a variable, a data type, a pointer, an array, a list or a pointer to a function or method, and/or another way to reference a data or other item to be passed via API 212.

In some embodiments, in response to and/or after receiving the information, application 204 transfers the information to system 210 via communication 220. In some embodiments, after receiving the information, application 204 transfers the information to system 210 in response to a trigger.

FIG. 2B illustrates a computer system with a touch screen in accordance with some embodiments. In some embodiments, computer system 222 is a portable multifunction device that is a personal device of a user. It should be acknowledged that computer system 222 can be computer system 100 and/or device 200 as described above.

As illustrated in FIG. 2B, computer system 222 includes touch screen 224, touch screen 230, menu button 226, and microphone 228. In some embodiments, computer system 222 displays, via touch screen 224, a user interface (UI) including one or more user interface elements, such as controls, graphics, and/or content. Computer system 222 can then detect an input, such as a tap input using a finger of a user or a stylus, on a user interface element to select the user interface element. In some embodiments, the user interface element is selected when touch screen 223 no longer detects the input.

In some embodiments, microphone 228 is an input device for detecting sounds near computer system 222, including verbal inputs from a user. For example, computer system 222 can detect a subject making a verbal request and/or command to computer system 222 via microphone 228. In some embodiments, computer system 222 collects data and/or information about a subject via microphone 228. For example, computer system 222 can confirm an identity of a subject by matching a verbal input of the subject to a voice profile of a user. At FIG. 2B, microphone 228 is part of computer system 222. In some embodiments, microphone 228 is not part of but is in communication (e.g., via a wired and/or wireless communication) with computer system 222.

In some embodiments, camera 230 is an input device that includes an image or video sensor (such as one or more optical sensors and/or one or more depth sensors) that allows computer system 222 to detect objects and/or inputs (e.g., hand and/or air-gesture inputs) near computer system 222. In some embodiments, computer system 222 collects data and/or information about a subject via camera 230. For example, computer system 222 can confirm an identity a subject by matching a facial scan of a subject to a biometric profile of a user. At FIG. 2B, camera 230 is part of computer system 222. In some embodiments, camera 230 is not part of computer system 222 but is in communication (e.g., via a wired and/or wireless connection) with computer system 222. In some embodiments, camera 230 is always on and continuously capturing images (e.g., periodically and/or without interruption). In some embodiments, camera 230 begins to capture an image when an input and/or interaction is detected.

In some embodiments, menu button 226 is a physical button that, when depressed, provides a physical input for computer system 222. In some embodiments, touch screen 224 and/or menu button 226 are used for turning computer system 222 on and off and/or locking it. For example, menu button 226 can be used to lock computer system 222 by pressing and releasing menu button 226 before a predetermined amount of time (e.g., 2-10 seconds) has passed. For another example, menu button 226 can be used to unlock computer system 222 or start an unlocking process, or to turn computer system 222 on or off by pressing and holding menu button 226 in the depressed state for longer than the predetermined amount of time. In some embodiments, microphone 228 allows computer system 222 to detect a verbal input for turning on or off certain features. Additionally, computer system 222 can optionally have one or more tactile output devices to provide tactile outputs (e.g., haptic outputs) to the user and/or one or more contact intensity sensors to detect the intensity of contacts on touch screen 224

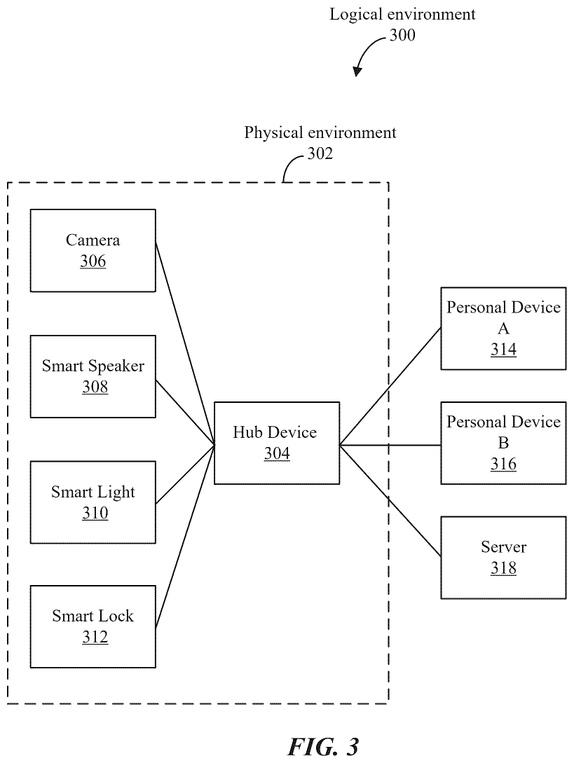

FIG. 3 is a block diagram illustrating a logical environment in accordance with some embodiments. As illustrated in FIG. 3, logical environment 300 includes multiple devices that are in communication (e.g., wired and/or wirelessly) with each other. In some embodiments, logical environment 300 is a software-defined construct that represents state, capabilities, and/or permissible interactions of devices within logical environment 300. For example, logical environment 300 can maintain a data model including (1) unique identifiers for different devices and/or assigned roles for each device, (2) a capability map describing supported functions and/or data formats, (3) a relationship graph indicating pairing status, hierarchy, and/or authorized communication paths, (4) contextual state parameters such as operating modes, user profiles, and/or session data, and/or (5) policy constraints that govern security, power management, and/or permissible commands. In some embodiments, logical environment 300 enables controller devices (e.g., hub device 304, personal device A 314, personal device B 316, and/or server 318) to discover, address, control, and/or configure accessory devices (e.g., camera 306, smart speaker 308, smart light 310, smart lock 310, and/or hub device 304). In such embodiments, logical environment 300 can be independent of underlying physical transports and/or physical location.

As illustrated in FIG. 3, logical environment 300 includes (e.g., involves) devices within physical environment 302 (e.g., camera 306, smart speaker 308, smart light 310, smart lock 312, and hub device 304). In some embodiments, physical environment 302 is a physical location, such a home, an office building, a warehouse, and/or an apartment building. It should be acknowledged that techniques described herein can be used with any type of physical location.

In some embodiments, the devices within logical environment 300 work together using one or more of the techniques described herein for detecting an activity in, interacting with, capturing sensor data related to, and/or communicating data about physical environment 302. Such control and/or communication can be via a homeowner and/or administrator of physical environment 302 and/or logical environment 300. In some embodiments, detecting an activity includes detecting and/or identifying a subject within physical environment 302. In some embodiments, in response to detecting the activity, a device (e.g., camera 306, smart speaker 308, smart light 310, smart lock 312, and/or hub device 304) within physical environment 302 captures sensor data in physical environment 302 and/or performs an operation. In such embodiments, the operation can includes allowing or denying a subject access to all or part of physical environment 302, turning on a light, and/or playing music.

At FIG. 3, devices illustrated within the dashed box of physical environment 302 are located within physical environment 302. Such devices include hub device 304, camera 306, smart speaker 308, smart light 310, and smart lock 312. In some embodiments, such devices and are in communication via one or more local area networks (e.g., WiFi and/or ethernet), one or more personal area network (e.g., Bluetooth, Zigbee, and/or Thread), one or more wide area networks (e.g., Internet and/or cellular), and/or one or more peer-to-peer connections.

At FIG. 3, devices illustrated outside the dashed box of physical environment 302 are located outside of physical environment 302 or are mobile with the ability to be inside or outside of physical environment 302. Such devices include personal device A 314, personal device B 316, and server 318. It should be acknowledged that logical environment 300 and physical environment 302 are described for explanatory purposes and that techniques described below can be carried out with more, less, similar, and/or different devices than the devices and/or the configurations discussed above.

In some embodiments, hub device 304 is a stationary or semi-stationary computer system that communicates with accessory devices located within physical environment 302 including, but not limited to, camera 306, smart speaker 308, smart light 310 and/or smart lock 312. In some embodiments, hub device 304 communicates with one or more accessory devices on behalf of (e.g., communicates information to and/or from) one or more controller devices, such as personal device A 314 and/or personal device B 316. In some embodiments, hub device 304 provides centralized coordination, routing, and/or persistent data storage for physical environment 302. In some embodiments, hub device 304 includes a component for detecting other devices, such as a camera, a microphone, and/or Bluetooth and/or Ultra-Wideband (UWB) component. While hub device 304 is depicted in FIG. 3 as a single device, the functionality described below can be implemented with two or more resident devices operating together. Examples of hub device 304 include a smart speaker, a set-top box, a router, a home-automation bridge, a television, and/or a desktop computer.

In some embodiments, hub device 304 communicates with devices outside of physical environment 302. For example, hub device 304 can communicate with other hub devices that belong to different environments. For another example, hub device 304 can communicate with other accessory devices and/or other controller devices. In such embodiments, hub device 304 communicates with other devices through one or more communication channels described above (e.g., a local area network, a personal area network, a peer-to-peer connection, and/or a wide area network).

In some embodiments, hub device 304 includes and/or is in communication with one or more cameras with which hub device 304 can capture an image and/or a video of a subject and/or activity within physical environment 302. In some embodiments, hub device 304 includes and/or is in communication with one or more microphones with which hub device 304 can detect noise (e.g., glass breaking, an alarm going off, and/or a subject talking) within physical environment 302. In some embodiments, a microphone enables hub device 304 to detect verbal inputs from a subject, enabling the subject to interact with hub device 304 without making physical contact with hub device 304 or another computer system within physical environment 302.

In some embodiments, hub device 304 includes and/or is in communication with one or more sensors. In some embodiments, a sensor includes a hardware component capable of detecting (e.g., sensing and/or processing) information about physical environment 302 in proximity to the hardware component. For example, a sensor can be configured to detect information surrounding the sensor, detect information in one or more directions away from the sensor, and/or detect information based on contact of the sensor with an element of physical environment 302. In some embodiments, a hardware component of a sensor includes a sensing component (e.g., a temperature and/or image sensor), a transmitting component (e.g., a radio transmitter and/or laser transmitter), and/or a receiving component (e.g., a radio receiver and/or laser receiver). It should be acknowledged that a sensor can be multiple types of sensors. For example, a sensor can be an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a motion sensor, a range or depth sensor (e.g., RADAR and/or LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. In some embodiments, hub device 304 combines data from multiple sensors to generate information about physical environment 302.

In some embodiments, hub device 304 includes and/or is in communication with one or more speakers that can output audio content into physical environment 302. In some embodiments, hub device 304 includes and/or is in communication with one or more display components, such as a display, a projector, a touch-sensitive display, a head-mounted display (HMD), and/or another device component that presents visual content to a subject. In some embodiments, hub device 304 includes and/or is in communication with a touch-sensitive surface (such as a touchpad or a touch screen display) from which hub device 304 detects inputs.

In some embodiments, camera 306 is a computer system for capturing and/or recording images in the form of digital photos and/or videos. In some embodiments, camera 306 includes and/or is in communication with one or more sensors, such as those mentioned above with respect to hub device 304. In some embodiments, camera 306 captures an image and/or a video continuously and/or in response to detecting an activity via a sensor. In some embodiments, camera 306 combines data from multiple sensors (e.g., that are part of camera 306 and/or one or more additional devices in communication with camera 306) to generate information about physical environment 302. While camera 306 is presented as an individual device, it should be acknowledged that camera 306 can represent multiple devices capable of capturing images and/or videos. For example, camera 306 can include cameras positioned to observe important areas of physical environment 302, such as an entrance, a hallway, and/or a living room area.

In some embodiments, smart speaker 308 is a computer system that converts electrical signals into sound and includes one or more components for outputting audio, such as speakers, audio distributors, soundbars, headphones, earphones, earbuds, television speakers, HMD speakers, audio jacks, optical audio outputs, Bluetooth audio outputs, and/or HDMI audio outputs. For example, smart speaker 308 can output audio content to provide information to a subject. In some embodiments, smart speaker 308 includes one or more microphones that can be used by smart speaker 308 to obtain data and/or information from a subject and/or about physical environment 302. For example, smart speaker 308 can detect if a subject is in the room by detecting a subject talking via a microphone. In some embodiments, the information that smart speaker 308 obtains via the microphone includes verbal inputs from a subject. For example, a subject can request smart speaker 308 to perform an action and/or obtain information for the subject. While smart speaker 308 is presented as an individual device, it should be acknowledged that smart speaker 308 can represent multiple devices capable of outputting audio.

In some embodiments, smart light 310 is a computer system for outputting light and includes one more components for outputting light, such as an incandescent, LED, fiber optic, fluorescent, halogen, and/or neon light. In some embodiments, smart light 310 includes and/or is in communication with one or more sensors, such as those mentioned above with respect to hub device 304. In some embodiments, smart light 310 outputs light or ceases outputting light in response to detecting an activity via a sensor. For example, smart light 310 can turn on in response to detecting a sound via a microphone. For another example, smart light 310 can turn off in response to detecting light from another light source via a light sensor. While smart light 310 is presented as an individual device, it should be acknowledged that smart light 310 can represent multiple devices capable of outputting light.

In some embodiments, smart lock 312 is a computer system for locking and unlocking an area and includes one or more components for such locking, such as a deadbolt, mortise, electromagnet, and/or latch lock. In some embodiments, smart lock 312 includes and/or is in communication with one or more sensors, such as those mentioned above with respect to hub device 304, and locks or unlocks in response to detecting an activity via a sensor. For example, smart lock 312 can lock in response to detecting a contact sensor close, indicating that a door has closed. In some embodiments, smart lock 312 includes and/or is in communication with an input component capable of detecting physical inputs, such as a physical input mechanism (e.g., one or more buttons) and/or a touch sensitive surface and/or screen, and locks or unlocks in response to detecting inputs via the input component. For example, smart lock 312 can unlock in response to detecting a correct PIN code being entered via the input component. In some embodiments, smart lock 312 includes a component for detecting other devices, such as Bluetooth, UWB, and/or Near Field Communication (NFC) component, and locks or unlocks in response to detecting another device. For example, smart lock 312 can unlock in response to detecting, via UWB, a personal device of a user approach smart lock 312. While smart lock 312 is presented as an individual device, it should be acknowledged that smart lock 312 can represent multiple devices capable of locking and unlocking areas.

Personal device A 314 and personal device B 316 are computer systems belonging to users and/or groups of users. For example, personal device A 314 and/or personal device B 316 can be a smart phone, a tablet, a smart watch, a laptop, a communal device, a personal gaming system, a desktop computer, a fitness tracking device, and/or an HMD. In some embodiments, personal device A 314 and personal device B 316 are the same type of device. For example, both personal device A 314 and personal device B 316 can both be smart phones. In other embodiments, personal device A 314 and personal device B 316 are different types of devices. For example, personal device A 314 can be a smartwatch while personal device B 316 can be a smart phone.

In some embodiments, server 318 is a remotely accessible digital storage system, that is hosted by a service provider and accessible by registered devices of logical environment 300 (e.g., hub device 304 and/or other device with appropriate user credentials). In some embodiments, hub device 304 communicates with server 318 via a wired or wireless connection, such as Wi-Fi, ethernet, and/or cellular network.

In some embodiments, one or more devices within logical environment 300 communicate with hub device 304 about an activity detected within physical environment 302. For example, in response to unlocking, smart lock 312 can communicate the unlocking to hub device 304. In some embodiments, in response to a device communicating a detected activity, hub device 304 captures a photo and/or a video of physical environment 302 (e.g., via camera 306 and/or a camera of hub device 304). For example, in response to smart speaker 308 communicating about detecting a noise, hub device 304 can send a command to camera 306 to capture video of physical environment 302 near smart speaker 308. In some embodiments, one or more devices within logical environment 300 send information (e.g., images, video, audio, inputs and/or status updates from sensors) regarding an activity to hub device 304 and, in response, hub device 304 analyzes the information. For example, when camera 306 captures a video in response to detecting motion (e.g., as discussed above), camera 306 can send the video to hub device 304 to analyze. For example, hub device 304 can analyze a captured image of physical environment 302 that includes smoke and determine a fire is in physical environment 302.

In some embodiments, devices outside of hub device 304 analyze data to make determination. For example, camera 306 can determine an identity of a subject within an image and send the identity to hub device 304 rather than sending the image. For another example, in response to smart lock 312 detecting the presence of a personal device of a user (e.g., personal device A 314), hub device 304 can request camera 306 to capture an image. After capturing the image, camera 306 can identify a subject in the image to determine whether the image includes the user.

In some embodiments, after a subject is identified (e.g., such as using camera 306 as described above), hub device 304 initiates an authentication process to authenticate the subject. The authentication process can verify and/or confirm the identity of the subject in physical environment 302. For example, if the subject is registered with hub device 304, in conjunction with identifying the subject (e.g., via camera 306 as described above), hub device 304 communicates with a personal device (e.g., personal device A 314 or personal device B 316) registered to the subject through wireless signal (e.g., UWB signal, Bluetooth signal, and/or Wi-Fi signal) to authenticate the subject. In some embodiments, hub device 304 captures and/or receives multiple types of information at once and is able to identify and authenticate the subject simultaneously. For example, in a scenario where the subject in physical environment 302 is speaking while being within the field-of-view of camera 306, hub device 304 can identify the subject using an image captured via camera 306 using facial recognition and authenticate the subject using audio captured via smart speaker 308 to match voice biometrics. In some embodiments, hub device 304 receives an authentication key (e.g., PIN code and/or key fob authenticator) for a user (such as when the user enters the authentication key at smart lock 312) and uses the fact that the authentication key corresponds to same user as detected in physical environment 302 via another device, such as camera 306, to authenticate the user.

In some embodiments, when a subject is identified and not authenticated, hub device 304 sends an authentication request to a personal device (e.g., personal device A 314 or personal device B 316) of the subject. For example, hub device 304 can send a request for a facial scan and/or a PIN to personal device A 314, and consider the subject authenticated upon receiving a notification from personal device B 316 that correct information has been entered and/or received. In some embodiments, hub device 304 sends an authentication request to a personal device detected within physical environment 302.

In some embodiments, personal device B 316 is a personal device (e.g., phone, watch and/or tablet) belonging to an administrator (e.g., a resident, owner, and/or caretaker) of logical environment 300. Personal device B 316 can be in communication with hub device 304, and allow the administrator to view and/or remotely control aspects of logical environment 300, such as managing camera views and/or visitor access. In some embodiments, in response to detecting an inquiry (e.g., “Who is at the door?” and/or “Is anyone home?”), personal device B 316 sends a request to hub device 304 to capture an image (e.g., via camera 306) and send the image to personal device B 316. It should be acknowledged that communication between devices within physical environment 302 and personal device B 316 can occur even when personal device B 316 is outside physical environment 302, such as through a secure outside internet or cellular connection.

In some embodiments, hub device 304 sends a notification to personal device B 316 in response to detecting (e.g., directly and/or via another device of logical environment 300) an activity. For example, hub device 304 can send a notification to personal device B 316 in response to not being able to identify a subject detected in physical environment 302. In some embodiments, the notification sent by hub device 304 to personal device B 316 includes information corresponding to a time and/or a location that the activity and/or subject was detected. In some embodiments, the notification includes an image and/or a video of the activity. For example, the notification can include a video of smoke filling a room where smoke was detected. In some embodiments, the notification includes identifying information (e.g., name, photo, and/or video) of the subject in physical environment 302. In some embodiments, hub device 304 sends a notification without sending images to personal device B 316. For example, an administrator might want to be notified if someone they recognize is at the front door without showing a video feed of a camera at the front door. For another example, the notification might not require an image, such as a notification that a thermostat has detected a temperature outside of a predetermined range. In other embodiments, hub device 304 does not send a notification if certain identified subjects are detected, thus avoiding unnecessary notifications (e.g., an administrator might not care to be notified if their spouse or roommate is detected at the front door).

In some embodiments, the notification sent by hub device 304 to personal device B 316 includes an option to authenticate a detected subject via the notification (e.g., a control within the notification and/or an application corresponding the notification). In some embodiments, if the detected subject is identified, the notification includes a control to initiate communication (e.g., text and/or call) with the detected subject. In some embodiments, the notification includes a control to initiate communication with a subject detected in physical environment 302 via smart speaker 308. In some embodiments, the notification includes escalation options such as a control contacting emergency services. In some embodiments, the administrator corresponding to personal device B 316 creates a profile for a subject in physical environment 302 that automatically authenticates the subject.

In some embodiments, devices within physical environment 302 output content to communicate information to a subject within physical environment 302. For example, in response to a subject being identified but not authenticated, hub device 304 can output via smart speaker 308 a request for the subject to authenticate themselves. For another example, in response to detecting a door being opened, hub device 304 can indicate the door is opened by outputting light via smart light 310 near the door. In some embodiments, devices within physical environment 302 output content to communicate an event escalation. For example, in response to personal device B 316 detecting an input on the control to contact emergency services (e.g., as described above), smart light 310 can flash its lights and smart speaker 308 can output alarm noises.

In some embodiments, hub device 304 allows communication with administrators of logical environment 300. For example, a person in physical environment 302 can request to call an administrator of logical environment 300 (e.g., initiate a call to personal device B 316) to request access to physical environment 302 and/or devices within physical environment 302. In some embodiments, hub device 304 detect such a request directly or via an input on a personal device (e.g., personal device A 314). In such embodiments, the administrator can give allowance to subject in physical environment 302 and personal device B 316 communicates to hub device 304 that the subject in physical environment 302 has been authenticated.

In some embodiments, after the subject in physical environment 302 is identified and authenticated, hub device 304 enables the subject access to physical environment 302 and/or one or more devices with physical environment 302. In some embodiments, hub device 304 enables the subject access to physical environment 302s for a predefined amount of time (e.g., 1 hour to 10 days). In such embodiments, the predefined amount of time can vary depending on the type of authorization provided to the subject. For example, a guest of physical environment 302 can have access for less time than a temporary resident of physical environment 302.

In some embodiments, data about activities detected within physical environment 302 is recorded and stored. Some or all of such activity data can be stored locally and/or on server 318. Storing activity data can allow an administrator of physical environment 302 to review a history of activity in physical environment 302.

Reference is made herein to environmental context (also referred to herein as a “context of an environment” and/or “a context corresponding to an environment”). In some embodiments, an environmental context is a context based on one or more characteristics of physical environment 302 (e.g., subjects, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) by detecting input (e.g., via one or more input devices) and/or receiving data (e.g., from one or more other devices and/or components in communication with the device).

Reference is made herein to user context (also referred to herein as a “context of a user” and/or “a context corresponding to a user”). In some embodiments, a user context is a context based on one or more characteristics of a user. For example, a user context can include a subject's appearance and/or clothing, personality, actions, behavior, movement, location, and/or pose. In some embodiments, a device (e.g., using an agent) determines a user context (e.g., to be currently true, occurring, and/or applicable) by detecting input (e.g., via one or more input devices) and/or receiving data (e.g., from one or more other devices and/or components in communication with the device). In some embodiments, a device determines user context based on historical context and/or learned characteristics of the subject, where one or more characteristics of the subject are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include an internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) by detecting input (e.g., via one or more input devices) and/or receiving data (e.g., from one or more other devices and/or components in communication with the device). In some embodiments, a device (e.g., using an agent) determines an operational context (e.g., to be currently true, occurring, and/or applicable) by assessing one or more internal states (e.g., accessed, retrieved, and/or queried by a process of the device).

Reference is made herein to “performing output,” “causing output,” “outputting,” and/or similar phrases. Such phrases can be interchangeable and/or include computer system itself performing such output or causing another computer system perform such output. Reference is made herein to “displaying,” “causing display of,” “outputting visual content,” and/or similar phrases. Such phrases can be interchangeable and/or include computer system itself displaying or causing another computer system perform such display. Reference is made herein to “outputting audio,” “causing output of audio,” “providing audio output,” and/or similar phrases. Such phrases can be interchangeable and/or include computer system itself outputting audio or causing another computer system perform such output.

Attention is now directed towards embodiments of user interfaces (“UI”) and associated processes that are implemented on an electronic device, such as computer system 100, device 200, computer system 222, hub device 304, camera 306, smart speaker 308, smart light 310, smart lock 312, personal device A 314, personal device B 316, or server 318.

FIGS. 4A-4J illustrate exemplary user interfaces for reviewing guests in accordance with some embodiments. The user interfaces in these figures are used to illustrate the processes described below, including the processes in FIGS. 5-6.

In some embodiments, reviewing a guest includes an administrator of a location receiving a notification of a resident and/or a guest at the location. In such embodiments, the location can be any environment, such as a house, apartment, outside area, a room, and/or a business. In some embodiments, the location includes one or more accessories in communication with one or more controllers, such as a personal device of the administrator, a resident device of the location, and/or a server. Examples of the one or more accessories include a camera, a speaker, a television, and/or a lock. In some embodiments, the one or more accessories are in communication with the resident device, which is in communication with one or more other controllers that are configured to control the one or more accessories via the resident device. For example, a camera accessory can detect a guest and communicate with the resident device that the guest has been detected without communicating any media captured via the camera accessory. In such an example, in response to receiving the communication that the guest has been detected, the resident device can communicate with a personal device (e.g., computer system 400) of the administrator to notify the personal device that the guest has been detected. In some embodiments, in response to receiving a notification, the administrator is able to review the guest at the location. In such embodiments, reviewing the guest can include reviewing an ability to grant permission to the guest to the location and/or create a guest profile for the guest. As will be discussed further below with reference to FIGS. 4E and 4H, the administrator can add data corresponding to a guest's identity (e.g., a profile picture and a name) and/or grant certain permissions (e.g., a personalized PIN, a schedule, accessory access, and/or remote access) to a guest profile for the location.

In some embodiments, an administer is a resident of the location with control of access to the location and/or to the one or more accessories in the location for others. In some embodiments, a resident is a person and/or a device with access to the location and/or to the one or more accessories in the location but does not have control of access for others. In some embodiments, similar to a resident, a guest is a person and/or a device without control of access for others. In such embodiments, the guest might have different access to the location and/or to the one or more accessories in the location than a resident.

FIGS. 4A-4J illustrate computer system 400 as a smart phone. It should be recognized that computer system 400 can be other types of computer systems such as a tablet, a smart watch, a laptop, a communal device, an accessory, a personal gaming system, a desktop computer, a fitness tracking device, and/or a head-mounted display (HMD) device. In some embodiments, computer system 400 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 400 includes and/or is in communication with one or more output devices (e.g., a display screen, a projector, a touch-sensitive display, and/or a speaker).

While the examples in FIGS. 4A-4J illustrate computer system 400 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, another computer system detects one or more inputs on behalf of computer system 400.

At FIG. 4A, a camera (e.g., separate from computer system 400 and, in some embodiments, not in communication with computer system 400 but rather only in communication with a resident device of the location) (e.g., the camera accessory) detects a first guest approaching the location. In response to detecting the first guest approaching the location, the camera attempts to identify the first guest. In some embodiments, the camera attempts to identify the first guest by recognizing the first guest through visual, auditory, and/or other biometric information captured by the camera. For example, the camera can attempt to identify the first guest by comparing an image and/or a video of the first guest with images of known users. In other embodiments, the camera attempts to identify the first guest by attempting to communicate with a personal device of the first guest to receive identity information from the personal device. Such communication can be via Bluetooth, WiFi, Thread, NFC, UWB, and/or another type of communication. It should be recognized that other techniques can be used to identify the first guest. At FIG. 4A, the camera is unable to identify the first guest and, in response, sends a communication indicating that the first guest is an unknown guest to the resident device. In response to receiving the communication, the resident device communicates with computer system 400 that an unknown guest is approaching. In other embodiments, the resident device can attempt to identify the first guest using other accessories and, if still unable, can proceed as described below.

As illustrated in FIG. 4A, computer system 400 displays lock screen user interface 412. Lock screen user interface 412 includes date indicator 424 (e.g., Saturday, October 12) and time indicator 436 (e.g., “9:30”) as well as, in response to receiving the communication from the resident device, notification 448. It should be recognized that more, fewer, and/or different elements can be included in lock screen user interface 412. It should also be recognized that another user interface different from lock screen user interface 412 can be displayed with notification 448, including an application specific to notification 448 (such as an accessory management application) or an application not specific to notification 448 (such as a music or internet browser application).

In some embodiments, notification 448 includes information about the first guest being detected at the location and/or controls to cause different operations to occur. For example, as illustrated in FIG. 4A, notification 448 includes detection indicator 448a (e.g., “Motion detected in entryway”), live feed 448b, get help control 448c, and allow control 448d. In some embodiments, only the administrator receives notification 448. In other embodiments, multiple administrators and/or one or more residents of the location receives notification 448.

As illustrated in FIG. 4A, detection indicator 448a includes information of how the first guest was detected (e.g., by motion) as well as information of where the first guest was detected (e.g., the entryway). Such information can be based on the communication received from the resident device. In some embodiments, detection indicator 448a includes different information if detection of the first guest was different, the location of detection was different, and/or if the first guest is identified. For example, if the first guest is identified as “John” and detected at the back door, computer system 400 can display detection indicator 448a as, “John is detected at the back door.” In some embodiments, detection indicator 448a includes a time of detection. For example, “Motion detected at entryway at 9:30 AM.”

As illustrated in FIG. 4A, live feed 448b is a live feed of the first guest at the entryway captured by the camera. As illustrated in FIG. 4A, live feed 448b includes first guest representation 448b1 (e.g., the first guest). In some embodiments, rather than or in addition to a live feed, computer system 400 displays an image of the first guest at the entryway captured by the camera. In some embodiments, rather than or in addition to a live feed, computer system 400 displays a recorded video of the first guest at the entryway captured by the camera. In some embodiments, rather than or in addition to a live feed, computer system 400 outputs audio of the first guest at the entryway captured by the camera or another accessory device separate from the camera. In some embodiments, rather than or in addition to a live feed, computer system 400 displays a profile picture of the first guest (e.g., in the scenario that the first guest has a guest profile) as will be discussed below with reference to FIG. 4G. In some embodiments, computer system 400 does not display live feed 448b if it is determined that the administrator and/or a resident of the location are at the location.

In some embodiments, computer system 400 does not display live feed 448b if it is determined that a guest is authenticated. For example, in a scenario where the guest is John and John is authenticated, notification 448 does not include live feed 448b but rather includes text of “John is at your home environment.” In some embodiments, authentication can be defined as a recognition and/or authorization of a guest. For example, authentication can be a two-factor process, including multiple different forms of authentication, each having different requirements. In some embodiments, a first form of authentication includes identifying a guest in media captured via a camera. In such embodiments, a second form of authentication can include detecting a personal device of the guest at the location and/or receiving an indication that a password and/or a PIN code corresponding to the guest has been recently entered in a device (e.g., a lock, a computer, and/or other electronic device) at the location. In some embodiments, authentication allows a guest to have access to the location and/or permission to use one or more accessories at the location.

At FIG. 4A, computer system 400 detects input 405a directed to allow control 448d. It should be recognized that input 405a is an example of a selection input as a tap input but can be other inputs, such as a mouse click, a verbal input (e.g., “Allow access,”), and/or a button press.

As illustrated in FIG. 4B, in response to detecting input 405a, computer system 400 displays menu 460 while maintaining display of notification 448 and live feed 448b. Menu 460 is a user interface element that allows the administrator to select how long a guest has access to the location. As illustrated in FIG. 4B, menu 460 includes one hour control 460a, today control 460b, and schedule control 460c. In some embodiments, in response to detecting an input directed to one hour control 460a, computer system 400 communicates with the resident device to grant a guest access to the location for one hour. In some embodiments, in response to detecting an input directed to today control 460b, computer system 400 communicates with the resident device to grant a guest access to the location for the rest of the day. In some embodiments, in response to detecting an input directed to schedule control 460c, computer system 400 ceases display of lock screen user interface 412 and displays a schedule user interface that gives the administrator the ability to create a schedule for when a guest is allowed to enter the location and how long the guest can remain at the location (e.g., without causing someone to be notified, such as the administrator, and/or losing control of one or more accessories). It should be recognized that menu 460 can have a different appearance than described herein and/or be displayed without content described above or with other content.

At FIG. 4B, computer system 400 detects input 405b directed to today control 460b. It should be recognized that input 405b is an example of a selection input as a tap input but can be other inputs, such as a mouse click, a verbal input (e.g., “Give access for today.”), and/or a button press.

As illustrated in FIG. 4C, in response to detecting input 405b, computer system 400 ceases display of menu 460 and displays allowed indicator 472 (e.g., “Allowed for rest of day”). At FIG. 4C, in response to detecting input 405b, computer system 400 communicates with the resident device to allow the first guest access for the rest of the day. At FIG. 4C, in response to receiving a communication from computer system 400 to allow the first guest access for the rest of the day, the resident device authenticates the first guest at the entryway of the location and grants access to the location.

It should be recognized that, as part of allowing access to the location, the resident device can cause certain operations to be performed to allow the first guest access. For example, the resident device can unlock a door where the first guest is detected, allow a personal device of the first guest to control one or more accessories at the location, and/or turn off notifications of activity of the first guest at the location. In some embodiments, if the first guest stays at the location for longer than the permitted time, the resident device causes certain operations to be performed to deny the first guest access. For example, the resident device can notify the administrator of the first guest not leaving, remove the ability of the personal device of the first guest to control one or more accessories at the location, and/or turn on notifications of activity of the first guest at the location. Additionally, in between FIGS. 4C and 4D, the resident device can detect the first guest entering the location.

At FIG. 4D, time has passed since computer system 400 displayed allowed indicator 472 (e.g., time indicator 436 indicates that one minute has passed since FIG. 4C). As illustrated in FIG. 4D, after the time has passed since displaying allowed indicator 472, computer system 400 ceases display of notification 448 (e.g., including live feed 448b) and displays notification 484 (e.g., a notification summarizing activity of the first guest, including that the guest entered the home at 9:30 AM).

In some embodiments, computer system 400 displays notification 484 in response to detecting input 405b. In such embodiments, computer system 400 does not display notification 448 including allowed indicator 472 (e.g., such as described above with respect to FIG. 4C) after detecting input 405b. Instead, in response to detecting input 405b, computer system 400 ceases display of notification 448 and displays notification 484.

In some embodiments, computer system 400 displays notification 484 after a predefined amount of time after the first guest has entered the location. In some embodiments, computer system 400 does not display notification 484 if it is determined that the administrator and/or a resident of the location are at location. In some embodiments, in a scenario where the first guest has already been authenticated, returns to the location, and upon reentry of the location by the first guest, computer system 400 displays notification 484 rather than notification 448.

In some embodiments, computer system 400 ceases display of live feed 448b when displaying notification 484 because the first guest is no longer (1) in a field of view of the camera, (2) identified, and/or (3) authenticated now that they have gained access to the location.

As illustrated in FIG. 4D, notification 484 includes arrival indicator 484a (e.g., “Guest arrived”), indicating that the camera was unable to identify the first guest. Notification 484 also includes entry indicator 484b (e.g., “Entered home environment at 9:30 AM”), view activity control 484c, review control 484d, and image 484e. In some embodiments, notification 484 includes get help control 448c. In some embodiments, arrival indicator 484a does not include any identification of the first guest because the first guest was unable to be identified. In some embodiments, if the first guest is identified, arrival indicator 484a includes an indication of an identity of the first guest, such as “John arrived.” As illustrated in FIG. 4D, entry indicator 484b includes an indication of the time of entry (e.g., “9:30 AM”).

It should be recognized that entry indicator 484b can include different content depending on method of entry and/or location of entry. For example, in a scenario where the first guest used a PIN code to enter the location, entry indicator 484b can include “Entered PIN code at 9:30 AM.” For another example, in a scenario where the first guest entered the location through the garage, entry indicator 484b can include “Entered through garage at 9:30 AM.”

In some embodiments, in response to detecting an input directed to view activity control 484c, computer system 400 ceases display of lock screen user interface 412 and displays an activity user interface that includes user interface elements to allow the administrator to view what activities the first guest has performed at the location. In some embodiments, activities include detected actions, interactions, and/or uses of accessories at the location. For example, an activity can be that the first guest turned on a TV. For another example, an activity can be that the first guest opened an entryway door to enter the location. In some embodiments, the activities performed by the first guest included in the activity user interface include multiple activities over a predetermined period of time. For example, the activity user interface can include activities performed by the first guest since being detected in the entryway (and/or entering the location). For another example, the activity user interface can include activities performed by the first guest since the very first visit to the location (e.g., activities from all time).

As illustrated in FIG. 4D, image 484e includes an image of the first guest captured by a camera in communication with and/or connected to the resident device, such as the camera used to capture live feed 448b (e.g., as illustrated in FIG. 4A). In some embodiments, image 484e is an image of when the first guest was detected. In some embodiments, image 484e is an image of when the first guest was authenticated. In some embodiments, in the scenario that the first guest has a profile created with the resident device, image 484e is a profile picture of the first guest.

At FIG. 4D, computer system 400 detects input 405d directed to review control 484d. It should be recognized that input 405d is an example of a selection input as a tap input but can be other inputs, such as a mouse click, a verbal input (e.g., “Let's review that guest.” and/or “Create a profile for that guest.”), and/or a button press.

As illustrated in FIG. 4E, in response to detecting input 405d, computer system 400 ceases display of lock screen user interface 412 and displays review user interface 496. As illustrated in FIG. 4E, review user interface 496 includes a series of user interface elements that allow a user to view, create, and/or edit a guest profile (e.g., including data and permissions) corresponding to the first guest, including image 408, create name control 420, PIN control 432, schedule control 444, accessories control 456, and remote access control 468.

As illustrated in FIG. 4E, image 408 is the same image as image 484e. In some embodiments, image 408 is an image of when the first guest was detected, identified, and/or authenticated. It should be recognized that computer system 400 uses image 408 as the profile image for the first guest. In some embodiments, in the scenario that the first guest has a profile created with the resident device, image 484e is a profile picture of the first guest. In some embodiments, in the scenario where the first guest does not have a profile created with the resident device, a default profile image (e.g., of a blank head icon) is displayed within image 408 instead of the same image as image 484e. Additionally, as illustrated within FIG. 4E, image 408 includes add control 408a. In some embodiments, in response to detecting an input directed to add control 408a, computer system 400 ceases display of review user interface 496 and displays a photo user interface that allows the administrator to select a different image for the first guest.

As illustrated in FIG. 4E, create name control 420 includes the words, “Create name,” indicating that no name has been added for the first guest. In some embodiments, in response to detecting an input directed to create name control 420, computer system 400 displays a digital keyboard that allows the administrator to create a name for the first guest.

As illustrated in FIG. 4E, PIN control 432 does not include any text or numbers, indicating that no PIN has been created for the first guest. In some embodiments, in response to detecting an input directed to PIN control 432, computer system 400 displays a digital keyboard to allow the administrator to create a PIN for the first guest. Additionally, as illustrated in FIG. 4E, computer system 400 displays edit control 432a within PIN control 432. In some embodiments, in response to detecting an input to edit control 432a when no PIN has been created, computer system 400 displays a digital keyboard to allow the administrator to create a PIN for the first guest. In some embodiments, in response to detecting an input to edit control 432a when a PIN has been created, computer system 400 displays a digital keyboard to allow the administrator to edit an existing PIN for the first guest. It should be recognized that once a PIN is created for the first guest, the first guest can use it as a means of authentication and/or entry, such as via a lock in the location.

As illustrated in FIG. 4E, schedule control 444 does not include any dates and/or times, indicating that no schedule has been created for the first guest. In some embodiments, in response to detecting an input directed to schedule control 444, computer system 400 ceases display of review user interface 496 and displays a scheduling user interface to allow the administrator to create a custom schedule for the first guest. For example, the administrator can create a schedule that only provides access to the first guest on Monday, Wednesday, and Friday, from the times of 8:00 AM to 11:00 AM. For another example, the administrator can create a schedule that provides access to the first guest access every Sunday, all day. Additionally, as illustrated in FIG. 4E, schedule control 444 includes edit control 444a. In some embodiments, in response to detecting an input to edit control 444a when no schedule has been created, computer system 400 ceases display of review user interface 496 and displays the scheduling user interface to allow the administrator to create a schedule for the first guest. In some embodiments, in response to detecting an input to edit control 444a when a schedule has been created, computer system 400 ceases display of review user interface 496 and displays the scheduling user interface to allow the administrator to edit an existing schedule for the first guest. It should be recognized that once a schedule is created for the first guest, the first guest is only granted access to the location including to accessories included in accessories control 456 during selected times and/or dates of the schedule. In some embodiments, if the first guest tries to access the location during a time not selected within the schedule, the resident device communicates with computer system 400 to notify the administrator that the first guest is trying to access the location.

As illustrated in FIG. 4E, accessories control 456 does not include any selected accessory indicators, indicating that no accessories have been selected to be controlled by the first guest. In some embodiments, in response to detecting an input directed to accessories control 456, computer system 400 ceases display of review user interface 496 and displays an accessory user interface including a list of accessories at the location. In such embodiments, in response to an input to select an accessory, computer system 400 enables the accessory to be controlled by the first guest. For example, the administrator can grant the first guest access to use a television, lights in the living room, and/or access into the laundry room. For another example, the administrator can grant the first guest access to every accessory at the location. For another example, the administrator can only grant the first guest access to the living room and the backyard. Additionally, as illustrated in FIG. 4E, accessories control 456 includes edit control 456a. In some embodiments, in response to detecting an input to edit control 456a when no accessories have been selected, computer system 400 ceases display of review user interface 496 and displays the accessory user interface to allow the administrator to select which accessories in the location can be accessed by the first guest. In some embodiments, in response to detecting an input to edit control 456a when accessories have been selected, computer system 400 ceases display of review user interface 496 and displays the accessory user interface to allow the administrator to edit which accessories at the location can be accessed by the first guest. In some embodiments, if the first guest tries to access and/or use non-selected accessories, the resident device communicates with computer system 400 to notify the administrator.

In some embodiments, in response to detecting an input directed to remote access control 468, computer system 400 grants the first guest the ability to remotely control accessories that guest has been granted access to at the location from their personal device. For example, the first guest can turn on the lights remotely (e.g., while their personal device is not on the same network as the lights) if given remote access. For another example, the first guest can unlock the front door remotely if given remote access.

At FIG. 4F, time has passed (e.g., time indicator 436 indicates that fifteen minutes have passed since FIGS. 4D-4E) since FIG. 4E. It should be recognized that, in between FIGS. 4E and 4F, the camera detected a second guest approaching the location. At FIG. 4F, in response to detecting the second guest approaching the location, the camera attempted to identify the second guest. It should be recognized that the camera was able to identify the second guest as a private dog walker from the company “Dog Walkerz,” such as through facial recognition and, in response, communicated information of the second guest to the resident device. In response to receiving the communication about the second guest approaching the location, the resident device can communicate with computer system 400 to display content as described below.

As illustrated in FIG. 4F, computer system 400 displays notification 448 in response to receiving a communication from the resident device that the second guest has arrived at the location. As illustrated in FIG. 4F, notification 448 includes information that the second guest was detected at the location by the camera. As illustrated in FIG. 4F, notification 448 includes live feed 448b. Live feed 448b includes second guest representation 448b2 (e.g., the second guest). In some embodiments, computer system 400 displays an indication of an identity of second guest representation 448b2 within notification 448 in response to receiving the communication from the resident device.

In between FIGS. 4F and 4G, the second guest entered a PIN code associated with their profile (e.g., a PIN code such as described above with respect to PIN control 432). In response to detecting the entry of the PIN code, the resident device authenticates the second guest at the entryway of the location and grants the second guest access to the location. Additionally, in between FIGS. 4F and 4G, the resident device detects that the second guest entered the location.

As illustrated in FIG. 4G, in response to the second guest entering the location, computer system 400 ceases display of notification 448 (e.g., including live feed 448b) and displays notification 484. As illustrated in FIG. 4G, notification 484 includes arrival indicator 484a (e.g., “Dog Walkerz arrived”), entry indicator 484b (e.g., “PIN entered at 9:46 AM”), view activity control 484c, review control 484d, and image 484f. As illustrated in FIG. 4G, computer system 400 displays arrival indicator 484a with identification of the second guest because the second guest was able to be identified (e.g., through the entry of the PIN code assigned with a profile created for the location). As illustrated in FIG. 4G, entry indicator 484b includes an indication of the method of entry (e.g., “PIN entered”) and the time of entry (e.g., “9:46 AM”). As illustrated in FIG. 4G, image 484f is a profile picture of the second guest. It should be recognized that image 484f is not an image captured from live feed 448b by a camera connected to and/or in communication with the resident device, as image 484f has the second guest in a pose not in live feed 448b.

In some embodiments, multiple guests can share the same profile. For example, the second guest can be a private dog walker belonging to a company called “Dog Walkerz.” In such an example, the administrator can create a profile for “Dog Walkerz,” and include a PIN code that all employees of “Dog Walkerz” can use to be authenticated and/or gain entry into the location. In such an example, in response to a new guest (e.g., has not previously visited the location) being authenticated with the PIN code for “Dog Walkerz,” computer system 400 sends a request for the new guest to further register their biometric information (e.g., their facial features and/or fingerprint) with the camera and/or the resident device. By requiring the new guest to register their biometric information, computer system 400 enables the new guest to be authenticated without the PIN code and/or to authenticate two ways (e.g., biometric and the PIN code) before granting access to the location.

At FIG. 4G, computer system 400 detects input 405g directed to review control 484d. It should be recognized that input 405g is an example of a selection input as a tap input but can be other inputs, such as a mouse click, a verbal input (e.g., “Let's review that guest.” and/or “Can I check on the profile for that Dog Walkerz.”), and/or a button press.

As illustrated in FIG. 4H, in response to detecting input 405g, computer system 400 ceases display of lock screen user interface 412 and displays review user interface 496. As illustrated in FIG. 4H, review user interface 496 includes a series of user interface elements that correspond to an existing guest profile corresponding to the second guest.

As illustrated in FIG. 4H, image 408 is the same image as image 484f and is a selected profile picture for the second guest. As illustrated in FIG. 4H, create name control 420 includes name indicator 420a (e.g., “Dog Walkerz”), indicating that “Dog Walkerz” is the name assigned to the second guest by the homeowner. As illustrated in FIG. 4H, PIN control 432 includes PIN indicator 432b (e.g., “0305”), indicating that “0305” is the PIN assigned to the second guest. As illustrated in FIG. 4H, schedule control 444 includes schedule indicator 444b (e.g., “Every Saturday”), indicating that the second guest can access the location every Saturday. As illustrated in FIG. 4H, accessories control 456 includes accessories indicator 456b (e.g., “Living room, Backyard”), indicating that the second guest has access to both the living room and the backyard in the location. As illustrated in FIG. 4H, remote access control 468 is toggled on, indicating that the second guest has remote access, as described above.

At FIG. 4I, time has passed since the second guest has arrived (e.g., time indicator 436 indicates that one hour and eighteen minutes have passed since FIG. 4H).

It should be recognized that, in between FIGS. 4H and 4I, the camera detected a third guest approaching the location. It should be recognized that the camera was unable to identify the third guest and, in response, communicated information of the third guest to the resident device. In response to receiving the communication about the third guest approaching the location, the resident device communicates with computer system 400.

As illustrated in FIG. 4I, computer system 400 displays notification 448 within lock screen user interface 412. As illustrated in FIG. 4I, notification 448 includes information that the third guest was detected at the location by the camera. As illustrated in FIG. 4I, live feed 448b includes third guest representation 448b3 (e.g., an entirely new third guest).

In some embodiments, computer system 400 sends alerts to different devices in response to detecting the third guest. Such alerts can correspond to different levels of alerts, each level of alert being sent to a different set of subjects (e.g., devices and/or people). For example, a first level of alerts can be sent to owners of a location, a second level of alerts sent to residents and/or members of the location, and a third level of alerts sent to neighbors and/or a security company as discussed further below. In such embodiments, one level of alert is sent at a time, such that a next level of alert is not sent until it is determined that a previous level of alert has not been handled. In some embodiments, based on a determination that the third guest cannot be identified, computer system 400 causes a personal device (e.g., smartphone, tablet, and/or smartwatch) of an owner of the location (e.g., a homeowner, landlord, and/or property manager) to output a first alert (e.g., a first level of alert). For example, computer system 400 can send a notification to the personal device, the notification causing a visual, audible, and/or haptic output by the personal device (e.g., in response to receiving, viewing, selecting, or otherwise accessing the notification). In such embodiments, after causing the personal device of the owner of the location to output the first alert and based on a determination that the first alert is not handled (e.g., the owner has not identified the third guest, has not determined that the third guest is unwanted or not an intruder, has taken no action to disarm an alarm, in the location, associated with the third guest, or has not identified the third guest in some way as being welcome at the location) within a predetermined period of time (e.g., 30-300 seconds), computer system 400 causes other devices to output a second alert (e.g., one or more levels of alert that are subsequent to the first level of alert). For example, computer system 400 can send a notification (e.g., a second level of alert that is subsequent to the first level of alert) to a personal device of a resident of (e.g., users registered with, associated to, and/or corresponding to) the location, the notification causing a visual, audible, and/or haptic output by the personal device of the resident (e.g., in response to receiving, viewing, selecting, or otherwise accessing the notification). For another example, computer system 400 can send a notification (e.g., a third level of alert that is subsequent to the first level of alert and/or the second level of alert) to a personal device of a member of (e.g., a current guest, a user configured with control of at least one accessory within, and/or other link to) the location, the notification causing a visual, audible, and/or haptic output by the personal device of the member (e.g., in response to receiving, viewing, selecting, or otherwise accessing the notification). For another example, computer system 400 can send a notification (e.g., a fourth level of alert that is before the first level of alert or subsequent to the first level of alert, the second level of alert, and/or the third level of alert) to a device within a logical environment (e.g., as described above with respect to FIG. 3) for (e.g., corresponding to, associated with, assigned to, and/or established for) the location, the notification causing a visual, audible, and/or haptic output by the device (or a device in communication with the device) (e.g., in response to receiving, viewing, selecting, or otherwise accessing the notification). For another example, computer system 400 can send a notification (e.g., a fifth level of alert that is subsequent to the first level of alert, the second level of alert, the third level of alert, and/or the fourth level of alert) to a device associated in some way with the location (e.g., a neighbor device, such as a personal device, an accessory device, or a hub device, that is in another logical environment that is separate from a logical environment for the location, such as a neighbor's logical environment that is part of a neighborhood group of logical environments including the logical environment), the notification causing a visual, audible, and/or haptic output by the device (or a device in communication with the device) (e.g., in response to receiving, viewing, selecting, or otherwise accessing the notification).

In some embodiments, after causing the personal device of the owner of the location to output the first alert and based on a determination that the first alert is handled (e.g., the owner has taken action to disarm any alarms associated with unidentified guests and identify the guest as welcome at the location) within the predetermined period of time, computer system 400 does not cause the other devices (e.g., other than the owner if the owner is a resident) of the location to output the second alert. In some embodiments, the second alert and the first alert are the same. In some embodiments, the first alert and the second alert are different. In some embodiments, when the second alert is handled or stopped (e.g., by a resident), the first alert is maintained. In some embodiments, when the second alert is handled or stopped (e.g., by a resident), the first alert and the second alert (e.g., to residents other than a resident that disarmed the second alarm) are revoked and/or stopped for others receiving alerts. In some embodiments, when the second alert is handled or stopped (e.g., by a resident dismissing the alert), the second alert is maintained for residents other than a resident that dismissed the second alert. In some embodiments, when the first alert is handled or stopped (e.g., by the owner) after the second alert is output, the second alert is revoked and/or stopped for all user devices that received it. It should be recognized that the location can include more than one owner, causing first alerts to be sent to multiple user devices (e.g., the multiple owners'devices) based on the determination that the third guest cannot be identified.

In some embodiments, as part of causing the personal device of the owner of the location and/or the personal devices of the residents of the location to output the first alert or the second alert, computer system 400 causes the personal device of the owner of the location and/or the personal devices of the residents of the location to suspend operating with respect to a particular operating mode. For example, if the personal device of the owner of the location is operating with respect to a do not disturb mode (e.g., a mode where the personal device of the owner of the location suppresses the output of notifications), computer system 400 can cause the personal device of the owner of the location to suspend operating with respect to the do not disturb mode (e.g., when the second alert is caused or when the first alert is caused) such that the personal device of the owner of the location can output the first alert. In some embodiments, instead of, before, after, at the same time as, or as part of causing the personal devices of the residents of the location output the second alert and based on a determination that the location is monitored by a security company, computer system 400 sends a notification to the security company to alert the security company that an unidentified guest is detected. In some embodiments, computer system 400 causes the personal device of the owner of the location and/or the personal devices of the residents of the location to output an alert based on a determination that an unidentified guest entered the location. In some embodiments, computer system 400 causes the personal device of the owner of the location and/or the personal devices of the residents of the location to output an alert based on a determination that an unidentified guest entered the location and remained within the location for a predetermined period of time (e.g., 1-60 minutes). In some embodiments, based on the determination that an unidentified guest entered the location, computer system 400 sends a notification to the security company to alert the security company that an unidentified guest is detected within the location.

At FIG. 4I, computer system 400 detects input 405i directed to get help control 448c. It should be recognized that input 405i is an example of a selection input as a tap input but can be other inputs, such as a mouse click, a verbal input (e.g., “I don't know who that is.”, “Call my emergency contact.”, and/or “Call 911”), and/or a button press.

As illustrated in FIG. 4J, in response to detecting input 405i, computer system 400 displays menu 492 while maintaining display of notification 448 and live feed 448b. Menu 492 includes emergency contact control 492a and contact emergency services control 492b. In some embodiments, in response to detecting an input directed to emergency contact control 492a, computer system 400 ceases display of lock screen user interface 412 and displays a call user interface with an emergency contact for the administrator. In some embodiments the emergency contact is a contact that that the administrator preselected for emergency conditions and/or is automatically set based on frequency of contact (e.g., calls and/or texts). In some embodiments, in a scenario where the administrator has multiple emergency contacts, computer system 400 displays a menu with a list of each emergency contact to allow the administrator to choose which emergency contact to call. In some embodiments, in response to detecting an input directed to contact emergency services control 492b, computer system 400 ceases display of lock screen user interface 412 and displays a call user interface with an emergency service, such as the police.

FIG. 5 is a flow diagram illustrating a process (e.g., process 500) for displaying representations of guests based on authentication in accordance with some embodiments. Some operations in process 500 are, optionally, combined, the orders of some operations are, optionally, changed, and some operations are, optionally, omitted.

As described below, process 500 provides an intuitive way for displaying representations of guests based on authentication. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a computer system (e.g., 400) that is in communication (e.g., wired communication and/or wireless communication) with (and/or includes) one or more display components (e.g., as discussed above with respect to FIG. 4A) (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

The computer system receives (502) an indication (e.g., a notification, alert, and/or data) of an activity (e.g., as discussed above with respect to FIG. 4F) (e.g., video, image, motion sense, and/or door opening/closing) of a subject (e.g., 448b2) (e.g., a user, person, and/or individual) in an environment (e.g., as discussed above with respect to FIG. 4F) (e.g., a physical environment, such as a home, a room, a yard, and/or a building). In some embodiments, the computer system receives the indication of the activity from another computer system (e.g., a camera, a resident device, a phone, a watch, a tablet, a fitness tracking device, a wearable device, an accessory, a speaker, a light, a head-mounted display (HMD), and/or a personal computing device) external to and in communication with the computer system. In some embodiments, the other computer system detects the activity of the subject in the environment. In some embodiments, receiving the indication of the activity includes (and/or is) detecting. via one or more input devices (e.g., a camera, a depth sensor, a microphone, a hardware input mechanism, a rotatable input mechanism, a heart monitor, a temperature sensor, and/or a touch-sensitive surface), an input (e.g., the subject performing the activity in media) corresponding to the indication of the activity of the subject. In some embodiments, the computer system includes and/or is in communication with the one or more input devices. In some embodiments, the indication of the activity of the subject in the environment is a notification. In some embodiments, the subject is a primary and/or nearest user, person, and/or individual.

After (and/or in response to) receiving the indication of the activity of the subject in the environment (and/or in response to the computer system transitioning into an active and/or unlocked mode and/or navigating to a particular user interface), the computer system displays (504), via the one or more display components, a first representation (e.g., 448b) (e.g., video and/or image) of the subject in a first user interface (e.g., 448) (e.g., a lockscreen, home user interface, a user interface of an application, and/or a notification center). In some embodiments, the first representation of the subject is media (e.g., image and/or video) received from an external computer system (e.g., a different external computer system than the external computer system that sent the indication of the activity, and/or the same external computer system that sent the indication of the activity). In some embodiments, the first representation of the subject is media detected via the one or more input devices. In some embodiments, the first representation of the subject includes content captured during, the indication of the activity, before the indication of the activity, and/or after the indication of the activity.

While (506) displaying the first user interface(and/or after displaying the first representation of the subject and/or without receiving a request to dismiss a notification corresponding to the first representation of the subject), in accordance with a determination (508) that the subject is (and/or has been) authenticated (e.g., as discussed above with respect to FIG. 4G) (e.g., identified, characterized, and/or enabled to access the environment), the computer system ceases (510) display of, via the one or more display components, the first representation of the subject. In some embodiments, the determination that the subject is authenticated is based on and/or occurs in response to receiving, from the other computer system, an indication that the subject is and/or has been authenticated. In some embodiments, the determination that the subject is authenticated is based on and/or occurs in response to receiving (e.g., from the computer system, a server, or the other computer system) one or more authorization content (e.g., biometric data, pin code, and/or key). In some embodiments, the determination that the subject is authenticated is based on and/or occurs in response to the subject being authenticated based on the first representation of the subject.

While (506) displaying the first user interface, in accordance with the determination (508) that the subject is authenticated, the computer system displays (512), via the one or more display components, a second representation (e.g., 484f) (e.g., an image and/or contact card) of the subject different from the first representation of the subject.

While (506) displaying the first user interface, in accordance with a determination that the subject is not (and/or has not been) authenticated, the computer system maintains (514) display of, via the one or more display components, the first representation of the subject. In some embodiments, the second representation of the subject is a different size (e.g., the first representation is a first size and the second representation is a second size, wherein the first size is bigger than the first size and/or the second size is bigger than the first size), a different portion (e.g., the first representation is a first portion of content and the second representation is a second portion of the content), and/or a different type of representation (e.g., video, photo, and/or contact card). Changing a representation of a subject after the subject is authenticated allows the computer system to indicate an authentication status of the subject via representations of the subject, thereby providing improved visual feedback to the user and/or performing an operation when a set of conditions has been met without requiring further user input.

In some embodiments, while displaying the first representation of the subject, the computer system forgoes display of, via the one or more display components, the second representation of the subject (e.g., as discussed above with respect to FIG. 4G). In some embodiments, after (and/or in response to) receiving the indication of the activity of the subject in the environment (and/or in response to the computer system transitioning into an active and/or unlocked mode and/or navigating to a particular user interface), the computer system displays, via the one or more display components, the first representation (e.g., video and/or image) of the subject in the first user interface without displaying the second representation of the subject. Only displaying a particular representation of a subject after the subject is authenticated allows the computer system to indicate an authentication status of the subject via representations of the subject, thereby providing improved visual feedback to the user and/or performing an operation when a set of conditions has been met without requiring further user input.

In some embodiments, the subject is a first subject (e.g., as discussed above with respect to FIG. 4A). In some embodiments, after (and/or in response to) receiving an indication (e.g., a notification, alert, and/or data) of an activity (e.g., video, image, motion sense, and/or door opening/closing) of a second subject (e.g., as discussed above with respect to FIG. 4A) (e.g., a user, person, and/or individual) in the environment (and/or in response to the computer system transitioning into an active and/or unlocked mode and/or navigating to a particular user interface): in accordance with a determination that the second subject is not authenticated (e.g., as described above) while receiving the indication of the activity of the second subject, the computer system displays, via the one or more display components, a first representation (e.g., 448b) (e.g., video and/or image) of the second subject. In some embodiments, the second subject is the first subject. In some embodiments, the activity of the second subject is different and/or separate from the activity of the first subject. In some embodiments, after (and/or in response to) receiving an indication (e.g., a notification, alert, and/or data) of an activity (e.g., video, image, motion sense, and/or door opening/closing) of a second subject (e.g., as discussed above with respect to FIG. 4A) (e.g., a user, person, and/or individual) in the environment (and/or in response to the computer system transitioning into an active and/or unlocked mode and/or navigating to a particular user interface): after receiving an indication of an activity of the second subject in the environment: the second subject is the first subject, in accordance with a determination that the second subject is authenticated (e.g., as described above) while receiving the indication of the activity of the second subject, the computer system displays, via the one or more display components, a second representation (e.g., 484e) (e.g., an image and/or contact card) of the second subject, wherein the second representation of the second subject is different from the first representation of the second subject. Only displaying a particular representation of a subject when the subject is authenticated allows the computer system to indicate an authentication status of the subject via representations of the subject, thereby providing improved visual feedback to the user and/or performing an operation when a set of conditions has been met without requiring further user input.

In some embodiments, the indication of the activity of the subject in the environment is received from a resident device of the environment (e.g., as discussed above with respect to FIG. 4A). In some embodiments, the resident device is in communication with and/or manages one or more accessory devices within the environment. Displaying a representation of a subject when the subject is detected in an environment by a resident device of the environment allows the computer system to indicate a current status of the environment as detected by the resident device, thereby providing improved visual feedback to the user and/or performing an operation when a set of conditions has been met without requiring further user input.

In some embodiments, while displaying the first representation of the subject, the computer system displays, via the one or more display components, an indication (e.g., 448a) of how (e.g., via a camera, a microphone, and/or entering a password, such as a PIN code and/or an authentication code) the subject was detected within the environment. In some embodiments, the indication includes an icon, a glyph, and/or a symbol corresponding to how the subject was detected within the environment. For example, the indication can include an image of a camera, an image of a microphone, and/or an indication of a password. In some embodiments, the indication includes text corresponding to how the subject was detected within the environment, such as text including “camera,” “microphone,” or “password.” Displaying an identification of how a subject was detected within an environment after detecting the subject performing an activity allows the computer system to indicate information about the environment and what is occurring in the environment, thereby providing improved visual feedback to the user and/or performing an operation when a set of conditions has been met without requiring further user input.

In some embodiments, while displaying the first representation of the subject, the computer system displays, via the one or more display components, an identification (e.g., 484b) of when the subject was detected within the environment. Displaying an identification of when a subject was detected within an environment after detecting the subject performing an activity allows the computer system to indicate information about the environment and what is occurring when in the environment, thereby providing improved visual feedback to the user and/or performing an operation when a set of conditions has been met without requiring further user input.

In some embodiments, while displaying the first representation of the subject, the computer system displays, via the one or more display components, an identification (e.g., 448b) of where (e.g., “kitchen,” “front door,” “bedroom,” “hallway,” and/or the like) the subject was detected within the environment. In some embodiments, the identification of where the subject was detected within the environment is generated by the computer system based on a visual analysis of the environment. In some embodiments, the identification of where the subject was detected within the environment is assigned by a user before receiving the indication of the activity of the subject in the environment. In some embodiments, the identification of where the subject was detected within the environment is based on which camera detects the activity of the subject. Displaying an identification of where a subject was detected within an environment after detecting the subject performing an activity allows the computer system to indicate information about the environment and what is occurring where in the environment, thereby providing improved visual feedback to the user and/or performing an operation when a set of conditions has been met without requiring further user input.

In some embodiments, the computer system is in communication with (and/or includes) one or more input devices (e.g., as discussed above with respect to FIG. 4A) (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, while displaying the first representation of the subject, the computer system detects, via the one or more input devices, an input (e.g., as discussed above with respect to FIG. 4A) (e.g., a tap input and/or a voice request). In some embodiments, in response to detecting the input, in accordance with a determination that the input corresponds to a request to allow (and/or enable) the subject to have access to (and/or entry of) the environment (e.g., 405a), the computer system ceases display of, via the one or more display components, the first representation of the subject (and/or forgoes display of, via the one or more display components, the second representation of the subject). In some embodiments, in response to detecting the input, in accordance with a determination that the input corresponds to a request to deny (and/or prevent) the subject to have access to (and/or entry of) the environment (e.g., 405i), the computer system displays, via the one or more display components, a control for performing a remediation operation with respect to the subject (e.g., 492a and/or 492b). In some embodiments, while displaying the control for performing the remediation operation with respect to the subject, the computer system detects, via the one or more input devices, an input (e.g., a tap input and/or a voice request) corresponding to the control for performing the remediation operation with respect to the subject. In some embodiments, in response to detecting the input corresponding to the control for performing the remediation operation with respect to the subject, the computer system initiates an alarm. In some embodiments, the remediation operation includes the alarm. In some embodiments, in response to detecting the input corresponding to the control for performing the remediation operation with respect to the subject, the computer system contacts a resource (e.g., emergency contact, an Emergency Call Center (ECC), and/or 911) for emergency assistance. In some embodiments, the remediation operation includes the contacting the resource. In some embodiments, in response to detecting the input and in accordance with the determination that the input corresponds to the request to allow the subject to have access to (and/or entry of) the environment, the computer system forgoes display of the control for performing the remediation operation with respect to the subject. Providing controls to allow or deny a subject to have access to an environment while displaying a representation of the subject allows the computer system to manage who has access and, if the subject does not have access, to remediate their presence, thereby providing improved visual feedback to the user and/or performing an operation when a set of conditions has been met without requiring further user input.

In some embodiments, in response to detecting the input and in accordance with the determination that the input corresponds to the request to allow the subject to have access to the environment (e.g., 405a), the computer system displays, via the one or more display components, an amount of time that the subject is allowed to have access to the environment (e.g., 460a, 406b, and/or 406c) (e.g., until end of day, for one hour, for 6 hours, indefinitely, and/or the like). In some embodiments, the amount of time is set via the computer system in conjunction with (e.g., before, after, and/or while) and/or as part of detecting the input that corresponds to the request to allow the subject to have access to the environment. Displaying an amount of time that a subject is allowed to have access to an environment when allowing the subject to have access to the environment allows the computer system to indicate a state of those within the environment and to confirm how the subjects have been configured, thereby providing improved visual feedback to the user and/or performing an operation when a set of conditions has been met without requiring further user input.

In some embodiments, the first representation of the subject includes media (e.g., audio, an image, and/or a video) of a portion (e.g., including the subject) of the environment (e.g., 448b). A representation of a subject detected in an environment before the subject is authenticated including media of a portion of the environment allows the computer system to represent who is detected in the environment with a live view, thereby providing improved visual feedback to the user and/or performing an operation when a set of conditions has been met without requiring further user input.

In some embodiments, the subject is a first subject (e.g., as discussed above with respect to FIG. 4A). In some embodiments, after (and/or in response to) receiving an indication (e.g., a notification, alert, and/or data) of an activity (e.g., video, image, motion sense, and/or door opening/closing) of a second subject (e.g., 448b1) (e.g., a user, person, and/or individual) in the environment (and/or in response to the computer system transitioning into an active and/or unlocked mode and/or navigating to a particular user interface): the second subject is the first subject, in accordance with a determination that a registered subject (e.g., as discussed above with respect to FIG. 4A) (e.g., an owner, a guest, and/or a registered user) is located (and/or remains) within the environment (e.g., as discussed above with respect to FIG. 4A), the computer system forgoes display of, via the one or more display components, a representation (e.g., video, image, and/or contact card) of the second subject, wherein the registered subject is different from the second subject. In some embodiments, the activity of the second subject is different and/or separate from the activity of the first subject. In some embodiments, after receiving an indication of an activity of the second subject in the environment: the second subject is the first subject, in accordance with a determination that a (and/or any) registered subject (e.g., an owner, a guest, and/or a registered user) is not located (and/or does not remain) within the environment (e.g., as discussed above with respect to FIG. 4A) (and/or that the second subject is authenticated (e.g., as described above) while receiving the indication of the activity of the second subject and/or that the second subject is not authenticated (e.g., as described above) while receiving the indication of the activity of the second subject), the computer system displays, via the one or more display components, a representation (e.g., 448b) (e.g., an image, a video, and/or contact card) of the second subject, wherein the registered subject is different from the second subject. Only displaying a representation of a subject detected in an environment when a registered subject is not located within the environment allows the computer system to report on new subjects within the environment when there is not already a registered subject in the environment, thereby providing improved visual feedback to the user and/or performing an operation when a set of conditions has been met without requiring further user input.

In some embodiments, while displaying the second representation of the subject, the computer system displays, via the one or more display components, an identification (e.g., as discussed above with respect to FIG. 4G) of where (e.g., “kitchen,” “front door,” “bedroom,” “hallway,” and/or the like) the subject was authenticated. In some embodiments, the identification of where the subject was authenticated is generated by the computer system based on a visual analysis of the environment. In some embodiments, the identification of where the subject was authenticated is assigned by a user before receiving the indication of the activity of the subject in the environment. In some embodiments, the identification of where the subject was authenticated is based on which camera detects the activity of the subject. Displaying an identification of where a subject was authenticated after detecting the subject performing an activity allows the computer system to indicate information about the environment and what is occurring where in the environment, thereby providing improved visual feedback to the user and/or performing an operation when a set of conditions has been met without requiring further user input.

In some embodiments, while displaying the second representation of the subject, the computer system displays, via the one or more display components, an identification (e.g., 484b) of when the subject was authenticated. Displaying an identification of when a subject was authenticated after detecting the subject performing an activity allows the computer system to indicate information about the environment and what is occurring when in the environment, thereby providing improved visual feedback to the user and/or performing an operation when a set of conditions has been met without requiring further user input.

In some embodiments, the computer system is in communication with (and/or includes) one or more input devices (e.g., as discussed above with respect to FIG. 4A) (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, while displaying the second representation of the subject, the computer system displays, via the one or more display components, a user interface element (e.g., 484d) to review access to the environment. In some embodiments, while displaying the user interface element to review access to the environment, the computer system detects, via the one or more input devices, an input (e.g., 405d and/or 405g) (e.g., a tap input and/or a voice request) corresponding to (e.g., selecting and/or at a location of) the user interface element to review access to the environment. In some embodiments, in response to detecting the input corresponding to the user interface element to review access to the environment, the computer system displays, via the one or more display components, a user interface (e.g., 496) for access permission assigned to the subject for the environment (e.g., as described below with respect to process 600). In some embodiments, the user interface for access permission assigned to the subject for the environment includes identification of one or more days, months, years, and/or times that the subject is allowed access to the environment. In some embodiments, the user interface for access permission assigned to the subject for the environment includes identification of one or more computer systems within the environment that the subject is allowed access (and/or control). In some embodiments, the user interface for access permission assigned to the subject for the environment includes identification of one or more passwords, passcodes, and/or PIN codes usable by the subject for access to the environment. Displaying a user interface for access permission assigned to a subject for an environment in response to detecting an input on a control displayed while displaying a representation of the subject that is displayed when the subject has been authenticated allows the computer system to provide a user experience for viewing and/or editing access permission when subjects are detected within the environment, thereby providing improved visual feedback to the user and/or performing an operation when a set of conditions has been met without requiring further user input.

In some embodiments, the computer system is in communication with (and/or includes) one or more input devices (e.g., as discussed above with respect to FIG. 4A) (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, while displaying the second representation of the subject (and/or while displaying the first representation of the subject), the computer system displays, via the one or more display components, a control (e.g., as discussed above with respect to FIG. 4I) to contact the subject. In some embodiments, while displaying the control to contact the subject, the computer system detects, via the one or more input devices, an input (e.g., a tap input and/or a voice request) corresponding to (e.g., selecting and/or at a location of) the control to contact the subject. In some embodiments, in response to detecting the input corresponding to the control to contact the subject, the computer system displays, via the one or more display components, a user interface (e.g., as discussed above with respect to FIG. 4I) to communicate with the subject. In some embodiments, the user interface to communicate with the subject is a call user interface for initiating a call (e.g., a video and/or audio call) with the subject (e.g., a personal device corresponding to the subject). In some embodiments, the user interface to communicate with the subject is a messaging user interface for messaging (e.g., SMS and/or instant messaging) the subject (e.g., a personal device corresponding to the subject). In some embodiments, in response to detecting the input corresponding to the control to contact the subject, the computer system initiates a communication (e.g., a video and/or audio call) with the subject. Displaying a user interface to communicate with a subject in response to detecting an input on a control displayed while displaying a representation of the subject that is displayed when the subject has been authenticated allows the computer system to provide a user experience for communicating with administrators of a location, thereby providing improved visual feedback to the user and/or performing an operation when a set of conditions has been met without requiring further user input.

In some embodiments, the computer system is in communication with (and/or includes) one or more input devices (e.g., as discussed above with respect to FIG. 1) (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, while displaying the second representation of the subject, the computer system displays, via the one or more display components, a control (e.g., 484c) to view activity of the subject within the environment. In some embodiments, while displaying the control to view activity of the subject within the environment, the computer system detects, via the one or more input devices, an input (e.g., as discussed above with respect to FIG. 4D) (e.g., a tap input and/or a voice request) corresponding to (e.g., selecting and/or at a location of) the control to view activity of the subject. In some embodiments, in response to detecting the input corresponding to the control to view activity of the subject, the computer system displays, via the one or more display components, a representation of (e.g., as discussed above with respect to FIG. 4D) (e.g., text, an image, and/or a video corresponding to) a first activity performed by the subject within the environment (e.g., as discussed above with respect to FIG. 4D) and a representation of (e.g., as discussed above with respect to FIG. 4D) (e.g., text, an image, and/or a video corresponding to) a second activity performed by the subject within the environment (e.g., as discussed above with respect to FIG. 4D), wherein the representation of the first activity is separate from the representation of the second activity. In some embodiments, the second activity is different and/or separate from the first activity. In some embodiments, the first activity and the second activity are determined to be part of the same session, such as proximate in time and/or location and/or part of a single visit by the subject to the environment. In some embodiments, the first activity and/or the second activity is detected via one or more cameras. In some embodiments, the first activity is detected via a first camera and the second activity is detected via a second camera separate from the first camera. Displaying separate representations of separate activities performed by a subject within an environment in response to detecting an input on a control displayed while displaying a representation of the subject that is displayed when the subject has been authenticated allows the computer system to provide a user experience for understanding activities performed by the subject, thereby providing improved visual feedback to the user and/or performing an operation when a set of conditions has been met without requiring further user input.

In some embodiments, the second representation of the subject includes an image (e.g., 484e and/or 484f) of the subject. In some embodiments, the image of the subject is captured within the environment. In some embodiments, the image of the subject is captured when the subject is authenticated. In some embodiments, the image of the subject is captured when the subject is detected within the environment. In some embodiments, the image of the subject is included in a contact card corresponding to the subject. A representation of a subject occluding an image of the subject when the subject is authenticated allows the computer system to indicate who has been authenticated, thereby providing improved visual feedback to the user and/or performing an operation when a set of conditions has been met without requiring further user input.

In some embodiments, the image of the subject is captured via another computer system (e.g., an external device, such as a camera accessory and/or a smart phone) separate from the computer system (e.g., as discussed above with respect to FIG. 4A).

In some embodiments, the second representation of the subject includes an identification (e.g., 484a) (e.g., a name, a unique identifier, and/or a username) of the subject. A representation of a subject occluding an identification of the subject when the subject is authenticated allows the computer system to indicate who has been authenticated, thereby providing improved visual feedback to the user and/or performing an operation when a set of conditions has been met without requiring further user input.

Note that details of the processes described above with respect to process 500 (e.g., FIG. 5) are also applicable in an analogous manner to other processes described herein. For example, process 500 optionally includes one or more of the characteristics of the various processes described above with reference to process 500. For example, the representation of the notification of process 600 can be the first representation of the subject of process 500. For brevity, these details are not repeated herein.

FIG. 6 is a flow diagram illustrating a process (e.g., process 600) for displaying access permissions in accordance with some embodiments. Some operations in process 600 are, optionally, combined, the orders of some operations are, optionally, changed, and some operations are, optionally, omitted.

As described below, process 600 provides an intuitive way for displaying access permissions. Process 600 reduces the cognitive burden on a user, thereby creating a more efficient human-machine interface. For battery-operated computing devices, enabling a user to interact with such devices faster and more efficiently conserves power and increases the time between battery charges.

In some embodiments, process 600 is performed at a computer system (e.g., 400) that is in communication (e.g., wired communication and/or wireless communication) with (and/or includes) one or more input devices (e.g., as discussed above with respect to FIG. 4A) (e.g., a camera, a depth sensor, a microphone, a hardware input mechanism, a rotatable input mechanism, a heart monitor, a temperature sensor, and/or a touch-sensitive surface) and one or more display components (e.g., as discussed above with respect to FIG. 4A) (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

The computer system receives (602) a notification (e.g., as discussed above with respect to FIG. 4A) that a subject (e.g., 448b1 and/or 448b2) (e.g., a user, person, and/or individual) is present at (e.g., located at and/or at a position corresponding to) a location (e.g., as discussed above with respect to FIG. 4A) (e.g., a physical and/or geographical location). In some embodiments, the location corresponds to a portion of a home, a room, a yard, and/or a building. In some embodiments, the notification that the subject is present at the location is received from an external computer system and/or the computer system. In some embodiments, the notification that the subject is present at the location is received via the one or more input devices. In some embodiments, the subject is a primary and/or nearest user, person, and/or individual.

After receiving the notification that the subject is present at the location, the computer system displays (604), via the one or more display components, a representation (e.g., 448b) (e.g., a graphical and/or textual representation) of the notification with a user interface element (e.g., 448) (e.g., an icon, a widget, and/or a control) to review access to the location. In some embodiments, the user interface element to review access is displayed within and/or adjacent to the representation of the notification with the user interface element.

While displaying the representation of the notification with the user interface element to review access to the location, the computer system detects (606), via one or more input devices, an input (e.g., 405d and/or 405f) (e.g., a tap input, a voice input, and/or an air gesture) corresponding to the user interface element to review access to the location. In some embodiments, the tap input is on the user interface element to review access to the location. In some embodiments, the voice input includes a request to select the user interface element to review access to the location (e.g., “Select ‘review’”). In some embodiments, the air gesture includes a gesture corresponding to a request to select the user interface element to review access to the location (e.g., a pinch and/or swipe).

In response to detecting the input corresponding to the user interface element to review access to the location, the computer system displays (608), via the one or more display components, a user interface (e.g., 496) including (and/or corresponding to) access permission (e.g., access permission of the subject, and/or authorization of the subject) assigned to the subject for the location. In some embodiments, in response to detecting the input corresponding to the user interface element to review access to the location, the computer system ceases display of the representation of the notification with the user interface element to review access to the location. In some embodiments, the user interface including the access permission assigned to the subject for the location includes the representation of the access permission assigned to the subject. In some embodiments, the computer system displays the user interface including the access permission assigned to the location while displaying the representation of the notification with the user interface element to review access to the location. In some embodiments, the user interface including the access permission assigned to the subject for the location includes a representation (e.g., a graphical and/or textual representation) of the access permission assigned to the subject. In some embodiments, the user interface including the access permission assigned to the subject for the location includes a representation (e.g., a graphical and/or textual representation) of one or more accessories at the location that the subject is enabled and/or disabled to control, access, and/or operate. In some embodiments, the user interface includes an indication of access permission assigned to the subject for the location. In response to detecting an input while displaying a notification that a subject is present at a location, displaying a user interface including access permission assigned to the subject for the location allows the computer system to review access permission whenever the subject is detected at the location, thereby reducing the number of inputs needed to perform an operation and/or performing an operation when a set of conditions has been met without requiring further user input.

In some embodiments, the subject is an unknown (and/or unrecognized, unidentified, and/or unauthenticated) subject (e.g., as discussed above with respect to FIG. 4A) (e.g., unknown to the computer system and/or a security system associated with and/or corresponding to the location). In response to detecting an input while displaying a notification that an unknown subject is present at a location, displaying a user interface including access permission assigned to the unknown subject for the location (in some embodiments, such access permission is nothing until a user of the computer system grants the unknown such access permission via the user interface) allows the computer system to provide a quick way to create, add, and/or modify access permission for the unknown subject whenever the unknown subject is detected at the location, thereby reducing the number of inputs needed to perform an operation and/or performing an operation when a set of conditions has been met without requiring further user input.

In some embodiments, the subject is a known (and/or recognized, identified, and/or authenticated) subject (e.g., as discussed above with respect to FIG. 4A) (e.g., known to the computer system and/or a security system associated with and/or corresponding to the location). In response to detecting an input while displaying a notification that a known subject is present at a location, displaying a user interface including access permission assigned to the known subject for the location allows the computer system to provide a quick way to create, add, and/or modify access permission for the known subject whenever the known subject is detected at the location, thereby reducing the number of inputs needed to perform an operation and/or performing an operation when a set of conditions has been met without requiring further user input.

In some embodiments, the notification that the subject is present at the location is received from a resident device (e.g., as discussed above with respect to FIG. 4A) for (and/or of, associated with, and/or corresponding to) the location. In some embodiments, the resident device is in communication with and/or manages one or more accessory devices within, associated with, and/or corresponding to the location. In response to detecting an input while displaying a notification received from a resident device that a subject is present at a location, displaying a user interface including access permission assigned to the subject for the location allows the computer system to review access permission whenever the subject is detected at the location and then manage such access permission via the resident device, thereby reducing the number of inputs needed to perform an operation and/or performing an operation when a set of conditions has been met without requiring further user input.

In some embodiments, the representation of the notification includes an image (e.g., 448b) (e.g., captured when the subject is authenticated, when the subject is detected, and/or that is part of a contact card corresponding to the subject) of the subject. Displaying an image of a subject within a representation of a notification that the subject is present at a location allows the computer system to identify who is at the location and enable to a user to determine whether to modify access permission for the subject, thereby reducing the number of inputs needed to perform an operation and/or performing an operation when a set of conditions has been met without requiring further user input.

In some embodiments, the representation of the notification includes an identification (e.g., 484a) (e.g., a name, a username, and/or a unique identifier) of the subject. Displaying an identification of a subject within a representation of a notification that the subject is present at a location allows the computer system to identify who is at the location and enable to a user to determine whether to modify access permission for the subject, thereby reducing the number of inputs needed to perform an operation and/or performing an operation when a set of conditions has been met without requiring further user input.

In some embodiments, the representation of the notification includes an indication (e.g., 484b) of how (e.g., via a camera, a microphone, and/or entering a password, such as a PIN code and/or an authentication code) the subject was authenticated (e.g., as discussed above with respect to FIG. 4G). In some embodiments, the indication includes an icon, a glyph, and/or a symbol corresponding to how the subject was authenticated. For example, the indication can include an image of a camera, an image of a microphone, and/or an indication of a password. In some embodiments, the indication includes text corresponding to how the subject was authenticated, such as text including “camera,” “microphone,” or “password.” Displaying an identification of how a subject was authenticated within a representation of a notification that the subject is present at a location allows the computer system to identify how the subject is configured to be authenticated and whether such authentication is reliable (e.g., camera v. PIN code), thereby reducing the number of inputs needed to perform an operation and/or performing an operation when a set of conditions has been met without requiring further user input.

In some embodiments, the representation of the notification includes an indication (e.g., 484b) of when the subject was authenticated (e.g., as discussed above with respect to FIG. 4G). Displaying an indication of when a subject was authenticated within a representation of a notification that the subject is present at a location allows the computer system to identify details about authentication so that a user can determine whether to modify access permission for the subject, thereby reducing the number of inputs needed to perform an operation and/or performing an operation when a set of conditions has been met without requiring further user input.

In some embodiments, the representation of the notification includes a control (e.g., 484c) to view activity of the subject at the location. In some embodiments, while displaying the control to view activity of the subject at the location, the computer system detects, via the one or more input devices, an input (e.g., as discussed above with respect to FIG. 4D) (e.g., a tap input and/or a voice request) corresponding to (e.g., selecting and/or at a location of) the control to view activity of the subject. In some embodiments, in response to detecting the input corresponding to the control to view activity of the subject, the computer system displays, via the one or more display components, a representation of (e.g., text, an image, and/or a video corresponding to) a first activity performed by the subject at the location (e.g., as discussed above with respect to FIG. 4D) and a representation of (e.g., text, an image, and/or a video corresponding to) a second activity performed by the subject at the location (e.g., as discussed above with respect to FIG. 4D), wherein the representation of the first activity is separate from the representation of the second activity. In some embodiments, the second activity is different and/or separate from the first activity. In some embodiments, the first activity and the second activity are determined to be part of the same session, such as proximate in time and/or location and/or part of a single visit by the subject at the location. In some embodiments, the first activity and/or the second activity is detected via one or more cameras. In some embodiments, the first activity is detected via a first camera and the second activity is detected via a second camera separate from the first camera. Displaying separate representations of separate activities performed by a subject at a location in response to detecting an input on a control displayed while displaying a representation of a notification that the subject is present at the location allows the computer system to provide a user experience for understanding activities performed by the subject, thereby providing improved visual feedback to the user and/or performing an operation when a set of conditions has been met without requiring further user input.

In some embodiments, the representation of the notification includes video of the subject at the location (e.g., as discussed above with respect to FIG. 4A). In some embodiments, the video is captured at the location when the subject is detected at the location. Displaying a video of a subject within a representation of a notification that the subject is present at a location allows the computer system to identify who is at the location and enable to a user to determine whether to modify access permission for the subject, thereby reducing the number of inputs needed to perform an operation and/or performing an operation when a set of conditions has been met without requiring further user input.

In some embodiments, the user interface including the access permission (e.g., access permission of the subject, and/or authorization of the subject) assigned to the subject for the location includes an identification (e.g., 484a) (e.g., a name and/or an image, such as an image captured when the subject is authenticated, when the subject is detected at the location, and/or from a contact card corresponding to the subject) of the subject. In some embodiments, the identification of the subject is included in the representation of the notification. Displaying a user interface including (1) access permission assigned to a subject for a location and (2) an identification of the subject allows the computer system to indicate who such access permission pertains, thereby providing improved visual feedback to the user and/or performing an operation when a set of conditions has been met without requiring further user input.

In some embodiments, the user interface including the access permission (e.g., access permission of the subject, and/or authorization of the subject) assigned to the subject for the location includes: an indication (e.g., 444) of a frequency of access (e.g., a schedule, a set of days, times, weeks, months, and/or years) for the subject with respect to the location; an indication (e.g., 465) of one or more computer systems (e.g., accessory devices, communal devices, and/or other electronic devices) at the location that are configured to be controlled by the subject. In some embodiments, the one or more computer systems are external to the computer system; an indication (e.g., 468) of whether the subject has remote access permission for the location (e.g., permission to control one or more computer systems at the location while the subject is remote from the location, such as not in communication with a local network corresponding to the location); or an indication (e.g., 432) of one or more credentials (e.g., a code, a password, a PIN code, and/or other credential) assigned to the subject for access at the location. Displaying a user interface including (1) access permission assigned to a subject for a location and (2) different indications of such access permission allows the computer system to indicate what access permission is defined for the subject, thereby providing improved visual feedback to the user and/or performing an operation when a set of conditions has been met without requiring further user input.

In some embodiments, the user interface element to review access to the location is a user interface element (e.g., 460a, 460b, and/or 460c) to allow access to the location for a period of time (e.g., 1 hour, 2 hours, 1 day, 1 week, or indefinitely). In some embodiments, the user interface including access assigned to the subject for the location includes a confirmation (e.g., as discussed above with respect to FIG. 4B) that the subject has been granted access to the location for the period of time. Displaying a user interface including (1) access permission assigned to a subject for a location and (2) a confirmation that the subject has been granted access to the location for a period of time allows the computer system to indicate what access permission is defined for the subject, thereby providing improved visual feedback to the user and/or performing an operation when a set of conditions has been met without requiring further user input.

FIGS. 7A-7G illustrate exemplary user interfaces for alerting devices of detected subjects in accordance with some embodiments. The user interfaces in these figures are used to illustrate the processes described below, including the processes in FIG. 8.

FIGS. 7A-7G are split between a left portion, a middle portion, and a right portion. The left portion illustrates resident computer system 700 as a smart phone. It should be recognized that resident computer system 700 can be other types of computer systems such as a tablet, a smart watch, a laptop, an accessory, a personal gaming system, a desktop computer, a fitness tracking device, a communal device, and/or a head-mounted display (HMD) device. In some embodiments, resident computer system 700 includes and/or is in communication with one or more input devices (e.g., a sensor, a camera, a lidar detector, a motion sensor, an infrared sensor, a touch-sensitive surface, a physical input mechanism, and/or a microphone). In some embodiments, resident computer system 700 includes and/or is in communication with one or more output devices (e.g., a display screen, a projector, a touch-sensitive display, and/or a speaker). In some embodiments, resident computer system 700 belongs to, is registered to, corresponds to, and/or is associated with a homeowner (e.g., a primary resident and/or an administrator) of physical environment 708. In some embodiments, resident computer system 700 is part of, an administrator for, and/or a controller of a logical environment (e.g., as described above with respect to FIG. 3) corresponding to and/or associated with physical environment 708. At FIGS. 7A-7G, resident computer system 700 belongs to John, the homeowner of physical environment 708.

The middle portion illustrates resident computer system 704 as a smart phone. It should be recognized that resident computer system 704 can be other types of computer systems such as a tablet, a smart watch, a laptop, a communal device, a smart speaker, an accessory, a personal gaming system, a desktop computer, a fitness tracking device, and/or a head-mounted display (HMD) device. In some embodiments, resident computer system 704 is part of, an administrator for, and/or a controller of the logical environment corresponding to and/or associated with physical environment 708. In some embodiments, resident computer system 704 belongs to, is registered to, corresponds to, and/or is associated with a resident of physical environment 708. Examples of a resident include a homeowner, a parent, a spouse, a child, a guest, a family member, a neighbor, a friend, a maid, a dog walker, and/or a babysitter. In such embodiments, resident computer system 704 has access to physical environment 708 (e.g., has access to and/or is able to control one or more accessory devices that are part of the logical environment). In some embodiments, resident computer system 704 is associated with physical environment 708 but does not have full control, permissions, and/or authority over physical environment 708 (e.g., one or more accessory devices that are part of the logical environment). In some embodiments, different residents have different permissions and/or capabilities within physical environment 708 (and/or with respect to devices included in the logical environment). For example, resident computer system 700 can have higher and/or more permissions than resident computer system 704 because resident computer system 700 belongs to John who owns physical environment 708. In some embodiments, if John is renting physical environment 708, resident computer system 700 has higher and/or more permissions than resident computer system 704 because resident computer system 700 is the device that set up various devices and/or networks within and/or associated with physical environment 708 (and/or included in the logical environment). At FIGS. 7A-7G, resident computer system 704 belongs to John's daughter, Jane.

The right portion illustrates a top-down schematic view of physical environment 708. In some embodiments, physical environment 708 is a home, a school, an apartment, a warehouse, and/or an office. Physical environment 708 includes resident computer system 704 and hub device 710. In some embodiments, devices located in physical environment 708 are part of the logical environment. For example, the devices can be part of the logical environment based on association with an ID corresponding to John (e.g., through John's personal device and/or resident computer system 700), based on location (e.g., the devices are within physical environment 708 and/or a physical environment associated with John), and/or based on communication with hub device 710.

In some embodiments, hub device 710 is a central computer system within physical environment 708 that connects to, manages, communicates with, and/or facilitates communication between multiple computer systems and/or devices within physical environment 708 through the logical environment. In some embodiments, devices within the logical environment communicate through hub device 710. For example, in response to detecting an unidentified subject, a camera communicates with hub device 710, which then communicates with resident computer system 700. In other embodiments, devices within the logical environment communicate directly without going through hub device 710. For example, in response to detecting an unidentified subject, a camera communicates with resident computer system 700. In some embodiments, devices within the logical environment communicate through a network device and/or an access point that establishes a wireless and/or wired communication network. For example, a camera communicates with hub device 710 through a wireless network provided by the network device.

In some embodiments, hub device 710 includes and/or is in communication with one or more sensors (e.g., a camera, a LiDAR detector, a motion sensor, an infrared sensor, ultra-wideband (UWB) and/or a microphone). Such sensors can be used to detect presence, attention, statements, requests, and/or instructions from a subject in an environment. In some embodiments, a camera accessory device is included in (e.g., is a part of and/or is connected to) hub device 710. In some embodiments, hub device 710 is in communication with a camera accessory device within physical environment 708. At FIG. 7A, hub device 710 is in communication with both resident computer system 700 and resident computer system 704. In some embodiments, physical environment 708 includes more, less, and/or different rooms, objects, subjects, and/or devices.

In some embodiments, resident computer system 700 and resident computer system 704 include and/or are in communication with one or more input devices (e.g., a sensor, a camera, a LiDAR detector, a motion sensor, an infrared sensor, a touch-sensitive surface, a physical input mechanism, and/or a microphone). In some embodiments, each of resident computer system 700 and resident computer system 704 include and/or are in communication with one or more output devices (e.g., a display screen, a projector, a touch-sensitive display, and/or a speaker).

While FIGS. 7A-7G illustrate both resident computer system 700 and resident computer system 704 outputting particular content, it should be recognized that such content is merely for explanatory purposes and that such content can be in different forms, at different locations, at different sizes, include different content, and/or that more, fewer, and/or different content can be output in accordance with techniques described herein. It should also be recognized that, while the description below refers to each of resident computer system 700 and resident computer system 704 outputting content, other devices can output the same or similar content in addition to or instead of resident computer system 700 and/or resident computer system 704. Such other devices can correspond to other residents of physical environment 708 and/or can be other devices that share a relationship with the devices associated with physical environment 708. For example, a smartphone belonging to a trusted neighbor can output similar content, as described below. For another example, a tablet belonging to John's wife can output similar content, as described below. For another example, a desktop computer belonging to a third-party security service can output similar content, as described below.

FIGS. 7A-7G illustrate the relationship between resident computer system 700 and resident computer system 704 during a process of alerting devices of detected subjects. While the figures illustrate resident computer system 700 receiving notification content before resident computer system 704 to prioritize a homeowner, administrator, and/or primary resident in reviewing subjects and/or security measures, it should be recognized that other relationships can apply to the process. For example, resident computer system 700 can belong to a landlord and resident computer system 704 can belong to a tenant. For another example, resident computer system 700 can belong to an owner and resident computer system 704 can belong to an occupant and/or guest.

Further, while explained in FIGS. 7A-7G as a sequential process of notifying a device (e.g., resident computer system 700) before one or more other devices (e.g., resident computer system 704 and/or another device), it should be recognized that the process outlined below can be done in parallel and/or in alternative orders. For example, instead of notifying only resident computer system 700 in response to subject 712's presence, hub device 710 can communicate with both resident computer system 700 and resident computer system 704 at the same time. In such an example, hub device 710 can communicate with both resident computer system 700 and resident computer system 704 based on a threat level of subject 712 being over a threshold amount (e.g., subject 712 is detected with a weapon and/or subject 712 attempts to break in and/or breaks into physical environment 708). For another example, alongside communicating with resident computer system 700 and/or resident computer system 704, hub device 710 can communicate with a third party (e.g., a trusted neighbor, a law enforcement authority, a third-party monitoring service, and/or a security service) based on a threat level of subject 712 being over a threshold amount (e.g., subject 712 is detected with a weapon and/or subject 712 attempts to break in and/or breaks into physical environment 708).

As illustrated in FIG. 7A, resident computer system 700 displays lock screen user interface 602 including a time of “9:34” and a date of Wednesday, May 10th. In some embodiments, a lock screen is a user interface (e.g., a wake screen and/or an initial user interface) that resident computer system 700 displays when coming out of (e.g., transitioning from) a lower-power state (e.g., a low-power state, a reduced-power state, a resting state, a sleep state, off state, and/or a dimmed state) to a higher-power state (e.g., an active state, full-power state, on state, and/or awake state). Additionally, resident computer system 704 displays lock screen user interface 706. As illustrated in FIG. 7A, lock screen user interface 706 includes the same date and time as lock screen user interface 702, as well as a weather widget. At FIG. 7A, resident computer system 700 is located outside of physical environment 708 (e.g., resident computer system 700 is with John at work). As illustrated in FIG. 7A, resident computer system 706 is located within physical environment 708 (e.g., resident computer system 704 is with Jane within physical environment 708). In some embodiments, resident computer system 704 is computer system specific to, associated with, and/or restricted to physical environment 708, such as a hub device and/or a communal device. In other embodiments, resident computer system 704 is a personal computer system for Jane, such as a smartphone and/or wearable device on and/or carried by Jane.

In some embodiments, resident computer system 700 is a hub device and resident computer system 704 is a personal device belonging to John. In such embodiments, in response to detecting an unidentified subject, computer system 700 communicates, to one or more devices within and/or associated with physical environment 708, information corresponding to detection of the unidentified subject. For example, in response to detecting the unidentified subject, resident computer system 700 causes an alarm to be output by one or more speakers located within physical environment 708. In such an example, in response to a determination that the alarm has not been dismissed and/or interacted with, resident computer system 700 communicates information corresponding to the detection of the unidentified subject to resident computer system 704.

In some embodiments, resident computer system 700 is a personal device belonging to John and resident computer system 704 is a hub device. In such embodiments, in response to detecting an unidentified subject, resident computer system 704 communicates, to one or more devices within and/or associated with physical environment 708, information corresponding to detection of the unidentified subject. For example, in response to detecting the unidentified subject, resident computer system 704 communicates information corresponding to the detection of the unidentified subject to resident computer system 700. In such an example, in response to a determination that the alarm has not been dismissed and/or interacted with, resident computer system 704 causes an alarm to be output by one or more speakers located within physical environment 708.

At FIG. 7B, hub device 710 receives information that subject 712 is outside of physical environment 708. In some embodiments, hub device 710 receives the information that subject 712 is outside of physical environment 708 from another device within and/or associated with physical environment 708, such as a camera and/or a motion sensor. For example, a camera associated with physical environment 708 sends one or more images of subject 712 to hub device 710. For another example, after capturing one or more images of subject 712, a camera associated with physical environment 708 sends an indication and/or an identification of subject 712 to hub device 710 (e.g., rather or in addition to the one or more images). In some embodiments, hub device 710 detects that subject 712 is outside of physical environment 708 rather than another device within and/or associated with physical environment 708.

In some embodiments, subject 712 is detected based on their presence in a monitored zone, such as an entryway, a door, and/or a back entrance. In such embodiments, a monitored zone can be created by a homeowner, an administrator, and/or a primary resident through an application, such as a home management application and/or a security application. In other embodiments, subject 712 is detected because the location that they are at is contextually relevant from a security and/or home management perspective, such as an entryway, a side yard, a side door, a backyard, and/or a back entrance.

At FIG. 7B, a determination is made that subject 712 is unable to be identified (e.g., an individual unknown to and/or unable to be recognized by hub device 710). At FIG. 7B, in response to the determination that subject 712 is unable to be identified, hub device 710 communicates information that an unidentified subject is detected outside of physical environment 708 to resident computer system 700 in attempt to alert John of the presence of subject 712. As illustrated in FIG. 7B, in response to receiving communication that an unidentified subject is detected outside of physical environment 708 from hub device 710, resident computer system 700 displays security notification 714. As illustrated in FIG. 7B, security notification 714 includes live feed 716. Live feed 716 includes one or more images and/or a live stream captured by a camera included in and/or associated with physical environment 708. As illustrated in FIG. 7B, live feed 716 includes subject representation 718 (e.g., a representation of subject 712). In some embodiments, security notification 714 is sent to an application of resident computer system 700, such as a home application. In such embodiments, the home application can be an application for managing physical environment 708. In some embodiments, the information in the home application is received in a different form than security notification 714. For example, resident computer system 700 can display the information with a clear image of the unidentified subject, a list of detected activities corresponding to the unidentified subject, a communication button to speak to the subject, and/or an alarm button to activate an alarm within physical environment 708.

In some embodiments, rather than displaying security notification 714, resident computer system 700 outputs an audio output to notify John that there is an unidentified subject outside of physical environment 708. For example, in response to receiving communication that an unidentified subject is detected outside of physical environment 708 from hub device 710, resident computer system 700 outputs “Hey John, a stranger is outside your front door. Would you like to take a look?” In other embodiments, rather than displaying security notification 714, resident computer system 700 outputs a haptic output to notify John that there is an unidentified subject outside of physical environment 708. For example, in response to receiving communication that an unidentified subject is detected outside of physical environment 708 from hub device 710, resident computer system 700 outputs a haptic output (e.g., in a predefined pattern and/or in a sequence associated with detection of subjects corresponding to physical environment 708). In some embodiments, resident computer system 700 outputs different haptic outputs based on whether subject 712 is able to be identified. For example, in response to a determination that subject 712 is unable to be identified, resident computer system 700 outputs an aggressive haptic output. For another example, in response to a determination that subject 712 has been identified, resident computer system 700 outputs a gentle haptic output.

In some embodiments, resident computer system 700 outputs different haptic outputs based on a location where subject 712 is detected. For example, in response to a determination that subject 712 is at the entryway, resident computer system 700 outputs a gentle haptic output. For another example, in response to a determination that subject 712 is at the backdoor, resident computer system 700 outputs an aggressive haptic output.

In some embodiments, resident computer system 700 outputs an audio output and/or a haptic output rather than security notification 714 based on settings, preferences, and/or an operation mode of resident computer system 700. For example, resident computer system 700 can output an audio output based on John's preference that security notifications are audio outputs. For another example, resident computer system 700 can output a haptic output based on a determination that resident computer system 700 is in a lower-powered state.

At FIG. 7C, subject 712 has remained at the entryway of physical environment 708 for a minute. At FIG. 7C, a determination is made that John has not interacted with and/or dismissed security notification 714. At FIG. 7C, in response to the determination that John has not interacted with and/or dismissed security notification 714, hub device 710 communicates information that an unidentified subject is detected outside of physical environment 708 to resident computer system 704. In some embodiments, hub device 710 communicates with resident computer system 704 to increase the likelihood that at least one resident associated with physical environment 708 is alerted that there is an unidentified subject outside of physical environment 708. Additionally, as illustrated in FIG. 7C, resident computer system 700 maintains display of security notification 714.

In some embodiments, the determination that John has not interacted with and/or dismissed security notification 714 is based on time. For example, hub device 710 determines that one minute has passed since resident computer system 700 displayed security notification 714 and that John has not interacted with security notification 714. In other embodiments, the determination that John has not interacted with and/or dismissed security notification 714 is based on detecting that John interacted with other content. For example, hub device 710 can receive information that John interacted with other content, such as a text message, an email, and/or a phone call, without interacting with and/or dismissing security notification 714.

As illustrated in FIG. 7C, in response to receiving communication that an unidentified subject is detected outside of physical environment 708 from hub device 710, resident computer system 704 displays security notification 720. As illustrated in FIG. 7C, security notification 720 includes live feed 722. Live feed 722 includes one or more images and/or a live stream captured by a camera included in and/or associated with physical environment 708. As illustrated in FIG. 7C, live feed 722 includes subject representation 724 (e.g., a representation of subject 712).

In some embodiments, hub device 710 communicates information that an unidentified subject is detected outside of physical environment 708 to resident computer system 704 based on a determination that resident computer system 704 is within physical environment 708 (e.g., in an effort to warn Jane that she might be in danger). In other embodiments, hub device 710 communicates information that an unidentified subject is detected outside of physical environment 708 to resident computer system 704 based on a determination that resident computer system 704 is outside of physical environment 708 (e.g., in an effort to warn Jane not to return to physical environment 708 while a potential threat is outside of and/or attempting to gain access to physical environment 708). In some embodiments, hub device 710 communicates information that an unidentified subject is detected outside of physical environment 708 to resident computer system 704 based on activity of the unidentified subject. For example, hub device 710 can communicate with resident computer system 704 based on receiving information from a camera and/or another device associated with physical environment 708 that subject 712 is actively trying to break in and/or has gained access to physical environment 708 in an effort to warn Jane. For another example, hub device 710 can communicate with resident computer system 704 based on receiving information from a camera and/or another device associated with physical environment 708 that subject 712 is loitering at the entryway.

In some embodiments, the time period that it takes for hub device 710 to communicate information about unidentified subjects to resident computer system 704 is based on a setting. For example, hub device 710 can wait three minutes before communicating information about an unidentified subject to resident computer system 704 based on a setting created by John and/or Jane. For another example, hub device 710 can immediately communicate information about an unidentified subject to resident computer system 704 based on a setting created by John and/or Jane.

In some embodiments, the time period that it takes for hub device 710 to communicate information about unidentified subjects to resident computer system 704 is based on context. For example, hub device 710 can wait two minutes upon detecting that an unidentified subject is a child standing in the entryway before communicating information about the unidentified subject to resident computer system 704. For another example, hub device 710 can immediately communicate information about the unidentified subject to resident computer system 704 upon detecting that an unidentified subject is trying to break into physical environment 708.

As illustrated in FIG. 7C, resident computer system 704 displays the same type of notifying content as resident computer system 700 (e.g., security notification 720 and security notification 714 are both notifications with the same content). In some embodiments, resident computer system 700 and resident computer system 704 both output an audio output rather than displaying a notification. For example, in response to receiving communication that an unidentified subject is detected outside of physical environment 708 from hub device 710, resident computer system 700 and resident computer system 704 output an audio output (e.g., “There is a stranger in the entryway.”). In other embodiments, resident computer system 700 and resident computer system 704 both output a haptic output rather than displaying a notification. For example, in response to receiving communication that an unidentified subject is detected outside of physical environment 708 from hub device 710, resident computer system 700 and resident computer system 704 output a haptic output.

In some embodiments, resident computer system 704 outputs a different type of notifying content than resident computer system 700. For example, in response to receiving communication that an unidentified subject is detected outside of physical environment 708 from hub device 710, resident computer system 700 displays security notification 714 while resident computer system 704 outputs an audio output (e.g., “Hey Jane, a stranger is in the entryway.”). For another example, in response to receiving communication that an unidentified subject is detected outside of physical environment 708 from hub device 710, resident computer system 700 outputs a haptic output while resident computer system 704 displays security notification 720. In such embodiments, resident computer system 700 and resident computer system 704 output a different types of notifying content because resident computer system 700 belongs to John who owns physical environment 708 (e.g., hub device 710 can send more detailed information to resident computer system 700 while only sending the essentials to resident computer system 704).

In some embodiments, different computer systems output different types of notifying content. For example, a smart speaker can output an audio output (e.g., “A stranger is in the entryway”) and/or an alarm. For another example, a television can display a security notification that acts as an overlay over a movie. For another example, a smart lightbulb can output flashing lights to alert a subject.

In some embodiments, resident computer system 704 ceases outputting other content in response to receiving information from hub device 710. For example, resident computer system 704 can cease outputting audio content (e.g., a song, a podcast, and/or an audiobook) when displaying security notification 720. For another example, resident computer system 704 can pause a movie when displaying security notification 720.

In some embodiments, hub device 710 communicates information that an unidentified subject is detected outside of physical environment 708 to resident computer system 704 based on a determination the unidentified subject has been unable to be identified since resident computer system 700 displayed security notification 714. For example, if two minutes have passed since resident computer system 700 displayed security notification 714 and the unidentified subject is still not identified, hub device 710 communicates information that an unidentified subject is detected outside of physical environment 708 to resident computer system 704.

In some embodiments, before communicating information that an unidentified subject is detected outside of physical environment 708 to resident computer system 700 and/or resident computer system 704, hub device 710 changes the mode of a receiving computer system (e.g., resident computer system 700 and/or resident computer system 704). For example, in response to a determination that resident computer system 704 is in a do not disturb mode, hub device 710 can deactivate the do not disturb mode to ensure that the information about the unidentified subject is received (e.g., to ensure that resident computer system 704 displays security notification 720, outputs an audio output, and/or outputs a haptic output). In some embodiments, hub device 710 ignores the mode of a receiving computer system (e.g., resident computer system 700 and/or resident computer system 704). For example, even though hub device 710 determines that resident computer system 704 is in a do not disturb mode, hub device 710 causes resident computer system 704 to display security notification 720 to ensure that the information about the unidentified subject is received.

FIG. 7D illustrates a scenario following FIG. 7C where subject 712 breaks into physical environment 708. As illustrated in FIG. 7D, resident computer system 700 and resident computer system 704 maintain display of security notification 714 and security notification 720, respectively. At FIG. 7D, subject 712 has gained access to physical environment 708 (e.g., subject 712 breaks down the door, breaks a window, picks the lock of the door, reaches in through an open window to open the door from the inside and/or gains entry to physical environment 708 through an unlocked door and/or open window). At FIG. 7D, hub device 710 receives information that subject 712 is breaking into physical environment 708. In some embodiments, hub device 710 receives the information that subject 712 from another device within and/or associated with physical environment 708, such as a camera, a motion sensor, and/or a glass-breaking sensor.

At FIG. 7D, in response to receiving information that subject 712 has broken into and/or has gained access to physical environment 708, hub device 710 outputs alarm 726 (e.g., a loud ringing audio output and/or natural language alarm such as “Intruder Detected!”). In some embodiments, hub device 710 outputs alarm 726 based on receiving information that subject 712 is located within physical environment 708.

In some embodiments, based on a determination that Jane (and/or John) has not interacted with and/or dismissed security notification 720, hub device 710 communicates information that an unidentified subject is breaking in and/or inside physical environment to a third party device that belongs to and/or is associated with a different logical environment than hub device 710 (e.g., with a device belonging to and/or associated with a non-resident that is not directly associated with physical environment 708) that has a relationship with hub device 710. For example, hub device 710 communicates with a device of a trusted neighbor, a device of a family member, a device of a third-party security service, and/or a device of a law enforcement authority. In some embodiments, the relationship between hub device 710 and the third-party device is established through direct communication. For example, hub device 710 communicates directly with a smartphone of a trusted neighbor. For another example, hub device 710 communicates directly with a desktop computer belonging to a third-party security service based on a determination that John has subscribed to the third-party security service (e.g., John has granted permission to the third-party security service to communicate with and/or interact with devices associated with physical environment 708). In other embodiments, the relationship between hub device 710 and the third party device is established through a setting. For example, John has set up hub device 710 to communicate with a hub device that belongs to his parents. In some embodiments, the relationship between hub device 710 and the third party device is established by default. For example, by default, hub device 710 is capable of communicating with a law enforcement authority due to the communication being standardized and/or trusted without additional configuration by John.

In some embodiments, when communicating with a third party device, hub device 710 communicates via an ad hoc network, such as a Bluetooth network, a wireless mesh network (e.g., Thread), a peer-to-peer, decentralized network, a wireless sensor network, or a local area network that has been configured to act as an ad hoc network. In such embodiments, the ad hoc network can be a temporary network created by hub device 710 in order to directly communicate with a third party device outside of (e.g., not connected to and/or associated with) the logical environment including hub device 710. For example, in response to receiving information that subject 712 is attempting to break into physical environment 708, hub device 710 creates an ad hoc network to communicate with a hub device that belongs to a neighbor. In some embodiments, hub device 710 communicates with a third party device with a communication channel other than an ad hoc network, such as a WiFi network, an ethernet network, or a cellular network.

In some embodiments, based on a determination that Jane has not interacted with and/or dismissed security notification 720, hub device 710 communicates with resident computer system 700 to display another security notification in an effort to alert John that the unidentified subject is still present and/or that the situation has escalated. In other embodiments, because resident computer system 700 is still displaying security notification 714, in response to receiving communication from hub device 710, resident computer system 700 updates security notification 714 rather than display a separate notification. For example, in response to receiving communication from hub device 710, resident computer system 700 updates security notification 714 to show an updated version of live feed 716.

In some embodiments, based on a determination that Jane has not interacted with and/or dismissed security notification 720, hub device 710 communicates with resident computer system 700 to output another type of notifying content to alert John that the unidentified subject is still present and/or that the situation has escalated, such as an audio output (e.g., “The unidentified person is breaking into your home”) and/or a haptic output.

FIG. 7E illustrates an alternate scenario following FIG. 7C where John dismisses security notification 714 and subject 712 does not break into physical environment 708. At FIG. 7E, in response to detecting John dismiss security notification 714, resident computer system 700 ceases display of security notification 714 within lock screen user interface 702. As illustrated in FIG. 7E, resident computer system 704 maintains display of security notification 720. In some embodiments, resident computer system 704 maintains display of security notification 720 based on receiving communication from hub device 710 and/or another device within and/or associated with physical environment 708 (e.g., a camera, a motion sensor, and/or another type of sensor) that subject 712 is still at the entryway. In some embodiments, based on a determination that resident computer system 700 has ceased display of security notification 714, hub device 710 causes resident computer system 704 to cease display of security notification 720 in an effort to communicate to Jane that there is no threat and/or that subject 712 can be ignored. In some embodiments, along with causing resident computer system 704 to cease display of security notification 720, hub device 710 causes other alarms to cease as well (e.g., an alarm caused at a device corresponding to a neighbor, third-party monitory service, and/or a law enforcement authority).

FIG. 7F illustrates an alternate scenario following FIG. 7C where Jane dismisses security notification 720 and subject 712 does not break into physical environment 708. At FIG. 7F, in response to detecting Jane dismiss security notification 720, resident computer system 704 ceases display of security notification 720 within lock screen user interface 706. As illustrated in FIG. 7F, resident computer system 700 maintains display of security notification 714. In some embodiments, resident computer system 700 maintains display of security notification 714 based on receiving communication from hub device 710 and/or another device within and/or associated with physical environment 708 (e.g., a camera, a motion sensor, and/or another type of sensor) that subject 712 is still at the entryway. In other embodiments, resident computer system 700 maintains display of security notification 714 based on a determination that resident computer system 700 belongs to John, the homeowner, in an attempt to ensure that the homeowner is alerted of the unidentified subject. In some embodiments, resident computer system 700 maintains display of security notification 714 until dismissed by John. For example, John has enabled a setting and/or established a rule that John, the homeowner, must directly dismiss security notification 714 before hub device 710 can notify other devices associated with physical environment 708 that the threat has passed.

In some embodiments, based on a determination that resident computer system 704 has ceased display of security notification 720, hub device 710 causes resident computer system 700 to cease display of security notification 714 in an effort to communicate to John that there is no threat and/or that subject 712 can be ignored. For example, since resident computer system 704 is within physical environment 708, hub device 710 can cease display of security notification 714 in response to the dismissal of second device 720 due to Jane likely taking care of and/or ignoring unidentified subject 712.

In some embodiments, resident computer system 704 ceases display of security notification 720 based on a determination that Jane has not dismissed and/or interacted with security notification 720 for a predetermined amount of time. For example, resident computer system 704 ceases display of security notification 720 based on a determination that five minutes have passed since resident computer system 704 displayed security notification 720. In some embodiments, resident computer system 704 ceases display of security notification 720 based on a determination that resident computer system 704 is operating in a do not disturb mode.

FIG. 7G follows FIG. 7D, FIG. 7E, or FIG. 7F. As illustrated in FIG. 7G, subject 712 has moved away from physical environment 708. At FIG. 7G, hub device 710 receives information that subject 712 has moved away from physical environment 708. In some embodiments, hub device 710 receives the information that subject 712 has moved away from physical environment 708 from another device within and/or associated with physical environment 708, such as a camera and/or a motion sensor. At FIG. 7G, in response to receiving information that subject 712 has moved away from physical environment 708, hub device 710 causes resident computer system 700 and resident computer system 704 to cease display of security notification 714 and security notification 720, respectively. At FIG. 7G, in response to receiving communication from hub device 710, resident computer system 700 and resident computer system 704 cease display of security notification 714 and security notification 720, respectively. In some embodiments, hub device 710 causes resident computer system 700 and resident computer system 704 to cease display of security notification 714 and security notification 720, respectively, based on a determination that John and/or Jane have not dismissed and/or interacted with security notification 714 and/or security notification 720. In other embodiments, hub device 710 causes resident computer system 700 and resident computer system 704 to cease display of security notification 714 and security notification 720, respectively, based on a determination that John and/or Jane dismissed and/or interacted with security notification 714 and/or security notification 720.

In some embodiments, instead of ceasing display of security notification 714 and security notification 720, hub device 710 causes a modification to such notifications. For example, hub device 710 can modify security notification 714 and/or security notification 720 by removing live feed 716 and live feed 722, respectively, while adding a user interface element that allows John and/or Jane to review detected activity. In some embodiments, hub device 710 modifies security notification 714 to a reduced form (e.g., without live feed 716) and causes resident computer system 704 to cease display of security notification 720. In such embodiments, hub device 710 modifies security notification 714 in an attempt to ensure that John sees that an unidentified subject was detected while also giving John the option to review the detected activity.

FIG. 8 is a flow diagram illustrating a process (e.g., process 800) for alerting devices of detected subjects in accordance with some embodiments. Some operations in process 800 are, optionally, combined, the orders of some operations are, optionally, changed, and some operations are, optionally, omitted.

As described below, process 800 provides an intuitive way for alerting devices of detected subjects in accordance with some embodiments. Process 800 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

In some embodiments, process 800 is performed at a computer system (e.g., 700, 704, and/or 710). In some embodiments, the computer system is a phone, a watch, a tablet, a fitness tracking device, an accessory device, a processor, a head-mounted display (HMD) device, a hub device, a resident device, a server, a communal device, a media device, a speaker, a television, an electronic device, a camera, and/or a personal computing device.

The computer system detects (802) an unidentified (e.g., unauthorized, unknown, and/or unauthenticated) subject (e.g., 712) (e.g., at a location, in an environment, in a monitored area, and/or zone of a residence, and/or within a secure area and/or zone of a residence). In some embodiments, the computer system is in communication with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a gyroscope, an inertial measurement unit, a global positioning system, a motion sensor, a sensor, a mouse, a keyboard, a touchpad, and/or a touch-sensitive surface). In some embodiments, the unidentified subject is detected via the one or more input devices. In some embodiments, the unidentified subject is detected via another device separate from the computer system, such as a camera, a lock, and/or another computer system configured to have a username, password, and/or passcode entered via one or more input devices of the other computer system, the username, password, and/or passcode used to attempt to identify the unidentified subject. In some embodiments, the computer system receives a communication from the other computer system, the other communication indicating presence of the unidentified subject. In some embodiments, detecting the unidentified subject includes detecting a subject and, in response to detecting the subject, determining that the subject is an unidentified subject. In some embodiments, the computer system determines that the subject is an unidentified subject through a recognition process (e.g., facial recognition, voice recognition, object recognition, and/or pattern recognition). In some embodiments, the computer system determines the subject is an unidentified subject based on a determination that the computer system cannot communicate with a device corresponding to (and/or of) the subject (e.g., the computer system cannot ping and/or obtain an authentication token from a personal device and/or wearable device of the subject). In some embodiments, a subject is unidentified based on the computer system not finding a record of the subject within a list of known subjects, such as a list of members of a household, a list of verified occupants of a residence, a list of individuals previously given access to a residence, and/or a list of individuals with control over access to a residence. In some embodiments, detecting the unidentified subject includes detecting the unidentified subject within a zone and/or a predefined area (e.g., a monitored zone, a secure zone, a geo-fenced area, and/or one or more localities of a residence and/or occupied building). In some embodiments, detecting the unidentified subject includes detecting a threat level corresponding to the unidentified subject (e.g., the unidentified subject is holding a weapon, the unidentified subject is trying to gain access to a secure area, and/or the unidentified subject is detected for a certain amount of time (e.g., non-zero amount of time) and/or in a certain number of areas (e.g., non-zero number of areas, such as more than one or more than two)).

In response to detecting the unidentified subject, the computer system outputs (804), via a device (e.g., 700, 704, and/or 710) (e.g., via one or more output devices of the first device) corresponding to (e.g., belonging to, owned by, proximate to, and/or tied to) a first type of resident (e.g., as discussed above with respect to FIG. 7A) (e.g., a homeowner, an administrator, a user that established an environment of devices within a residence, and/or a user with a higher control level), a first alarm (e.g., 714, 720, and/or 726). In some embodiments, outputting the first alarm includes sending, to the first device, a request for the first device to output the first alarm. In some embodiments, outputting the first alarm includes causing the first device to output a visual indication (e.g., a notification, an alert, an image captured of the unidentified subject, and/or visual information about the detection of the unidentified subject), an auditory alert (e.g., an auditory alarm, a ringtone, a chime, and/or natural language output describing the detection of the unidentified subject), and/or a haptic pattern (e.g., a predefined pattern, a customized pattern, a continuous haptic, and/or a series of haptic outputs). In some embodiments, the computer system outputs the first alarm based on the computer system and the device corresponding to the first type of resident sharing a common owner, a common account, and/or a common relationship (e.g., part of a household and/or part of a common group of devices). In some embodiments, the computer system outputs the first alarm based on the device corresponding to the first type of resident providing the computer system permission to output content, such as one or more types of alarms, from one or more output devices of the first device.

After (806) (and/or while) causing output of the first alarm, in accordance with a determination that a set of one or more criteria is satisfied, the computer system outputs (808), via a device (e.g., 700, 704, and/or 710) corresponding to (e.g., belonging to, owned by, proximate to, and/or tied to) a second type of resident (e.g., as discussed above with respect to FIG. 7A) (e.g., a non-homeowner, a dependent of a homeowner, an occupant of the residence, a third-party monitoring service, and/or a guest), a second alarm (e.g., 714, 720, and/or 726), wherein the device corresponding to the second type of resident is separate from the device corresponding to the first type of resident, and wherein the second type of resident is different from the first type of resident. In some embodiments, outputting the second alarm includes sending, to the second device, a request for the second device to output the second alarm. In some embodiments, outputting the second alarm includes causing the second device to output a visual indication (e.g., a notification, an alert, an image captured of the unidentified subject, and/or visual information about the detection of the unidentified subject), an auditory alert (e.g., an auditory alarm, a ringtone, a chime, and/or natural language output describing the detection of the unidentified subject), and/or a haptic pattern (e.g., a predefined pattern, a customized pattern, a continuous haptic, and/or a series of haptic outputs). In some embodiments, the computer system outputs the second alarm based on the computer system and the device corresponding to the second type of resident sharing a common owner, a common account, and/or a common relationship (e.g., part of a household and/or part of a common group of devices). In some embodiments, the computer system outputs the second alarm based on the device corresponding to the second type of resident providing the computer system permission to output content, such as one or more types of alarms, from one or more output devices of the second device. In some embodiments, the second alarm is different from the first alarm (e.g., different types of output such as visual, audio, and/or haptic, different levels of alarm, and/or alarms output by different types of devices). In some embodiments, the set of one or more criteria includes a criterion that is satisfied when the first alarm is not dismissed and/or silenced within a threshold amount of time (e.g., non-zero amount of time), when the computer system detects and/or continues to detect the unidentified subject after and/or while causing the device corresponding to the first type of resident to output the first alarm, when the unidentified subject has a threshold threat level, when the computer system detects an elevation of the unidentified subject (e.g., the unidentified subject gains access to a secure area, the unidentified subject breaks an item, and/or the unidentified subject is detected in and/or around an elevated security area), and/or when the computer system receives, from the device corresponding to the first type of resident, a response (e.g., the first type of resident does not recognize the unidentified subject, the first type of resident cannot review the first alarm at this time, and/or the device corresponding to the first type of resident cannot output the first alarm). In some embodiments, the set of one or more criteria includes a criterion that is satisfied based on the device corresponding to the second type of resident and/or the second type of resident (e.g., the device corresponding to the second type of resident is inside and/or away from a residence, the second type of resident is within the residence and/or the second type of resident is away from the resident, and/or the second type of resident is a minor and/or guest of the first type of resident).

After (806) causing output of the first alarm, in accordance with a determination that the set of one or more criteria is not satisfied, the computer system forgoes (810) output of, via the device corresponding to the second type of resident, the second alarm. Performing an operation when a set of conditions has been met without requiring further user input (such as by outputting alarms via one or more subsequent devices based on satisfaction of a set of criteria without requiring an input on an initial outputting device or the one or more subsequent devices) enhances the operability of the device by reducing unnecessary inputs and/or steps to navigate through different user interfaces or sets of controls, reducing energy usage by the device.

In some embodiments, the set of one or more criteria includes a criterion that is satisfied when the first alarm is not disarmed (and/or dismissed) within (e.g., is not silenced within, is not interacted with before, is ignored for, and/or is not handled within) an amount of time (e.g., as discussed above with respect to FIG. 7C) (e.g., a non-zero amount of time, such as 1 second to 10 minutes). In some embodiments, the computer system outputs the second alarm when the first alarm is not disarmed within the amount of time in attempt to handle and/or take care of the unidentified subject within a timeframe (e.g., waits the amount of time until causing the second alarm and a greater amount of time before taking additional action). In some embodiments, the first alarm is an indication, a notification, and/or a visual alarm displayed via one or more display generation components of the device corresponding to first type of resident. In some embodiments, the first alarm is not disarmed when the indication, the notification, and/or the visual alarm are not interacted with, are not dismissed, and/or are not viewed. In some embodiments, the first alarm is an auditory alarm and/or audible alert that is output via one or more output devices of the device corresponding to the first type of resident. In some embodiments, the first alarm is not disarmed when the auditory alarm and/or the audible alert is not silenced. In some embodiments, the amount of time is determined by the computer system (e.g., the amount of time is lengthened and/or shortened based on context of the unidentified subject, such as threat level, actions taken, proximity, and/or frequency). In some embodiments, the amount of time is a fixed amount of time (e.g., an amount of time set within a setting of the computer system and/or the device corresponding to the first type of resident). In some embodiments, the computer system outputs the second alarm when the first alarm is not dismissed within the amount of time, when the first alarm is not dismissed within a non-zero amount of alerts, and/or when the first alarm is not dismissed before taking another action on the device corresponding to the first type of resident (e.g., interacting with another piece of content and/or opening an application not related to the first alarm). In some embodiments, more than one device is associated with the first type of resident (e.g., a personal device, a desktop computer, a smart phone, a speaker, a smart device, an accessory, and/or a communal device). In some embodiments, the computer system outputs the second alarm when the first alarm is not dismissed before the first type of resident interacts with another device (e.g., the first type of resident interacts with another device different from the device corresponding to the first type of resident and/or the first type of resident performs an action with another device associated with a residence and/or the first type of resident).

In some embodiments, the set of one or more criteria includes a criterion that is satisfied when the unidentified subject remains unidentified for an amount of time (e.g., a non-zero amount of time, such as 1 second to 10 minutes) (e.g., as discussed above with respect to FIG. 7C) after initiating output of the first alarm. In some embodiments, the computer system outputs the second alarm when the unidentified subject remains unidentified for the amount of time after initiating output of the first alarm in order to attempt to address the unidentified subject (e.g., the unidentified subject has remained for the amount of time). In some embodiments, the unidentified subject remains unidentified when the unidentified subject fails to identify themself through an identification process (e.g., an identification prompt is output and the unidentified subject does not correctly respond and/or the unidentified subject fails to present a method of identification when asked). In some embodiments, the unidentified subject remains unidentified based on the computer system failing to find a corresponding account, profile, and/or credential for the unidentified subject after performing an identification process (e.g., a facial recognition process and/or a speech recognition process). In some embodiments, the computer system continuously tries to identify detected subjects. In some embodiments, the unidentified subject remains unidentified for the amount of time due to the computer system failing to identify the unidentified subject a number of times (e.g., a set number of times and/or an interval of attempts over the amount of time), such as one time or more than one time.

In some embodiments, after initiating output of the second alarm, the computer system receives, from the device corresponding to the second type of resident, an indication (e.g., a signal, a message, and/or an alert) that the second alarm has been suspended (e.g., as discussed above with respect to FIG. 7F) (e.g., dismissed, ignored, silenced, and/or cancelled). In some embodiments, the second alarm has been suspended when output of the second alarm by the device corresponding to the second type of resident has been silenced, interrupted, and/or cancelled (e.g., the second type of resident performs an input directed to the second alarm, such as swiping to dismiss the second alarm, selecting a control to dismiss the second alarm, and/or turning of a display generation component while the second alarm is active, and/or mutes the second alarm). In some embodiments, in response to receiving the indication that the second alarm has been suspended, the computer system forgoes cessation of the first alarm (e.g., as discussed above with respect to FIG. 7F) (and/or maintains output of the first alarm and/or ceases output of the second alarm). In some embodiments, the computer system forgoes cessation of the first alarm to allow the first type of resident to respond to and/or be notified of the unidentified subject (and/or even if the second type of resident has decided to not). In some embodiments, the computer system forgoes cessation of the first alarm even though the second alarm has been suspended based on a relationship between the first type of resident and the second type of resident (e.g., parent, guardian, supervisor, administrator and a child, dependent, and/or subordinate). In some embodiments, the computer system forgoes cessation of the first alarm by sending one or more requests and/or messages to the device corresponding to the first type of resident to output the first alarm. In some embodiments, the device corresponding to the first type of resident continues to output the first alarm as long as the computer system continues to send requests and/or messages to output the first alarm. In some embodiments, the computer system forgoes cessation of the first alarm by forgoing sending a message and/or request to the device corresponding to the first type of resident to cease output of the first alarm. In some embodiments, the device corresponding to first type of resident continues to output the first alarm until the computer system ceases output of the first alarm (e.g., the computer system requests and/or messages the device corresponding to the first alarm to cease output of the first alarm). In some embodiments, in response to receiving the indication that the second alarm has been suspended, the computer system modifies output of the first alarm (e.g., causes the first alarm to be redisplayed, causes the first alarm to be displayed with modified visual characteristics, and/or causes output of the first alarm in an alternative manner, such as auditory alarm, visual alarm, and/or haptic alarm).

In some embodiments, after initiating output of the second alarm, the computer system receives, from the device corresponding to the second type of resident, an indication (e.g., a signal, a message, and/or an alert) that the second alarm has been suspended (e.g., as discussed above with respect to FIG. 7F) (e.g., dismissed, ignored, silenced, and/or cancelled). In some embodiments, the second alarm has been suspended when output of the second alarm by the device corresponding to the second type of resident has been silenced, interrupted, and/or cancelled (e.g., the second type of resident performs an input directed to the second alarm, such as swiping to dismiss the second alarm, selecting a control to dismiss the second alarm, and/or turning of a display generation component while the second alarm is active, and/or mutes the second alarm). In some embodiments, in response to receiving the indication that the second alarm has been suspended, the computer system ceases output of, via the device corresponding to the first type of resident, the first alarm (e.g., as discussed above with respect to FIG. 7F) (and/or ceases output of the second alarm). In some embodiments, the computer system ceases output of the first alarm in response to receiving the indication that the second alarm has been suspended due to dismissal of the second alarm indicating that the unidentified subject has been addressed and/or does not need to be addressed. In some embodiments, the computer system ceases output of the first alarm by requesting and/or sending a message to the device corresponding to the first type of resident to cease output of the first alarm. In some embodiments, after ceasing output of the first alarm, the computer system output, via the device corresponding to the first type of resident, a third alarm (e.g., an escalated version of the first alarm or an alarm different from the first alarm) in response to detecting the unidentified subject (e.g., the unidentified subject remains and/or has escalated their presence).

In some embodiments, after initiating output of the second alarm, the computer system receives, from the device corresponding to the first type of resident, an indication (e.g., a message and/or an alert) that the first alarm has been suspended (e.g., as discussed above with respect to FIG. 7E) (e.g., dismissed, ignored, silenced, and/or cancelled). In some embodiments, the first alarm has been suspended when output of the first alarm by the device corresponding to the first type of resident has been silenced, interrupted, and/or cancelled (e.g., the first type of resident performs an input directed to the first alarm, such as swiping to dismiss the first alarm, selecting a control to dismiss the first alarm, and/or turning off a display generation component while the first alarm is active, and/or mutes the first alarm). In some embodiments, in response to receiving the indication that the second alarm has been suspended, the computer system ceases output of, via the device corresponding to the second type of resident, the second alarm (e.g., as discussed above with respect to FIG. 7E) (and/or ceases output of the first alarm). In some embodiments, the computer system ceases output of the second alarm in response to receiving the indication that the second alarm has been suspended due to a relationship between the first type of resident and the second type of resident. In some embodiments, the computer system ceases output of the second alarm in response to receiving the indication that the first alarm has been suspended due to dismissal of the first alarm indicating that the unidentified subject has been addressed and/or does not need to be addressed. In some embodiments, the computer system ceases output of the second alarm by requesting and/or sending a message to the device corresponding to the second type of resident to cease output of the second alarm. In some embodiments, ceasing output of the second alarm includes ceasing output of a third alarm (e.g., a subsequent alarm alongside and/or after the second alarm to a device corresponding to another type of resident) and/or forgoing output of the third alarm.

In some embodiments, the first alarm is the same as the second alarm (e.g., as discussed above with respect to FIGS. 7C-7D). In some embodiments, the first alarm and the second alarm are a common type of alarm (e.g., notification, auditory alert, and/or haptic output). In some embodiments, the first alarm and the second alarm include common content (e.g., an image of the unidentified subject and/or a description of the detection of the unidentified subject). In some embodiments, the first alarm and the second alarm include a common control (e.g., a control to dismiss the alarm, a control to address the unidentified subject, and/or a control to gain additional information and/or content associated with the unidentified subject such as a video, additional photo, and/or previous detection).

In some embodiments, the set of one or more criteria is a first set of one or more criteria. In some embodiments, after initiating output of the second alarm and in accordance with a determination that a second set of one or more criteria is satisfied, the computer system outputs, via a device corresponding to (e.g., belonging to, owned by, proximate to, and/or tied to) a non-resident (e.g., as discussed above with respect to FIG. 7D) (e.g., a third-party, a device with a relationship with the first type of resident and/or the second type of resident, and/or a device with a relationship with a resident corresponding to the first type of resident and/or the second type of resident), a third alarm (e.g., 726 and/or as discussed above with respect to FIG. 7D), wherein the second set of one or more criteria is different from the first set of one or more criteria. In some embodiments, a logical environment (e.g., as described above with respect to FIG. 3) includes the device corresponding to the first type of resident and the device corresponding to the second type of resident. In some embodiments, the logical environment corresponds to or is associated with a location where the unidentified subject is detected. In some embodiments, the first alarm, the second alarm, and/or the third alarm indicate that the unidentified subject is detected near, in proximity of, within, inside, and/or at the location. In some embodiments, the logical environment does not include the device corresponding to the non-resident. In some embodiments, the second set of one or more criteria includes a criterion that is satisfied when an amount of time (e.g., a non-zero amount of time) has passed since the second alarm was output, when the second alarm has not been dismissed within an amount of time (e.g., a non-zero amount of time), when the unidentified subject remains unidentified for an amount of time (e.g., a non-zero amount of time), when the unidentified subject escalates (e.g., increases a threat level, attempts to break into a resident, breaks a window, brandishes a weapon, and/or is detected at a heightened threat level), when the unidentified subject is detected within another location corresponding to a residence, when the unidentified subject is detected within the residence, and/or when an indication is received from the device corresponding to the first type of resident or the device corresponding to the second type of resident to contact devices corresponding to non-residents. In some embodiments, the device corresponding to the non-resident includes one or more output devices. In some embodiments, outputting the third alarm includes requesting, the device corresponding to the non-resident, to output, via the one or more output devices of the device corresponding to the non-resident, the third alarm. In some embodiments, the third alarm is different from the first alarm and/or the second alarm (e.g., different type of alarm, different content included in the alarm, and/or different control associated with the alarm). In some embodiments, the third alarm includes a reduced amount of content as opposed to the first alarm and/or the second alarm (e.g., the third alarm includes a description instead of an image and/or the third alarm includes an image instead of a live video feed). In some embodiments, the third alarm does not include one or more controls found in the first alarm and/or the second alarm (e.g., the third alarm does not include a control to open an application corresponding to the detection of the unidentified subject and/or does not include a control for silencing alarms associated with the detection of the unidentified subject). In some embodiments, the third alarm is the same as the first alarm and/or the second alarm.

In some embodiments, the device corresponding to the first type of resident and the device corresponding to the second type of resident are included within a first logical environment (e.g., as discussed above with respect to FIG. 3). In some embodiments, the device corresponding to the non-resident is within a second logical environment (e.g., as discussed above with respect to FIG. 3) separate from first logical environment. In some embodiments, the second logical environment has a relationship with the first logical environment (e.g., as discussed above with respect to FIG. 7D). In some embodiments, the relationship includes a previous authentication of a device from the second logical environment with the first logical environment (e.g., the device is allowed access to the first logical environment and/or the device is provided network access to a network of the first logical environment), a connection established between the first logical environment and the second logical environment (e.g., an emergency connection between environments and/or accounts associated with the first logical environment and the second logical environment), a provided permission level assigned to a device within the second logical environment to the first logical environment (e.g., assigning the device a guest permission level and/or a subordinate permission level with the first logical environment), and/or a pairing and/or trust relationship between an account and/or device of the first logical environment and the second logical environment (e.g., a previous share of credentials and/or authentication information allowing trusted communication between the first logical environment and the second logical environment and/or between devices of the first logical environment and devices of the second logical environment).

In some embodiments, the device corresponding to the non-resident is a device corresponding to (e.g., belonging to, owned by, proximate to, monitored by, and/or tied to) a third-party emergency service (e.g., as discussed above with respect to FIG. 7D) (e.g., a monitoring service, a security service provider, a law enforcement authority, an emergency dispatch service and/or authority, and/or an authority able to send aid to respond to the unidentified subject). In some embodiments, outputting the third alarm includes alerting (e.g., calling, texting, sending a request to an endpoint and/or secure address of, and/or sending a secure communication to) the third-party emergency service (e.g., as discussed above with respect to FIG. 7D). In some embodiments, before detecting the unidentified subject, the device corresponding to the first type of resident configures one or more settings corresponding to one or more third-party emergency services (e.g., including the third-part emergency service) that are to be alerted (e.g., after alerting other devices, serially, and/or at the same time) upon detecting the unidentified subject and/or upon detecting a certain threat level corresponding to the unidentified subject.

In some embodiments, detecting the unidentified subject includes detecting the unidentified subject at a point (e.g., position of 712 in FIGS. 7A-7G and/or as discussed above with respect to FIG. 7B) (e.g., a location, a coordinate, and/or a physical spot) corresponding to (e.g., near, outside of, by, inside, and/or around) a residence (e.g., 708) (and/or a location, a physical environment, and/or an area). In some embodiments, the residence is a home, an office space, an apartment, and/or a monitored physical space. In some embodiments, the residence includes one or more secure areas (e.g., interior rooms, bedrooms, access ways, and/or nonpublic spaces), one or more access points (e.g., windows, doors, gates, and/or garage doors), and/or one or more open areas (e.g., front lawn, sidewalk, apartment hallway, backyard, driveway, and/or alleyway). In some embodiments, the residence is owned by, occupied by, associated with, monitored by and/or for, and/or assigned to the first type of resident, the second type of resident, the device corresponding to the first type of resident, and/or the device corresponding to the second type of resident. In some embodiments, the point corresponding to the residence is a monitored point and/or a point in an open area that is accessible by residents and/or non-residents (e.g., a front point, sidewalk, and/or front yard). In some embodiments, the point is at and/or within an access point of the residence.

In some embodiments, the point is within a zone (e.g., as discussed above with respect to FIG. 7B) (e.g., a detection zone, a region, and/or an area) outside of the residence (e.g., 708). In some embodiments, one or more zones (e.g., detection zones and/or ignore zones) are predefined around and/or outside the residence. In some embodiments, the zone is a detection zone (e.g., a front porch, a side yard, a front yard, a driveway, a room within a home, and/or an access point to the residence), and the computer system outputs the first alarm in response to detecting the unidentified subject within the detection zone. In some embodiments, the one or more zones include a suppression zone and/or ignore zone (e.g., a sidewalk, a public street, and/or a neighbor's yard), and the computer system forgoes outputting the first alarm (and/or any alarm) in response to detecting an unidentified subject within the suppression zone and/or the ignore zone.

In some embodiments, the point is within the residence (e.g., as discussed above with respect to FIG. 7D and/or within 708). In some embodiments, the point is a location within a room of the residence, is at an entry way and/or access point of the residence (e.g., at the inside of a doorway, at a window, and/or at a garage), and/or is at a location corresponding to the first type of residence and/or the second type of residence (e.g., a room near and/or on the way to the first type of resident and/or the second type of resident).

In some embodiments, after (and/or while) initiating output of the first alarm, before outputting the second alarm, and in accordance with the determination that the set of one or more criteria is satisfied, the computer system changes an operation mode (e.g., as discussed above with respect to FIG. 7C) (e.g., an update in operation mode, a change in one or more settings corresponding to an operation mode, and/or altering a current operation mode) of the device corresponding to the second type of resident. In some embodiments, the computer system outputs the second alarm irrespective of the operation mode of the device corresponding to the second type of resident (e.g., the computer system ignores the operation mode and/or one or more settings of the operation mode). In some embodiments, changing the operation mode of the device corresponding to the second type of resident includes requesting device information (e.g., current operation mode, sound level, do not disturb, current notification setting, and/or output device settings) from the device corresponding to the second type of resident and, in response to receiving the device information, sending, to the device corresponding to the second type of resident, a request to alter one or more settings (e.g., turning off silenced mode, turning off do not disturb, increasing a volume level, changing output mode, and/or updating a notification setting) based on the device information. In some embodiments, the notification setting can include preferred notification type and/or allowed notification type (e.g., displayed alerts, audible alerts, and/or haptic signals).

In some embodiments, the first alarm is different (and/or separate) from the second alarm (e.g., as discussed above with respect to FIG. 7C). In some embodiments, the first alarm is a different type of alarm than the second alarm (e.g., displayed alarm, notification, audible alarm, haptic alarm, and/or a combination of one or more different types of alarm). In some embodiments, the first alarm includes different content than the second alarm (e.g., different warning, different image, different level of content, and/or different controls). In some embodiments, the first alarm includes a more detailed set of content than the second alarm (e.g., a video feed instead of an image and/or an image instead of a description). In some embodiments, the first alarm includes one or more controls not included in the second alarm (e.g., a control to speak to the unidentified subject through another device, a control to silence alarms associated with the detection of the unidentified subject, and/or a control to notify another device and/or authority).

In some embodiments, the device corresponding to the first type of resident is the computer system (e.g., as discussed above with respect to FIG. 7A). In some embodiments, the computer system is a speaker, hub device, and/or communal device. In some embodiments, the device corresponding to the second type of resident is different and/or separate from the computer system. In some embodiments, the computer system includes one or more output devices (e.g., a display generation component, an audio generation component, and/or a haptic generation component). In some embodiments, outputting the first alarm includes outputting, via the one or more output devices of the computer system, the first alarm. In some embodiments, the computer system outputs the first alarm in response to detecting the unidentified subject and/or before causing an alarm (e.g., the second alarm and/or a third alarm separate from the first alarm and the second alarm) to be output by another device (e.g., the device corresponding to the second type of resident and/or another device separate from the computer system). In some embodiments, the computer system is within a residence corresponding to the first type of resident and/or the second type of resident. In some embodiments, outputting the first alarm includes outputting the first alarm within the residence (e.g., via the computer system and/or one or more other devices within the residence).

In some embodiments, the device corresponding to the second type of resident is the computer system (e.g., as discussed above with respect to FIG. 7A). In some embodiments, the computer system is a speaker, hub device, and/or communal device. In some embodiments, the device corresponding to the first type of resident is different and/or separate from the computer system. In some embodiments, the computer system includes one or more output devices (e.g., a display generation component, an audio generation component, and/or a haptic generation component). In some embodiments, the computer system outputs the first alarm in response to detecting the unidentified subject and/or before outputting, via one or more output devices of the computer system, the second alarm (e.g., the computer system causes output of an alarm via the device corresponding to the first type of resident before outputting an alarm and/or before outputting an alarm within a residence). In some embodiments, the computer system is within a residence corresponding to the first type of resident and/or the second type of resident. In some embodiments, outputting the second alarm includes outputting the second alarm within the residence (e.g., via the computer system and/or one or more other devices within the residence).

In some embodiments, the first type of resident is a homeowner (e.g., as discussed above with respect to FIG. 7A) (e.g., an owner of a home, a renter of a home, a landlord of a home, and/or an individual with a personal interest in a home). In some embodiments, the homeowner controls and/or administrates a logical environment at a residence (e.g., the logical environment includes the computer system, the device corresponding to the first type of resident, the device corresponding to the second type of resident, and/or one or more other devices at the residence). In some embodiments, the homeowner owns, is logged into a common account, and/or is trusted across all, each, and/or different devices of the logical environment. In some embodiments, the homeowner adds and/or authorizes the second type of resident to access and/or join the logical environment of the residence.

In some embodiments, the device corresponding to the first type of resident is a personal device (e.g., as discussed above with respect to FIG. 7A) (e.g., a phone, a mobile device, a personal smart device, and/or a device that requires a credential of the first type of resident) of the first type of resident. In some embodiments, the personal device is a device that is logged into and/or associated with an account for the first type of resident (e.g., an account that allows access to communicate with a set of devices and/or accessory devices). In some embodiments, the account is associated with a logical environment at a residence owned by the first type of resident.

In some embodiments, the second type of resident is a dependent of (and/or is dependent on) the first type of resident (e.g., as discussed above with respect to FIG. 7A). In some embodiments, the second type of resident is a child of the first type of resident. In some embodiments, the second type of resident has an account that is dependent on an account of the first type of resident (e.g., an administrator account provides access to resources to subordinate accounts and/or an administrator account can add additional accounts to resources owned by and/or associated with the administrator account).

In some embodiments, the second type of resident is a third-party monitoring service (e.g., as discussed above with respect to FIGS. 7A-7B) (e.g., a security service, a security team, and/or an authority). In some embodiments, the third-party monitoring service does not have access to resources of a residence until the third-party monitoring service receives the second alarm (e.g., after receiving the second alarm, the third-party monitoring service can access a video feed and/or a video stream that includes the unidentified subject). In some embodiments, the second alarm includes content (e.g., photo, description, and/or control) that allows the third-party monitoring service to address and/or inform an authority (e.g., a local police dispatch and/or a security team) of the unidentified subject.

In some embodiments, the first alarm is a notification (e.g., 714 and/or 720). In some embodiments, the device corresponding to the first type of resident includes one or more display generation components. In some embodiments, outputting the first alarm includes displaying, via the one or more display generation components, the notification. In some embodiments, the device corresponding to the first type of resident includes one or more output devices. In some embodiments, outputting the first alarm includes audibly outputting, via the one or more output devices, the notification (e.g., reading aloud the notification and/or outputting an alert to bring attention to a displayed notification).

In some embodiments, the second alarm is an auditory alarm (e.g., as discussed above with respect to FIGS. 7B-7D and/or 726). In some embodiments, the device corresponding to the second type of resident includes one or more output devices. In some embodiments, outputting the second alarm includes outputting, via the one or more output devices, the auditory alarm. In some embodiments, the auditory alarm is an alert, a series of sounds, a natural language statement and/or description of context surrounding the second alarm, and/or an audible pattern. In some embodiments, the auditory alarm is unique for the second alarm and/or the device corresponding to the second type of resident (e.g., predefined in a setting and/or set by the first type of resident). In some embodiments, the auditory alarm corresponds to the second alarm (e.g., the auditory alarm includes information that indicates that the second alarm is an alarm output after the first alarm and/or that indicates that the device corresponding to the second type of resident is the second device to output an alarm).

In some embodiments, after detecting the unidentified subject, the computer system detects a change in (e.g., an escalation of and/or an increase in) threat level (e.g., as discussed above with respect to FIGS. 7C-7D) (e.g., perceived threat and/or danger level) corresponding to (e.g., of and/or created by) the unidentified subject, wherein the set of one or more criteria includes a criterion that is satisfied when the threat level corresponding to the unidentified subject is over a predetermined value (e.g., as discussed above with respect to FIGS. 7C-7D) (e.g., a threshold threat level and/or a trigger level). In some embodiments, detecting the unidentified subject includes detecting a threat level of the unidentified subject (e.g., perceived emotion level such as angry, hostile, and/or agitated, detected object and/or weapon that could pose a threat to a residence and/or occupants, and/or threat of actions taken by the unidentified subject). In some embodiments, detecting the threat level of the unidentified subject includes detecting a threat level of actions taken by the unidentified subject (e.g., attempting to open a door, trying to open a window, slamming a door, pointing a weapon, breaking a window, attempting to break into a door and/or entry way, climbing a fence, and/or entering into a residence).

In some embodiments, detecting the unidentified subject includes detecting a threat level (e.g., as discussed above with respect to FIGS. 7C-7D) (e.g., perceived threat and/or danger level) corresponding to (e.g., of and/or created by) the unidentified subject. In some embodiments, the set of one or more criteria includes a criterion that is satisfied when the threat level corresponding to the unidentified subject is over a threshold (e.g., as discussed above with respect to FIGS. 7C-7D) (e.g., a threshold threat level and/or a trigger level). In some embodiments, detecting the unidentified subject includes detecting a threat level of the unidentified subject at the time of detecting the unidentified subject (e.g., perceived emotion level such as angry, hostile, and/or agitated, detected object and/or weapon that could pose a threat to a residence and/or occupants, and/or threat of actions taken by the unidentified subject). In some embodiments, detecting the threat level of the unidentified subject includes detecting a threat level of actions taken by the unidentified subject at the time of detecting the unidentified subject (e.g., attempting to open a door, trying to open a window, slamming a door, pointing a weapon, breaking a window, attempting to break into a door and/or entry way, climbing a fence, and/or entering into a residence). In some embodiments, the computer system outputs, via a device corresponding to a non-resident, a fourth alarm based on the threat level being over the threshold and/or another threshold (e.g., a higher value causing an alarm to a law enforcement authority and/or a security service) different from the threshold.

In some embodiments, detecting the unidentified subject includes detecting the unidentified subject at a residence (e.g., 708) (e.g., corresponding to the first type of resident and/or overseen by the first type of resident). In some embodiments, the set of one or more criteria includes a criterion that is satisfied when the device corresponding to the second type of resident is within the residence (e.g., as discussed above with respect to FIG. 7C). In some embodiments, the computer system outputs the second alarm in order to notify the second type of resident of the unidentified subject (e.g., inform an occupant of a potential threat without requiring opening an access point to the resident and/or inform an occupant of a potential intruder to allow for protective measures to be taken). In some embodiments, the device corresponding to the second type of resident is a communal device, a speaker device, and/or a device near the second type of resident within the residence, and the computer system causes output of, via the device near the second type of resident, the second alarm.

In some embodiments, detecting the unidentified subject includes detecting the unidentified subject at a residence (e.g., 708) (e.g., corresponding to the first type of resident and/or overseen by the first type of resident). In some embodiments, the set of one or more criteria includes a criterion that is satisfied when the device corresponding to the second type of resident is not within the residence (e.g., as discussed above with respect to FIG. 7C). In some embodiments, the computer system outputs the second alarm in order to notify the second type of resident of the unidentified subject (e.g., inform a nonoccupant of a potential threat prior to arriving at the residence and/or inform a nonoccupant of a potential intruder to allow for protective measures to be taken without requiring the nonoccupant to be at the residence). In some embodiments, the device corresponding to the second type of resident is a personal device, mobile device, and/or smart phone, and the computer system causes output of the second alarm due to the second type of resident being away from the residence (e.g., attempting to prevent the second type of resident from coming home while an active threat is at the residence and/or informing the second type of resident of a potential threat to allow the second type of resident to seek help prior to arriving at the residence).

In some embodiments, the set of one or more criteria is a first set of one or more criteria. In some embodiments, after initiating output of the second alarm and in accordance with a determination that a second set of one or more criteria is satisfied (e.g., as discussed above with respect to FIG. 7D), the computer system outputs, via the device corresponding to the first type of resident, a third alarm (e.g., as discussed above with respect to FIGS. 7D and/or 726), wherein the second set of one or more criteria is different from the first set of one or more criteria. In some embodiments, the third alarm is different from the first alarm (e.g., a different type of alarm, a different level of alarm, and/or an escalation of the first alarm). In some embodiments, the computer system outputs the third alarm in order to attempt to notify the first type of resident when the first alarm was potentially unnoticed and/or unsuccessful. In some embodiments, the third alarm is an escalation of the first alarm (e.g., a louder audible alert, an audible alert alongside a displayed notification, a larger notification, and/or a notification with an increased intensity). In some embodiments, the third alarm is and/or is the same as the second alarm. In some embodiments, the third alarm is or is the same as the first alarm (e.g., a repeat and/or re-alarm of the first alarm).

Note that details of the processes described above with respect to process 800 (e.g., FIG. 800) are also applicable in an analogous manner to other processes described herein. For example, process 800 optionally includes one or more of the characteristics of the various processes described above with reference to process 800. For example, the representation of the notification of process 600 can be the first alarm of process 800. For brevity, these details are not repeated herein.

In order to provide clarification, the aforementioned description has been explained using particular embodiments and examples. At least some of these particular embodiments and examples can be found in the accompanying figures. However, such embodiments and examples should not be construed as restricting the disclosure or as exhaustive unless explicitly indicated otherwise. Without going beyond this description, a person of ordinary skill in the art can make changes and/or alterations in light of the aforementioned description.

In some embodiments, one or more computer systems automatically produce content in response to a request for it. The content can be produced either off-device (e.g., by one or more nearby computer systems (such as accessible via a local network) and/or by one or more remote computers accessible (such as accessible via the internet)) or on-device (e.g., by a computer system at which the request is received). Text, audio, and/or visual elements (such as pictures, graphics, and/or video) are optionally included in the content.

In some embodiments, generative content refers to content generated by one or more artificial intelligence (AI) techniques (e.g., generative images, generative graphics, generative video, generative audio, and/or generative text). In such embodiment, an AI technique can generate the content in response to a stimulus that is given to it. In some embodiments, the AI technique incorporates one or more pre-processing techniques (e.g., adjustment to a user-provided prompt, development of a system-generated prompt, and/or AI model selection) before generating the content. In some embodiments, the AI technique incorporates one or more post-processing steps (e.g., passing the content to another AI technique, upscaling, downscaling, cropping, formatting, and/or adding or removing metadata) before the content is used for other purposes, such as being sent to another software process for additional processing or being presented to a user (e.g., visually or audibly).

One or more words (such as a spoken or written natural language prompt), one or more drawings, one or more images, and/or one or more videos can be included in a prompt for generating content. Examples of AI techniques include neural networks, transformer-based deep neural networks, large language models (LLMs), and generative pre-trained transformer models.

Although generative material is typically based on a prompt, it is created using the prompt as a starting point rather than being deterministically chosen from pre-generated content. In some embodiments, the prompt includes pre-existing content (such as text, audio, and/or visual content). For example, a prompt can ask for a block of text to be redone or summarized in a different tone. The result can be generative text that has been rewritten or summarized in the different tone. Similar to this, a prompt can ask for changes to visual content in order to include or exclude content that is specified by the prompt (e.g., deleting a feature that has been identified in visual content, adding a feature that is described in a prompt, altering a style of visual content, and/or producing additional visual elements that are based on visual content but are not located in the visual content). In some embodiments, the prompt includes or is used with a random or pseudo-random seed (e.g., content is generated using the random or pseudo-random seed as a starting point). For example, in order to create an image based on a diffusion model, a random noise pattern can be iteratively denoised on a basis of the prompt. Although this description has discussed particular kinds of AI techniques, it should be acknowledged that content can be generated by a wide range of AI techniques.

When gathering user data, organizations that share, collect, and/or use it should be transparent and/or have consent from users. Publicly accessible data can be used in certain techniques instead of in addition to user data. Data can be anonymized, aggregated, and/or processed in other ways to eliminate or restrict any individual identification in order to preserve user privacy. Entities that gather, distribute, and/or use such data in any way should have user consent before doing so and/or be transparent about the data collection process. Moreover, organizations in charge of user data, including but not restricted to data used in connection with AI techniques should make an effort to adhere to established privacy policies and/or privacy practices. When it comes to creating and/or training AI/ML systems, these organizations can adopt and continuously adhere to rules and procedures that are acknowledged as reaching or surpassing industry standards and legal requirements. While doing this, efforts should be made to guarantee that all privacy concerns and intellectual property rights are upheld. Practices for protecting training data, including private information, from abuse or exploitation should be incorporated into training. All phases of the creation, training, and application of AI/ML systems, including data collection, data preparation, model training, model evaluation, model deployment, and continuing monitoring and maintenance, should be covered by such policies and procedures. Accountability and transparency ought to be upheld at all times. Users should have easy access to such policies, which should be updated in response to changes in data collection and/or use. User information must be gathered for the entity's reasonable and lawful purposes and not shared or sold for purposes other than those purposes. Furthermore, any gathering and sharing must be transparent with users and/or only after obtaining their informed consent. Such organizations should also think about taking any necessary actions to protect and secure access to such data and make sure that those who have access to it follow their privacy policies and procedures. Additionally, such organizations ought to submit to third-party assessment in order to attest, if necessary for transparency, that they follow generally recognized privacy policies and procedures. Policies and/or practices should also be customized to a specific use case, applicable laws and standards, jurisdiction-specific factors, and the precise type of data being collected and/or accessed.

In some embodiments, AI/ML systems might make use of models that have been trained (for example, through supervised or unsupervised learning) utilizing a variety of training data, including information gathered from a user device. Such utilization of user-gathered data can be restricted to tasks performed on the user's device. For instance, a model can be trained locally on the user's device, preventing any data from being transferred to a different device. For another example, a model can be trained on one or more devices (e.g., a server) in addition to the user device, but this can be done in a way that protects privacy, like multi-party computation, which can be done cryptographically by secret sharing data or in another way that prevents user data from leaking to the other devices.

In certain implementations, such as federated learning, a model can be kept on several devices or centrally on the user's device. Such decentralized storage can also be accomplished in a way that protects privacy, for example, by using cryptographic procedures that split each piece of data into shards that prevent the data from being reassembled or used by the user device alone or only in conjunction with another device or devices. In this way, a model can be trained and run using additional computational power of other devices, without exposing a user or device activity pattern. As a result, user-gathered data can be safeguarded. In certain implementations, a model can be trained by combining input from several devices in a way that protects privacy.

In some embodiments, the current disclosure assumes that information utilized by AI/ML systems can be kept completely distinct from platforms on which the AI/ML systems are installed, used to communicate with users, or used to process data. In these implementations, data used to train the AI/ML systems offline can be kept in restricted-access, secured datastores, and/or kept for no longer than is required for training. In certain implementations, the AI/ML systems can temporarily store data in a local memory cache while a user is interacting with them. The AI/ML systems'performance can be enhanced by using the local memory cache. However, after the user session is over, data kept in the local memory cache can be deleted to preserve user privacy. After processing, any temporary data caches utilized for online learning or inference can be quickly deleted. Secure communication and/or industry-standard encryption should be used for all data collection, transfer, and/or storage.

As previously mentioned, in some embodiments, methods like homomorphic encryption, secure hardware components, federated learning, differential privacy, and/or multi-party computation can be used to further protect personal data while the AI/ML systems are being trained and/or used. Changes in the underlying data distribution, such as idea drift or data skew, should be watched for in AI/ML systems as they can eventually impair their performance. In some embodiments, both online and offline training are used to train the AI/ML systems. While online training enables AI/ML systems to continuously adapt and/or improve, offline training can use carefully selected datasets to set baseline model performance. The current disclosure acknowledges how crucial it is to uphold stringent data governance procedures during this procedure in order to guarantee user privacy. In some embodiments, the AI/ML systems might be built with protections to ensure that they stay true to their initial goals even as they change in response to fresh data. Any significant adjustments to the way an AI/ML system collects and/or uses data can (and in certain situations should) be openly shared with the relevant parties. This can involve getting user consent for any changes to the way user data is gathered and/or used.

The current disclosure additionally considers examples where users can block or selectively restrict access to and/or use of data. In other words, the current disclosure assumes that components of software and/or hardware can be offered to restrict or stop data access. For certain services, for instance, the current technology should be set up to provide customers the option to “opt in” or “opt out” of taking part in data collecting at the time of service registration or at any point subsequently. As an additional illustration, current technology ought to be set up to let users choose not to supply specific data for AI/ML system training or for usage as input when the systems are in the inference stage. Another example is that current technology should be set up to give customers the option to restrict how long their data is kept or to completely forbid AI/ML systems from using their data. The current disclosure involves sending alerts regarding the access or use of personal information in addition to offering “opt in” and “opt out” options. A user can be reminded when the AI/ML systems produce outputs or make judgments based on their data, for example, or they can receive notifications when their data is being entered into the systems for training or inference.

The current disclosure acknowledges that, even when AI/ML systems are developed, constructed, and/or operated in accordance with industry best practices and standards, they should have clear limitations and/or oversight to reduce potential hazards. For instance, outputs that might be deemed inaccurate, damaging, offensive, and/or biased might be generated; these outputs might not accurately represent the views or stances of the organizations creating or implementing these systems. Additionally, in certain situations, mentions of third-party goods and/or services in the outputs should not be interpreted as affiliations or endorsements by the companies who supply the AI/ML systems. Human oversight and/or the capacity to override or fix incorrect or undesirable outputs can be maintained as a failsafe, and generated content can be checked for potentially unsuitable or dangerous material before being shown to users.

The current disclosure also takes into consideration that users of the AI/ML systems should not use the services in any way that violates, infringes upon, or misappropriates the rights of any other party. Additionally, the AI/ML systems should not be utilized for any illegal or unlawful conduct, nor should they be used to create any use cases or applications that would commit or assist in the commission of any criminal, tortious, or illegal act. The AI/ML systems must properly attribute content as needed and not infringe upon, violate, or misappropriate any copyrights, trademarks, rights of privacy and publicity, trade secrets, patents, or other property or legal rights of any party. Furthermore, no security, digital signing, digital rights management, content protection, verification, or authentication process should be hampered by AI/ML systems. Machine-generated outputs should not be mistakenly represented as human-generated by AI/ML systems.

Using and/or collecting data from several sources is one aspect of the technology mentioned above. Such information can be utilized to enhance a device's interactions with its surroundings, such as those with users. Personal information that can be used to uniquely identify an individual can be included in such data in certain situations. Demographic information, phone numbers, email addresses, location and/or location-related information, home, and work addresses, and/or any other identifying information can all be considered personal information. Users of the device can benefit from the use of such personal information. For instance, a user's personal data can be utilized to enhance the device's communication with the user. Within the parameters of the current disclosure, additional advantages can potentially arise from the usage of personal data.

One or more entities can need to handle personal data in order for it to be used. These organizations can be engaged in gathering, processing, revealing, moving, storing, or performing other tasks that facilitate the technologies covered here. Although it does not prevent it, the current disclosure assumes that all uses of personal identifiable data adhere to existing privacy rules and/or procedures of such entities. Generally speaking, such policies and practices must adhere to all relevant legislative regulations pertaining to data privacy and security, as well as reach or beyond widely accepted industry standards. For instance, businesses should obtain users'informed consent before collecting and using personal data, and they should only do so for appropriate and justifiable purposes. Furthermore, a user's personal information should never be sold, transferred, divulged, or used for purposes other than those that are reasonable and/or lawful.

There are a number of situations where personal data is unavailable, such as when a user decides not to disclose it. The user can, for instance, “opt out” of sharing such data or not specifically “opt in” during the registration process to refuse consent for the gathering and/or use of such data. Any number of other hardware and/or software components that prohibit the gathering and/or use of such data can also be used by the user. The current disclosure considers that implementations of the current technology can be used without such data, even though the usage of personal information can benefit a user by improving the device's performance. For instance, the device's functions can make use of non-personal data (for instance, in lieu of or in addition to personal data). Other methods involve drawing conclusions from data that does not contain personal information or from a small amount of personal information.

What is claimed is:

1. A method, comprising:
at a computer system:
detecting an unidentified subject;
in response to detecting the unidentified subject, outputting, via a device corresponding to a first type of resident, a first alarm; and
after causing output of the first alarm:
in accordance with a determination that a set of one or more criteria is satisfied, outputting, via a device corresponding to a second type of resident, a second alarm, wherein the device corresponding to the second type of resident is separate from the device corresponding to the first type of resident, and wherein the second type of resident is different from the first type of resident; and
in accordance with a determination that the set of one or more criteria is not satisfied, forgoing output of, via the device corresponding to the second type of resident, the second alarm.

2. The method of claim 1, wherein the set of one or more criteria includes a criterion that is satisfied when the first alarm is not disarmed within an amount of time.

3. The method of claim 1, wherein the set of one or more criteria includes a criterion that is satisfied when the unidentified subject remains unidentified for an amount of time after initiating output of the first alarm.

4. The method of claim 1, further comprising:
after initiating output of the second alarm, receiving, from the device corresponding to the second type of resident, an indication that the second alarm has been suspended; and
in response to receiving the indication that the second alarm has been suspended, forgoing cessation of the first alarm.

5. The method of claim 1, further comprising:
after initiating output of the second alarm, receiving, from the device corresponding to the second type of resident, an indication that the second alarm has been suspended; and
in response to receiving the indication that the second alarm has been suspended, ceasing output of, via the device corresponding to the first type of resident, the first alarm.

6. The method of claim 1, further comprising:
after initiating output of the second alarm, receiving, from the device corresponding to the first type of resident, an indication that the first alarm has been suspended; and
in response to receiving the indication that the second alarm has been suspended, ceasing output of, via the device corresponding to the second type of resident, the second alarm.

7. The method of claim 1, wherein the first alarm is the same as the second alarm.

8. The method of claim 1, wherein the set of one or more criteria is a first set of one or more criteria, the method further comprising:
after initiating output of the second alarm and in accordance with a determination that a second set of one or more criteria is satisfied, outputting, via a device corresponding to a non-resident, a third alarm, wherein the second set of one or more criteria is different from the first set of one or more criteria.

9. The method of claim 8, wherein the device corresponding to the first type of resident and the device corresponding to the second type of resident are included within a first logical environment, wherein the device corresponding to the non-resident is within a second logical environment separate from first logical environment, and wherein the second logical environment has a relationship with the first logical environment.

10. The method of claim 8, wherein the device corresponding to the non-resident is a device corresponding to a third-party emergency service, and wherein outputting the third alarm includes alerting the third-party emergency service.

11. The method of claim 1, wherein detecting the unidentified subject includes detecting the unidentified subject at a point corresponding to a residence.

12. The method of claim 11, wherein the point is within a zone outside of the residence.

13. The method of claim 11, wherein the point is within the residence.

14. The method of claim 1, further comprising:
after initiating output of the first alarm, before outputting the second alarm, and in accordance with the determination that the set of one or more criteria is satisfied, changing an operation mode of the device corresponding to the second type of resident.

15. The method of claim 1, wherein the first alarm is different from the second alarm.

16. The method of claim 1, wherein the device corresponding to the first type of resident is the computer system.

17. The method of claim 1, wherein the device corresponding to the second type of resident is the computer system.

18. The method of claim 1, wherein the first type of resident is a homeowner.

19. The method of claim 18, wherein the device corresponding to the first type of resident is a personal device of the first type of resident.

20. The method of claim 1, wherein the second type of resident is a dependent of the first type of resident.

21. The method of claim 1, wherein the second type of resident is a third-party monitoring service.

22. The method of claim 1, wherein the first alarm is a notification.

23. The method of claim 1, wherein the second alarm is an auditory alarm.

24. The method of claim 1, further comprising:
after detecting the unidentified subject, detecting a change in threat level corresponding to the unidentified subject, wherein the set of one or more criteria includes a criterion that is satisfied when the threat level corresponding to the unidentified subject is over a predetermined value.

25. The method of claim 1, wherein detecting the unidentified subject includes detecting a threat level corresponding to the unidentified subject, and wherein the set of one or more criteria includes a criterion that is satisfied when the threat level corresponding to the unidentified subject is over a threshold.

26. The method of claim 1, wherein detecting the unidentified subject includes detecting the unidentified subject at a residence, and wherein the set of one or more criteria includes a criterion that is satisfied when the device corresponding to the second type of resident is within the residence.

27. The method of claim 1, wherein detecting the unidentified subject includes detecting the unidentified subject at a residence, and wherein the set of one or more criteria includes a criterion that is satisfied when the device corresponding to the second type of resident is not within the residence.

28. The method of claim 1, wherein the set of one or more criteria is a first set of one or more criteria, the method further comprising:
after initiating output of the second alarm and in accordance with a determination that a second set of one or more criteria is satisfied, outputting, via the device corresponding to the first type of resident, a third alarm, wherein the second set of one or more criteria is different from the first set of one or more criteria.

29. A non-transitory computer-readable storage medium storing one or more programs configured to be executed by one or more processors of a computer system, the one or more programs including instructions for:
detecting an unidentified subject;
in response to detecting the unidentified subject, outputting, via a device corresponding to a first type of resident, a first alarm; and
after causing output of the first alarm:
in accordance with a determination that a set of one or more criteria is satisfied, outputting, via a device corresponding to a second type of resident, a second alarm, wherein the device corresponding to the second type of resident is separate from the device corresponding to the first type of resident, and wherein the second type of resident is different from the first type of resident; and
in accordance with a determination that the set of one or more criteria is not satisfied, forgoing output of, via the device corresponding to the second type of resident, the second alarm.

30. A computer system, comprising:
one or more processors; and
memory storing one or more programs configured to be executed by the one or more processors, the one or more programs including instructions for:
detecting an unidentified subject;
in response to detecting the unidentified subject, outputting, via a device corresponding to a first type of resident, a first alarm; and
after causing output of the first alarm:
in accordance with a determination that a set of one or more criteria is satisfied, outputting, via a device corresponding to a second type of resident, a second alarm, wherein the device corresponding to the second type of resident is separate from the device corresponding to the first type of resident, and wherein the second type of resident is different from the first type of resident; and
in accordance with a determination that the set of one or more criteria is not satisfied, forgoing output of, via the device corresponding to the second type of resident, the second alarm.
